(19) United States
(12) Patent Application Publication
(10) Pub. No.: US 2026/0361904 A1
(43) Pub. Date: Nov. 12, 2026

(54) Intra Prediction Modes Exclusion Using Block Vector-based Intra Mode Derivation

(71) Applicant: Ofinno, LLC, Reston, VA (US)

(72) Inventors: Jung Kyung Lee, Reston, VA (US); Damian Ruiz Coll, Reston, VA (US)

(21) Appl. No.: 19/670,768

(22) Filed: May 7, 2026

Related U.S. Application Data
(60) Provisional application No. 63/801,441, filed on May 7, 2025.

(51) Int. Cl. H04N 19/44; H04N 19/105; H04N 19/159; H04N 19/176

(52) U.S. Cl. CPC H04N 19/44; H04N 19/105; H04N 19/159; H04N 19/176

(57) ABSTRACT

A decoder generates, for each intra prediction mode (IPM) in a first list of IPMs, a respective predicted current block by applying the each IPM to a plurality of reference samples neighboring a current block. A threshold predicted cost is determined based on similarities between a reference block of the current block and each of the predicted current blocks. One or more IPMs are excluded from a second list of IPMs based on the threshold predicted cost to generate an updated second list of IPMs. The decoder decodes the current block using an IPM selected from a set of IPMs comprising IPMs of the second list of IPMs.

### CROSS-REFERENCE TO RELATED APPLICATIONS

This application claims the benefit of U.S. Provisional Application No. 63/801,441, filed May 7, 2025, which is hereby incorporated by reference in its entirety.

### BRIEF DESCRIPTION OF THE DRAWINGS

Some features are shown by way of example, and not by limitation, in the accompanying drawings. In the drawings, like numerals reference similar elements.

FIG. 1 shows an example video coding/decoding system in which embodiments of the present disclosure may be implemented.

FIG. 2 shows an example encoder in which embodiments of the present disclosure may be implemented.

FIG. 3 shows an example decoder in which embodiments of the present disclosure may be implemented.

FIG. 4 shows an example quadtree partitioning of a coding tree block (CTB).

FIG. 5 shows an example quadtree corresponding to the example quadtree partitioning of the CTB in FIG. 4.

FIG. 6 show examples of binary tree and ternary tree partitions.

FIG. 7A shows an example of combined quadtree and multi-type tree partitioning of a CTB.

FIG. 7B shows an example tree corresponding to the combined quadtree and multi-type tree partitioning of the CTB shown in FIG. 7A.

FIG. 8 shows an example of partitioning modes in AV1.

FIG. 9 shows an example set of reference samples determined for intra prediction of a current block.

FIG. 10A, FIG. 10B, and FIG. 10C show example intra prediction modes.

FIG. 11 shows an example of a current block and corresponding reference samples.

FIG. 12 shows an example of applying an intra prediction mode (e.g., an angular mode) for prediction of a current block.

FIG. 13A shows an example of inter prediction performed for a current block in a current picture.

FIG. 13B shows an example motion vector.

FIG. 14 shows an example of bi-prediction performed for a current block.

FIG. 15A shows example spatial candidate neighboring blocks relative to a current block being coded.

FIG. 15B shows example locations of two temporal, co-located blocks relative to a current block.

FIG. 16 shows an example of intra block copy (IBC).

FIG. 17 shows, for an example current block, a reference region or search area of reconstructed samples within which in Intra Template Match Prediction (IntraTMP) a search is performed for a candidate reference block of which the template best matches the template of the current block.

FIG. 18 shows a current block in a current CTU, and the reference region with the corresponding IntraTMP search regions R1-R6 identified.

FIG. 19A shows the sparse search stage of IntraTMP.

FIG. 19B shows a block vector according to IntraTMP where the block vector's refinement window is clipped at the boundary of a search region.

FIG. 20 shows an example of the top-template type that can be used in IntraTMP.

FIG. 21 shows an example of the left-template type that can be used in IntraTMP.

FIG. 22 shows an example of the L-shape template type that can be used in IntraTMP.

FIG. 23 shows non-adjacent blocks for determining block vector candidates, according to IntraTMP with Merge Candidates.

FIG. 24 shows an IntraTMP with Merge Candidates process, according to some embodiments.

FIG. 25 shows example refinement windows for sparse block vector candidates and merge block vector candidates, according to some embodiments.

FIG. 26A shows an example of auto-relocated block vector prediction (AR-BVP) applied to IBC, according to some embodiments.

FIG. 26B shows examples of refinement windows of AR-BVP candidates derived from different positions associated with a guiding BV, according to some embodiments.

FIG. 27 shows an example of IntraTMP with BVP candidates derived using IntraTMP AR-BVP merge, according to some embodiments.

FIG. 28 shows an example of the IntraTMP AR-BVP merge process, according to some embodiments.

FIG. 29 shows an example of sparse AR-BVP candidates in IntraTMP generated by applying the AR-BVP technique to the TMP BV candidates, according to some embodiments.

FIG. 30 shows an example process for applying TMP sparse AR-BVP candidates to the TMP, according to some embodiments.

FIG. 31 shows an example of decoder-side intra mode derivation (DIMD) for coding a current block, according to some embodiments.

FIGS. 32A and 32B show an example of template-based intra mode derivation (TIMD) for coding a current block, according to some embodiments.

FIG. 33 shows an example of determining the intra coding mode for a block using block vector-based intra mode derivation (BVIMD), according to some embodiments.

FIG. 34 shows an example flowchart of the BVIMD, according to embodiments.

FIG. 35 shows an example flowchart illustrating a process for excluding improbable IPMs based BVIMD, according to some embodiments.

FIG. 36 shows another example flowchart illustrating a process for excluding improbable IPMs based BVIMD, according to some embodiments.

FIG. 37 shows an example flowchart illustrating a current block encoding/decoding process that uses BVIMD to exclude improbable IPMs from candidate lists, according to some embodiments.

FIG. 38 shows an example flowchart illustrating a current block encoding process that uses BVIMD to exclude improbable IPMs from consideration in rate distortion optimization calculations, according to some embodiments.

FIG. 39 illustrates a block diagram of an example computer system in which embodiments of the present disclosure may be implemented.

### DETAILED DESCRIPTION

In the following description, numerous specific details are set forth in order to provide a thorough understanding of the disclosure. However, it will be apparent to those skilled in the art that the disclosure, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Furthermore, embodiments may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium. A processor(s) may perform the necessary tasks.

A video sequence, comprising multiple pictures/frames, may be represented in digital form for storage and/or transmission. Representing a video sequence in digital form may require a large quantity of bits. Large data sizes that may be associated with video sequences may require significant resources for storage and/or transmission. Video encoding may be used to compress a size of a video sequence for more efficient storage and/or transmission. Video decoding may be used to decompress a compressed video sequence for display and/or other forms of consumption.

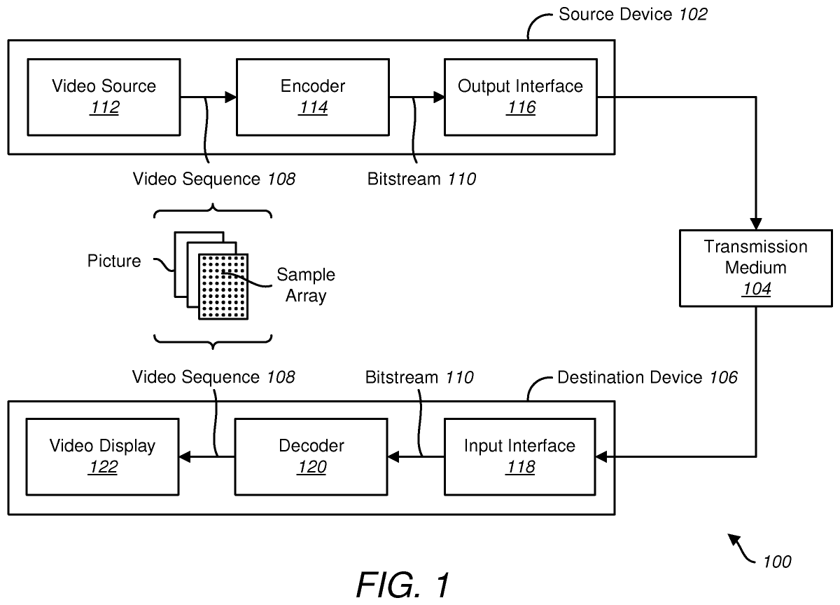

FIG. 1 shows an example video coding/decoding system 100 in which embodiments of the present disclosure may be implemented. Video coding/decoding system 100 comprises a source device 102, a transmission medium 104, and a destination device 106. Source device 102 encodes a video sequence 108 into a bitstream 110 for more efficient storage and/or transmission. Source device 102 may store and/or send/transmit bitstream 110 to destination device 106 via transmission medium 104. Destination device 106 decodes bitstream 110 to display video sequence 108. Destination device 106 may receive bitstream 110 from source device 102 via transmission medium 104. Source device 102 and/or destination device 106 may be any of a plurality of different devices (e.g., a desktop computer, laptop computer, tablet computer, smart phone, wearable device, television, camera, video gaming console, set-top box, video streaming device, etc.).

Source device 102 may comprise (e.g., for encoding video sequence 108 into bitstream 110) one or more of a video source 112, an encoder 114, and/or an output interface 116. Video source 112 may provide and/or generate video sequence 108 based on a capture of a natural scene and/or a synthetically generated scene. A synthetically generated scene may be a scene comprising computer generated graphics and/or screen content. Video source 112 may comprise a video capture device (e.g., a video camera), a video archive comprising previously captured natural scenes and/or synthetically generated scenes, a video feed interface to receive captured natural scenes and/or synthetically generated scenes from a video content provider, and/or a processor to generate synthetic scenes.

A video sequence, such as video sequence 108, may comprise a series of pictures (also referred to as frames). A video sequence may achieve an impression of motion based on successive presentation of pictures of the video sequence using a constant time interval or variable time intervals between the pictures. A picture may comprise one or more sample arrays of intensity values. The intensity values may be taken (e.g., measured, determined, provided) at a series of regularly spaced locations within a picture. A color picture may comprise (e.g., typically comprises) a luminance sample array and two chrominance sample arrays. The luminance sample array may comprise intensity values representing the brightness (e.g., luma component, Y) of a picture. The chrominance sample arrays may comprise intensity values that respectively represent the blue and red components of a picture (e.g., chroma components, Cb and Cr) separate from the brightness. Other color picture sample arrays may be possible based on different color schemes (e.g., a red, green, blue (RGB) color scheme). A pixel, in a color picture, may refer to/comprise/be associated with all intensity values (e.g., luma component, chroma components), for a given location, in the sample arrays (e.g., three sample arrays are used for one luma component and two chroma components, respectively) used to represent color pictures. A monochrome picture may comprise a single, luminance sample array. A pixel, in a monochrome picture, may refer to/comprise/be associated with the intensity value (e.g., luma component) at a given location in the single, luminance sample array used to represent monochrome pictures.

Encoder 114 may encode video sequence 108 into bitstream 110. Encoder 114 may apply/use (e.g., to encode video sequence 108) one or more prediction techniques to reduce redundant information in video sequence 108. Redundant information is information that may be predicted at a decoder and need not be transmitted to the decoder for accurate decoding of video sequence 108. For example, encoder 114 may apply spatial prediction (e.g., intra-frame or intra prediction), temporal prediction (e.g., inter-frame prediction or inter prediction), inter-layer prediction, and/or other prediction techniques to reduce redundant information in video sequence 108. Encoder 114 may partition pictures comprising video sequence 108 into rectangular regions referred to as blocks, for example, before applying one or more prediction techniques. Encoder 114 may then encode a block using the one or more of the prediction techniques.

For temporal prediction, encoder 114 may search for a block similar to the block being encoded in another picture (e.g., referred to as a reference picture) of video sequence 108. The block determined during the search (e.g., referred to as a prediction block) may then be used to predict the block being encoded. For spatial prediction, encoder 114 may form a prediction block based on data from reconstructed neighboring samples of the block to be encoded within the same picture of video sequence 108. A reconstructed sample refers to a sample that was encoded and then decoded. Encoder 114 may determine a prediction error (e.g., also referred to as a residual) based on the difference between a block being encoded and a prediction block. The prediction error may represent non-redundant information that may be sent/transmitted to a decoder for accurate decoding of video sequence 108.

Encoder 114 may apply a transform to the prediction error (e.g. using a discrete cosine transform (DCT), or any other transform) to generate transform coefficients. Encoder 114 may form bitstream 110 based on the transform coefficients and other information used to determine prediction blocks using/based on prediction types, motion vectors, and/or prediction modes. Encoder 114 may perform one or more of quantization and entropy coding of the transform coefficients and/or the other information used to determine the prediction blocks, for example, before forming bitstream 110. The quantization and/or the entropy coding may further reduce the quantity of bits needed to store and/or transmit video sequence 108.

Output interface 116 may be configured to write and/or store bitstream 110 onto transmission medium 104 for transmission to destination device 106. In addition or alternatively, output interface 116 may be configured to send/transmit, upload, and/or stream bitstream 110 to destination device 106 via transmission medium 104. Output interface 116 may comprise a wired and/or a wireless transmitter configured to send/transmit, upload, and/or stream bitstream 110 in accordance with one or more proprietary, open-source, and/or standardized communication protocols (e.g., Digital Video Broadcasting (DVB) standards, Advanced Television Systems Committee (ATSC) standards, Integrated Services Digital Broadcasting (ISDB) standards, Data Over Cable Service Interface Specification (DOCSIS) standards, 3rd Generation Partnership Project (3GPP) standards, Institute of Electrical and Electronics Engineers (IEEE) standards, Internet Protocol (IP) standards, Wireless Application Protocol (WAP) standards, and/or any other communication protocol).

Transmission medium 104 may comprise wireless, wired, and/or computer readable medium. For example, transmission medium 104 may comprise one or more wires, cables, air interfaces, optical discs, flash memory, and/or magnetic memory. In addition or alternatively, transmission medium 104 may comprise one or more networks (e.g., the internet) or file servers configured to store and/or send/transmit encoded video data.

Destination device 106 may decode bitstream 110 into video sequence 108 for display. Destination device 106 may comprise one or more of an input interface 118, a decoder 120, and/or a video display 122. Input interface 118 may be configured to read bitstream 110 stored on transmission medium 104 by source device 102. In addition or alternatively, input interface 118 may be configured to receive, download, and/or stream bitstream 110 from source device 102 via transmission medium 104. Input interface 118 may comprise a wired and/or a wireless receiver configured to receive, download, and/or stream bitstream 110 in accordance with one or more proprietary, open-source, standardized communication protocols, and/or any other communication protocol (e.g., such as referenced herein).

Decoder 120 may decode video sequence 108 from encoded bitstream 110. The decoder 120 may generate prediction blocks for pictures of video sequence 108 in a similar manner as encoder 114 and determine the prediction errors for the blocks, for example, to decode video sequence 108. Decoder 120 may generate the prediction blocks using/based on prediction types, prediction modes, and/or motion vectors received in bitstream 110. Decoder 120 may determine the prediction errors using the transform coefficients received in bitstream 110. Decoder 120 may determine the prediction errors by weighting transform basis functions using the transform coefficients. Decoder 120 may combine the prediction blocks and the prediction errors to decode video sequence 108. Video sequence 108 at the destination device 106 may be, or may not necessarily be, the same video sequence sent, such as video sequence 108 as sent by the source device 102. Decoder 120 may decode a video sequence that approximates video sequence 108, for example, because of lossy compression of video sequence 108 by encoder 114 and/or errors introduced into encoded bitstream 110 during transmission to destination device 106.

Video display 122 may display video sequence 108 to a user. Video display 122 may comprise a cathode rate tube (CRT) display, a liquid crystal display (LCD), a plasma display, a light emitting diode (LED) display, and/or any other display device suitable for displaying video sequence 108.

Video coding/decoding system 100 is merely an example and video encoding/decoding systems different from the video coding/decoding system 100 and/or modified versions of the video coding/decoding system 100 may similarly perform the methods and processes as described herein. For example, the video coding/decoding system 100 may comprise other components and/or arrangements. For example, video source 112 may be external to source device 102. Similarly, video display 122 may be external to destination device 106 or omitted altogether (e.g., if video sequence 108 is intended for consumption by a machine and/or storage device). In an example, source device 102 may further comprise a video decoder and destination device 106 may further comprise a video encoder. For example, source device 102 may be configured to further receive an encoded bitstream from destination device 106 to support two-way video transmission between the devices.

Encoder 114 and/or decoder 120 may operate according to one or more proprietary or industry video coding standards. For example, encoder 114 and/or decoder 120 may operate in accordance with one or more proprietary, open-source, and/or standardized protocols (e.g., International Telecommunications Union Telecommunication Standardization Sector (ITU-T) H.263, ITU-T H.264 and Moving Picture Expert Group (MPEG)-4 Visual (also known as Advanced Video Coding (AVC)), ITU-T H.265 and MPEG-H Part 2 (also known as High Efficiency Video Coding (HEVC)), ITU-T H.265 and MPEG-I Part 3 (also known as Versatile Video Coding (VVC)), the WebM VP8 and VP9 codecs, and/or AOMedia Video 1 (AV1), and/or any other video coding protocol).

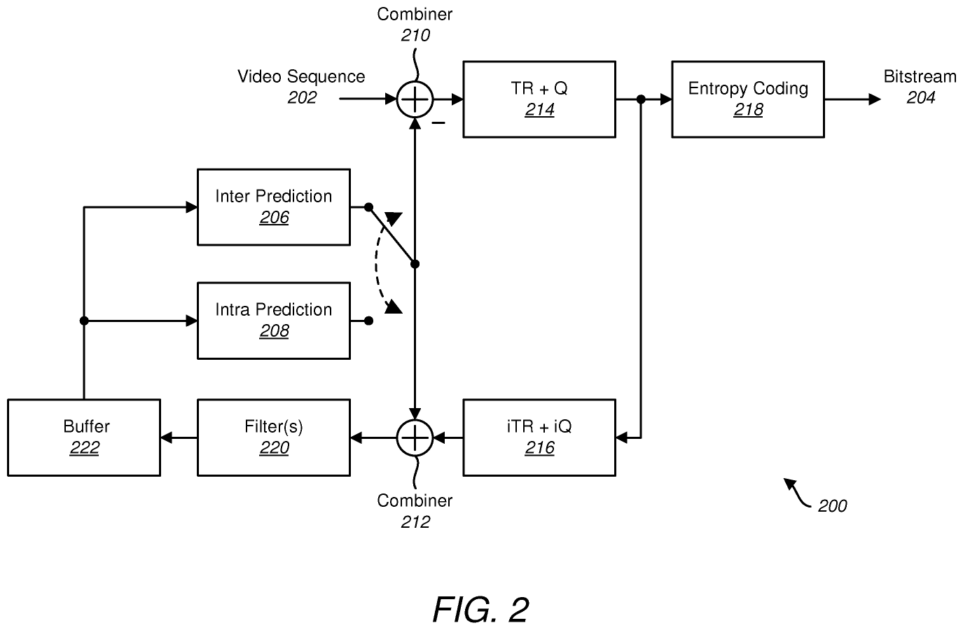

FIG. 2 shows an example encoder. Encoder 200 as shown in FIG. 2 may implement one or more processes described herein. Encoder 200 may encode a video sequence 202 into a bitstream 204 for more efficient storage and/or transmission. Encoder 200 may be implemented in video coding/decoding system 100 as shown in FIG. 1 (e.g., as encoder 114) or in any computing, communication, or electronic device (e.g., desktop computer, laptop computer, tablet computer, smart phone, wearable device, television, camera, video gaming console, set-top box, video streaming device, etc.). Encoder 200 may comprise one or more of an inter prediction unit 206, an intra prediction unit 208, combiners 210 and 212, a transform and quantization unit (TR+Q) 214, an inverse transform and quantization unit (iTR+iQ) 216, an entropy coding unit 218, one or more filters 220, and/or a buffer 222.

Encoder 200 may partition pictures (e.g., frames) of (e.g., comprising) video sequence 202 into blocks and encode video sequence 202 on a block-by-block basis. Encoder 200 may perform/apply a prediction technique on a block being encoded using either inter prediction unit 206 or intra prediction unit 208. Inter prediction unit 206 may perform inter prediction by searching for a block similar to the block being encoded in another, reconstructed picture (e.g., a reference picture) of video sequence 202. A reconstructed picture refers to a picture that was encoded and then decoded. The block determined during the search (e.g., referred to as a prediction block) may then be used to predict the block being encoded to remove redundant information. Inter prediction unit 206 may exploit temporal redundancy or similarities in scene content from picture to picture in video sequence 202 to determine the prediction block. For example, scene content between pictures of video sequence 202 may be similar except for differences due to motion and/or affine transformation of the screen content over time.

Intra prediction unit 208 may perform intra prediction by forming a prediction block based on data from reconstructed neighboring samples of the block to be encoded within the same picture of video sequence 202. A reconstructed sample refers to a sample that was encoded and then decoded. Intra prediction unit 208 may exploit spatial redundancy or similarities in scene content within a picture of video sequence 202 to determine the prediction block. For example, the texture of a region of scene content in a picture may be similar to the texture in the immediate surrounding area of the region of the scene content in the same picture.

Combiner 210 may determine a prediction error (e.g., referred to as a residual) based on the difference between the block being encoded and the prediction block. The prediction error may represent non-redundant information that may be sent/transmitted to a decoder for accurate decoding of video sequence 202.

Transform and quantization unit (TR+Q) 214 may transform and quantize the prediction error. Transform and quantization unit 214 may transform the prediction error into transform coefficients by applying, for example, a DCT to reduce correlated information in the prediction error. Transform and quantization unit 214 may quantize the coefficients by mapping data of the transform coefficients to a predefined set of representative values. Transform and quantization unit 214 may quantize the coefficients to reduce irrelevant information in bitstream 204. The irrelevant information refers to information that may be removed from the coefficients without producing visible and/or perceptible distortion in video sequence 202 after decoding (e.g., at a receiving device).

Entropy coding unit 218 may apply one or more entropy coding methods to the quantized transform coefficients to further reduce the bit rate. For example, entropy coding unit 218 may apply context adaptive variable length coding (CAVLC), context adaptive binary arithmetic coding (CABAC), and/or syntax-based context-based binary arithmetic coding (SBAC). The entropy coded coefficients may be packed to form bitstream 204.

Inverse transform and quantization unit (iTR+iQ) 216 may inverse quantize and inverse transform the quantized transform coefficients to determine a reconstructed prediction error. Combiner 212 may combine the reconstructed prediction error with the prediction block to form a reconstructed block. Filter(s) 220 may filter the reconstructed block, for example, using a deblocking filter, a sample-adaptive offset (SAO) filter, constrained directional enhancement filters (CDEFs), and/or loop restoration (LR) filters. Buffer 222 may store the reconstructed block for prediction of one or more other blocks in the same and/or different picture of video sequence 202.

Encoder 200 may further comprise an encoder control unit. The encoder control unit may be configured to control one or more units of encoder 200 as shown in FIG. 2. The encoder control unit may control the one or more units of encoder 200 such that bitstream 204 may be generated in conformance with the requirements of one or more proprietary coding protocols, industry video coding standards, and/or any other video cording protocol. For example, the encoder control unit may control the one or more units of encoder 200 such that bitstream 204 may be generated in conformance with one or more of ITU-T H.263, AVC, HEVC, VVC, VP8, VP9, AV1, and/or any other video coding standard/format.

The encoder control unit may be configured to attempt to minimize (or reduce) the bitrate of bitstream 204 and/or maximize (or increase) the reconstructed video quality (e.g., within the constraints of a proprietary coding protocol, industry video coding standard, and/or any other video cording protocol). For example, the encoder control unit may be configured to attempt to minimize or reduce the bitrate of bitstream 204 such that the reconstructed video quality does not fall below a certain level/threshold, and/or to maximize or increase the reconstructed video quality such that the bitrate of bitstream 204 does not exceed a certain level/threshold. The encoder control unit may determine/control one or more of: partitioning of the pictures of video sequence 202 into blocks, whether a block is inter predicted by inter prediction unit 206 or intra predicted by intra prediction unit 208, a motion vector for inter prediction of a block, an intra prediction mode among a plurality of intra prediction modes for intra prediction of a block, filtering performed by filter(s) 220, and/or one or more transform types and/or quantization parameters applied by transform and quantization unit 214. The encoder control unit may determine/control one or more of the above based on a rate-distortion measure for a block or picture being encoded. The encoder control unit may determine/control one or more of the above to reduce the rate-distortion measure for a block or picture being encoded.

The prediction type used to encode a block (intra or inter prediction), prediction information of the block (intra prediction mode if intra predicted, motion vector, etc.), and/or transform and/or quantization parameters, may be sent to entropy coding unit 218 to be further compressed (e.g., to reduce the bitrate). For example, entropy coding unit 218 may apply context adaptive variable length coding (CAVLC), context adaptive binary arithmetic coding (CABAC), syntax-based context-based binary arithmetic coding (SBAC), and/or symbol-to-symbol adaptive multi-symbol (non-binary) arithmetic coding to achieve further compression. The prediction type, prediction information, and/or transform and/or quantization parameters may be packed with the prediction error to form bitstream 204.

Encoder 200 is merely an example and encoders different from encoder 200 and/or modified versions of encoder 200 may perform the methods and processes as described herein. For example, encoder 200 may comprise other components and/or arrangements. One or more of the components shown in FIG. 2 may be optionally included in encoder 200 (e.g., entropy coding unit 218 and/or filters(s) 220).

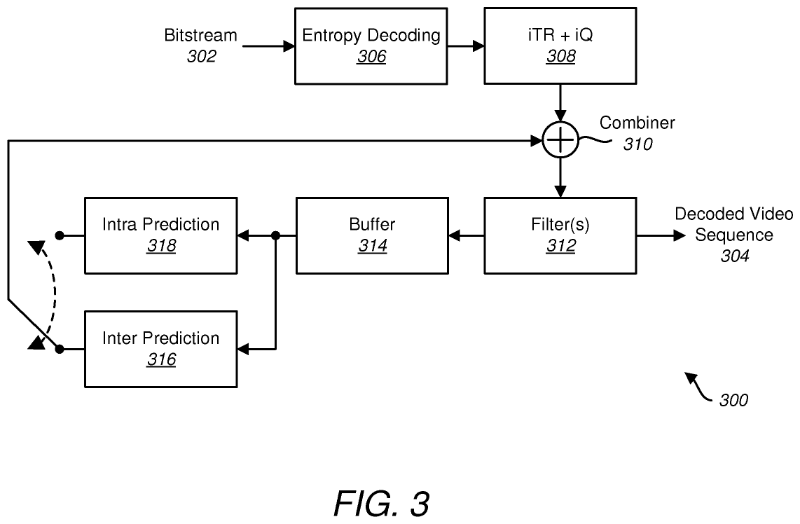

FIG. 3 shows an example decoder. A decoder 300 as shown in FIG. 3 may implement one or more processes described herein. Decoder 300 may decode a bitstream 302 into a decoded video sequence 304 for display and/or some other form of consumption. Decoder 300 may be implemented in video coding/decoding system 100 in FIG. 1 and/or in a computing, communication, or electronic device (e.g., desktop computer, laptop computer, tablet computer, smart phone, wearable device, television, camera, video gaming console, set-top box, and/or video streaming device). Decoder 300 may comprise an entropy decoding unit 306, an inverse transform and quantization (iTR+iQ) unit 308, a combiner 310, one or more filters 312, a buffer 314, an inter prediction unit 316, and/or an intra prediction unit 318.

Decoder 300 may comprise a decoder control unit configured to control one or more units of decoder 300. The decoder control unit may control the one or more units of decoder 300 such that bitstream 302 is decoded in conformance with the requirements of one or more proprietary coding protocols, industry video coding standards, and/or any other communication protocol. For example, the decoder control unit may control the one or more units of decoder 300 such that the bitstream 302 is decoded in conformance with one or more of ITU-T H.263, AVC, HEVC, VVC, VP8, VP9, AV1, and/or any other video coding standard/format.

The decoder control unit may determine/control one or more of: whether a block is inter predicted by inter prediction unit 316 or intra predicted by intra prediction unit 318, a motion vector for inter prediction of a block, an intra prediction mode among a plurality of intra prediction modes for intra prediction of a block, filtering performed by filter(s) 312, and/or one or more inverse transform types and/or inverse quantization parameters to be applied by inverse transform and quantization unit 308. One or more of the control parameters used by the decoder control unit may be packed in bitstream 302.

Entropy decoding unit 306 may entropy decode the bitstream 302. For example, entropy decoding unit 306 may apply context adaptive variable length coding (CAVLC), context adaptive binary arithmetic coding (CABAC), and syntax-based context-based binary arithmetic coding (SBAC) to decompress the prediction type used to encode a block (intra or inter prediction), prediction information of the block (intra prediction mode if intra predicted, motion vector, etc.), and transform and quantization parameters. Inverse transform and quantization unit 308 may inverse quantize and/or inverse transform the quantized transform coefficients to determine a decoded prediction error. Combiner 310 may combine the decoded prediction error with a prediction block to form a decoded block. The prediction block may be generated by intra prediction unit 318 or inter prediction unit 316 (e.g., as described above with respect to encoder 200 in FIG. 2). Filter(s) 312 may filter the decoded block, for example, using a deblocking filter, a sample-adaptive offset (SAO) filter, constrained directional enhancement filters (CDEFs), and/or loop restoration (LR) filters. Buffer 314 may store the decoded block for prediction of one or more other blocks in the same and/or different picture of the video sequence in bitstream 302. Decoded video sequence 304 may be output from filter(s) 312 as shown in FIG. 3.

Decoder 300 is merely an example and decoders different from decoder 300 and/or modified versions of decoder 300 may perform the methods and processes as described herein. For example, decoder 300 may have other components and/or arrangements. One or more of the components shown in FIG. 3 may be optionally included in decoder 300 (e.g., entropy decoding unit 306 and/or filters(s) 312).

Although not shown in FIGS. 2 and 3, each of encoder 200 and decoder 300 may further comprise an intra block copy unit in addition to inter prediction and intra prediction units. The intra block copy unit may perform/operate similar to an inter prediction unit but may predict blocks within the same picture. For example, the intra block copy unit may exploit repeated patterns that appear in screen content. The screen content may include computer generated text, graphics, animation, etc.

Video encoding and/or decoding may be performed on a block-by-block basis. The process of partitioning a picture into blocks may be adaptive based on the content of the picture. For example, larger block partitions may be used in areas of a picture with higher levels of homogeneity to improve coding efficiency.

A picture (e.g., in HEVC, or any other coding standard/format) may be partitioned into non-overlapping square blocks, which may be referred to as coding tree blocks (CTBs). The CTBs may comprise samples of a sample array. A CTB may have a size of 2n×2n samples, where n may be specified by a parameter of the encoding system. For example, n may be 4, 5, 6, or any other value. A CTB may have any other size. A CTB may be further partitioned by a recursive quadtree partitioning into coding blocks (CBs) of half vertical and half horizontal size. The CTB may form the root of the quadtree. A CB that is not split further as part of the recursive quadtree partitioning may be referred to as a leaf CB of the quadtree, and otherwise may be referred to as a non-leaf CB of the quadtree. A CB may have a minimum size specified by a parameter of the encoding system. For example, a CB may have a minimum size of 4×4, 8×8, 16×16, 32×32, 64×64 samples, or any other minimum size. A CB may be further partitioned into one or more prediction blocks (PBs) for performing inter and/or intra prediction. A PB may be a rectangular block of samples on which the same prediction type/mode may be applied. A CB may also be further partitioned into intra sub-partitions (ISP) where the reconstructed samples of each sub-partition are available to generate the prediction of the next sub-partition. For example, a CB may be split into 2 to 4 sub-partitions. For transformations, a CB may be partitioned into one or more transform blocks (TBs). A TB may be a rectangular block of samples that may determine/indicate an applied transform size.

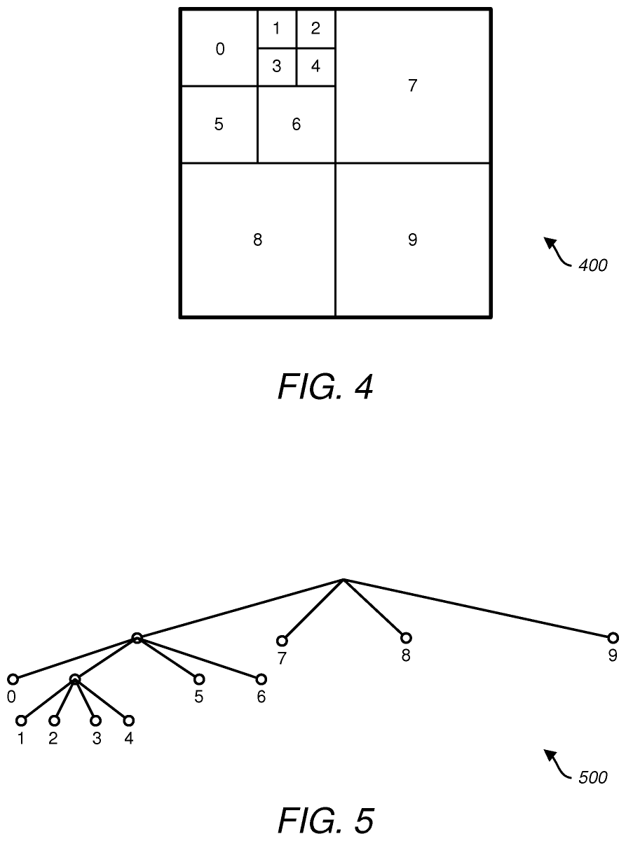

FIG. 4 shows an example quadtree partitioning of a CTB 400. FIG. 5 shows an example quadtree 500 corresponding to the example quadtree partitioning of CTB 400 in FIG. 4. As shown in the examples of FIGS. 4 and 5, CTB 400 may first be partitioned into four CBs of half vertical and half horizontal size. Three of the resulting CBs of the first level partitioning of CTB 400 are leaf CBs. The three leaf CBs of the first level partitioning of CTB 400 are respectively labeled 7, 8, and 9 in FIGS. 4 and 5. The non-leaf CB of the first level partitioning of CTB 400 is partitioned into four sub-CBs of half vertical and half horizontal size. Three of the resulting sub-CBs of the second level partitioning of CTB 400 are leaf CBs. The three leaf CBs of the second level partitioning of CTB 400 are respectively labeled 0, 5, and 6 in FIGS. 4 and 5. Finally, the non-leaf CB of the second level partitioning of CTB 400 is partitioned into four leaf CBs of half vertical and half horizontal size. The four leaf CBs are respectively labeled 1, 2, 3, and 4 in FIGS. 4 and 5.

The example CTB 400 of FIG. 4 is partitioned into 10 leaf CBs respectively labeled 0-9, but may be partitioned into other quantities of leaf CBs. The 10 leaf CBs may correspond to 10 CB leaf nodes (e.g., 10 CB leaf nodes of quadtree 500 as shown in FIG. 5). In other examples, a CTB may be partitioned into a different number of leaf CBs. The resulting quadtree partitioning of CTB 400 may be scanned using a z-scan (e.g., left-to-right, top-to-bottom) to form the sequence order for encoding/decoding the CB leaf nodes. A numeric label (e.g., indicator, index) of each CB leaf node in FIGS. 4 and 5 may correspond to the sequence order for encoding/decoding. For example, CB leaf node 0 may be encoded/decoded first and CB leaf node 9 may be encoded/decoded last. Although not shown in FIGS. 4 and 5, each CB leaf node may comprise one or more PBs and/or TBs.

A picture, in VVC (or in any other coding standard/format), may be partitioned in a similar manner (such as in HEVC). A picture may be first partitioned into non-overlapping square CTBs. The CTBs may then be partitioned, using a recursive quadtree partitioning, into CBs of half vertical and half horizontal size. A quadtree leaf node (e.g., in WVC) may be further partitioned by a binary tree or ternary tree partitioning (or any other partitioning) into CBs of unequal sizes.

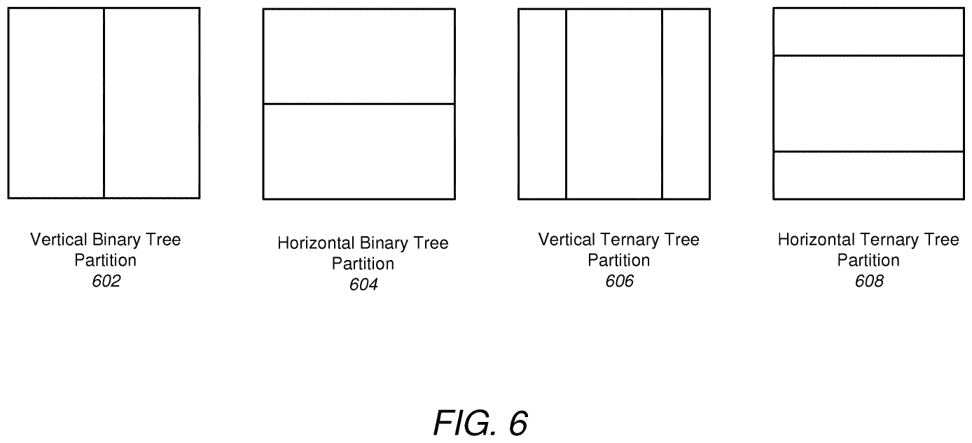

FIG. 6 shows example binary tree and ternary tree partitions. A binary tree partition may divide a parent block in half in either a vertical direction 602 or a horizontal direction 604. The resulting partitions may be half in size as compared to the parent block. In other examples, the resulting partitions may correspond to sizes that are less than and/or greater than half of the parent block size. A ternary tree partition may divide a parent block into three parts in either a vertical direction 606 or a horizontal direction 608. FIG. 6 shows an example in which the middle partition may be twice as large as the other two end partitions in the ternary tree partitions. In other examples, partitions may be of other sizes relative to each other and to the parent block. Binary and ternary tree partitions are examples of multi-type tree partitioning. Multi-type tree partitions may comprise partitioning a parent block into other quantities of smaller blocks. The block partitioning strategy (e.g., in VVC) may be referred to as a combination of quadtree and multi-type tree partitioning (quadtree+multi-type tree partitioning) because of the addition of binary and/or ternary tree partitioning to quadtree partitioning.

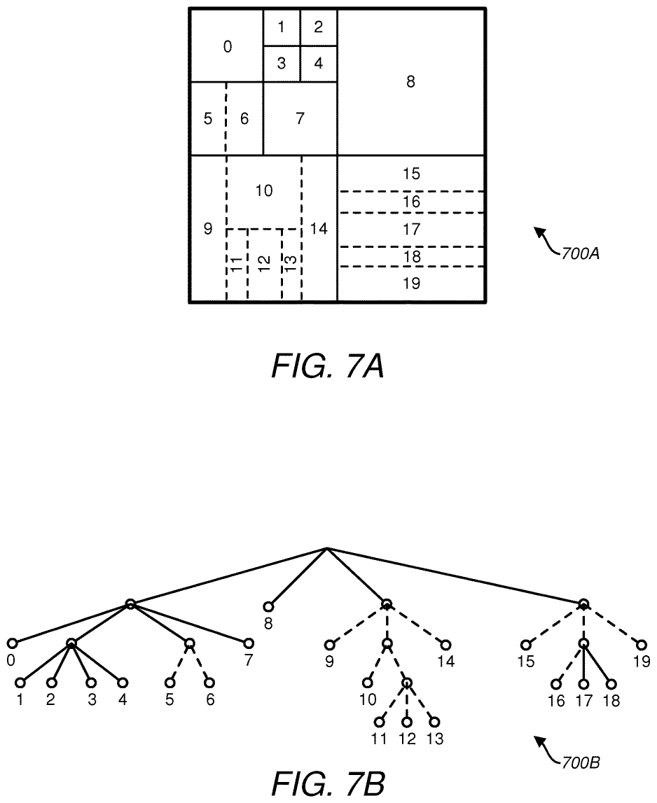

FIG. 7A shows an example of combined quadtree and multi-type tree partitioning of a CTB 700A. FIG. 7B shows an example tree 700B corresponding to the combined quadtree and multi-type tree partitioning of CTB 700A shown in FIG. 7A. In both FIGS. 7A and 7B, quadtree splits are shown in solid lines and multi-type tree splits are shown in dashed lines. For ease of explanation, CTB 700A is shown with the same quadtree partitioning as the CTB 400 described in FIG. 4, and a description of the quadtree partitioning of CTB 700A, which is similar to that for CTB 400, is omitted. The quadtree partitioning of the CTB 700A is merely an example and a CTB may be quadtree partitioned in a manner different from the CTB 700A. Additional multi-type tree partitions of CTB 700A may be made relative to three leaf CBs shown in FIG. 4. The three leaf CBs in FIG. 4 that are shown in FIG. 7A as being further partitioned may be leaf CBs 5, 8, and 9. The three leaf CBs may be further partitioned using one or more binary and/or ternary tree partitions.

The leaf CB 5 of FIG. 4 may be partitioned into two CBs based on a vertical binary tree partitioning. The two resulting CBs may be leaf CBs respectively labeled 5 and 6 in FIGS. 7A and 7B. The leaf CB 8 of FIG. 4 may be partitioned into three CBs based on a vertical ternary tree partition. Two of the three resulting CBs may be leaf CBs respectively labeled 9 and 14 in FIGS. 7A and 7B. The remaining, non-leaf CB may be partitioned first into two CBs based on a horizontal binary tree partition. One of the two CBs may be a leaf CB labeled 10. The other of the two CBs may be further partitioned into three CBs based on a vertical ternary tree partition. The resulting three CBs may be leaf CBs respectively labeled 11, 12, and 13 in FIGS. 7A and 7B. The leaf CB 9 of FIG. 4 may be partitioned into three CBs based on a horizontal ternary tree partition. Two of the three CBs may be leaf CBs respectively labeled 15 and 19 in FIGS. 7A and 7B. The remaining, non-leaf CB may be partitioned into three CBs based on another horizontal ternary tree partition. The resulting three CBs may all be leaf CBs respectively labeled 16, 17, and 18 in FIGS. 7A and 7B.

Altogether, CTB 700A may be partitioned into 20 leaf CBs respectively labeled 0-19. The 20 leaf CBs may correspond to 20 leaf nodes (e.g., 20 leaf nodes of tree 700B shown in FIG. 7B). The resulting combination of quadtree and multi-type tree partitioning of the CTB 700A may be scanned using a z-scan (left-to-right, top-to-bottom) to form the sequence order for encoding/decoding the CB leaf nodes. A numeric label of each CB leaf node in FIGS. 7A and 7B may correspond to the sequence order for encoding/decoding, with CB leaf node 0 encoded/decoded first and CB leaf node 19 encoded/decoded last. Although not shown in FIGS. 7A and 7B, it should be noted that each CB leaf node may comprise one or more PBs and/or TBS.

A coding standard/format (e.g., HEVC, VVC, or any other coding standard/format) may define various units (e.g., in addition to specifying various blocks (e.g., CTBs, CBS, PBs, TBs)). Blocks may comprise a rectangular area of samples in a sample array. Units may comprise the collocated blocks of samples from the different sample arrays (e.g., luma and chroma sample arrays) that form a picture as well as syntax elements and prediction data of the blocks. A coding tree unit (CTU) may comprise the collocated CTBs of the different sample arrays and may form a complete entity in an encoded bitstream. A coding unit (CU) may comprise the collocated CBs of the different sample arrays and syntax structures used to code the samples of the CBs. A prediction unit (PU) may comprise the collocated PBs of the different sample arrays and syntax elements used to predict the PBs. A transform unit (TU) may comprise TBs of the different samples arrays and syntax elements used to transform the TBs.

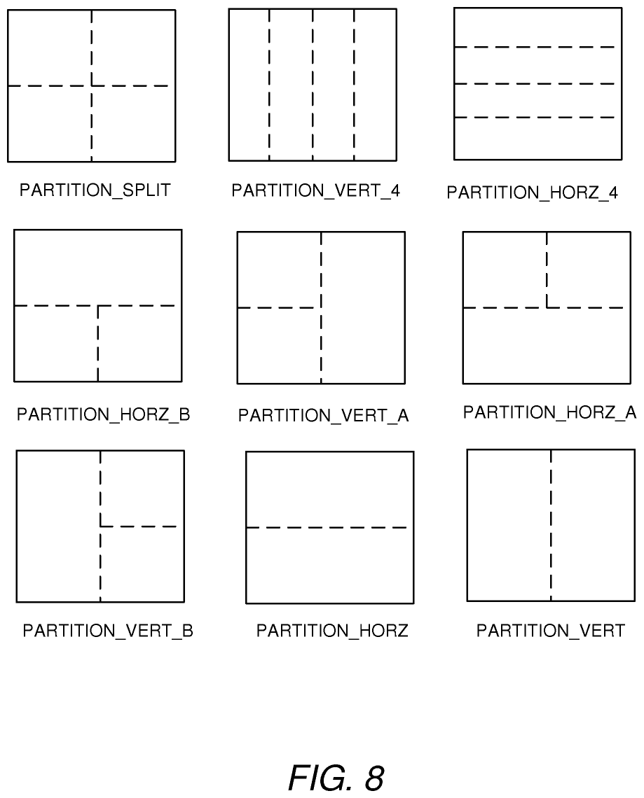

In some implementations of partitioning (e.g., AV1), a picture can be partitioned into multiple coding blocks. The largest coding blocks are also referred to as superblocks having sizes of either 128×128 or 64×64. Superblocks can be partitioned into smaller coding blocks which can be performed in nine partitioning modes. FIG. 8 shows the nine partitioning modes among which only PARTITION_SPLIT allows recursive partitioning. In addition, PARTITION_VERT_4 and PARTITION_HORZ_4 modes are not allowed for 8×8 or 128×128 coding blocks, and T-shaped partitioning modes are not allowed for 8×8 coding blocks. The minimum coding block size is 4×4. Intra and inter coding blocks can be further partitioned into transform blocks and the partitioning depth is up to two levels.

A block may refer to any of a CTB, CB, PB, TB, CTU, CU, PU, and/or TU (e.g., in the context of HEVC, WC, or any other coding format/standard). A block may be used to refer to similar data structures in the context of any video coding format/standard/protocol. For example, a block may refer to a macroblock in the AVC standard, a macroblock or a sub-block in the VP8 coding format, a superblock or a sub-block in the VP9 coding format, and/or a superblock or a sub-block (coding block or transform block) in the AV1 coding format.

In intra prediction, samples of a block to be encoded (e.g., also referred to as a current block) may be predicted from samples in a line of samples immediately adjacent to the current block. For example, the line of sample1s may include samples of the column immediately adjacent to the left-most column of the current block and samples of the row immediately adjacent to the top-most row of the current block. The samples from the immediately adjacent column and row may be jointly referred to as reference samples. Each sample of the current block may be predicted (e.g., in an intra prediction mode) by projecting the position of the sample in the current block in a given direction to a point along the reference samples. The sample may be predicted by interpolating between the two closest reference samples of the projection point if the projection does not fall directly on a reference sample. A prediction error (e.g., referred to as a residual) may be determined for the current block based on differences between the predicted sample values and the original sample values of the current block.

Predicting samples and determining a prediction error based on a difference between the predicted samples and original samples may be performed (e.g., at an encoder) for a plurality of different intra prediction modes (e.g., including non-directional intra prediction modes). The encoder may select one of the plurality of intra prediction modes and its corresponding prediction error to encode the current block. The encoder may send an indication of the selected prediction mode and its corresponding prediction error to a decoder for decoding of the current block. The decoder may decode the current block by predicting the samples of the current block, using the intra prediction mode indicated by the encoder, and/or combining the predicted samples with the prediction error.

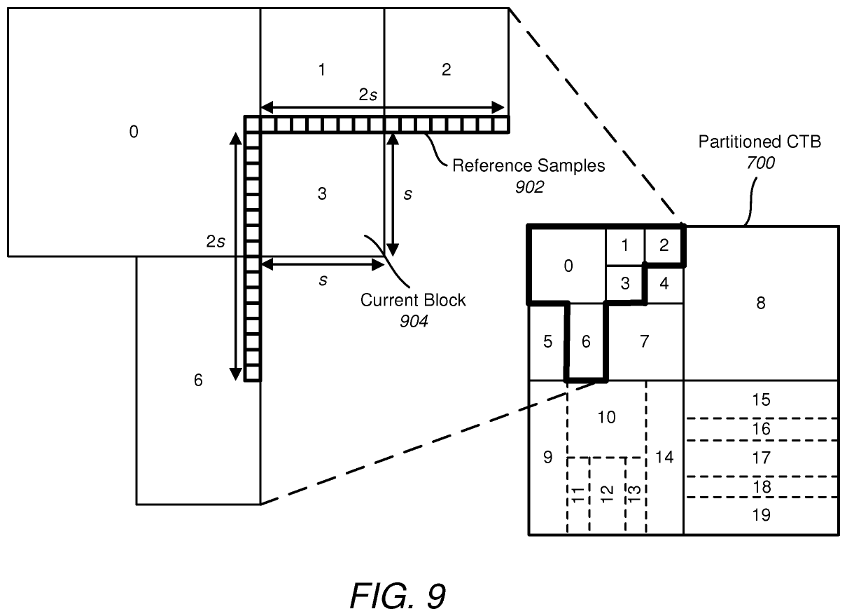

FIG. 9 shows an example set of reference samples 902 determined for intra prediction of a current block 904. Current block 904 may correspond to a block being encoded and/or decoded. Current block 904 may correspond to block 3 of partitioned CTB 700 as shown in FIG. 7A. As described herein, the numeric labels 0-19 of the blocks of partitioned CTB 700A may correspond to the sequence order for encoding/decoding the blocks and may be used as such in the example of FIG. 9.

In some embodiments, reference samples 902 may include a line of samples immediately adjacent to current block 904 and include samples from a column and a row immediately adjacent to current block 904. For example, the line of samples may include reference samples to the left and/or above current block 904. In some embodiments, reference samples 902 may be obtained (or selected) from a reference line of multiple reference lines (MRL), which may include a line of samples adjacent to current block 904 and also a line of non-adjacent samples. The MRL may include reference lines identified by corresponding reference line indices that indicate an i-th line of samples adjacent to current block 904 such that the 0-th line indicates the reference line immediate adjacent (or closest) to current block 904 and a higher numbered i-th line indicates a line of samples further away from current block 904. An encoder may select a reference line from a set of MRL and signal an MLR index in the bitstream to indicate the selected reference line. For example, the encoder may signal a codeword encoding the MRL index. The decoder may decode the codeword to determine the MRL index that identifies a specific reference line used in intra prediction of current block 904.

For current block 904 that is w×h samples in size, reference samples 902 may comprise: 2w samples (or any other quantity of samples) of an i-th row (e.g., indicated by an MRL index) adjacent to the top-most row of current block 904, 2 h samples (or any other quantity of samples) of the i-th column adjacent to the left-most column of current block 904, and the top left neighboring corner sample(s) extending from the i-th column and i-th row with respect to current block 904. Current block 904 may be square, such that w=h=s. In other examples, a current block need not be square, such that w #h. Available samples from neighboring blocks of current block 904 may be used for constructing the set of reference samples 902. Samples may not be available for constructing the set of reference samples 902, for example, if the samples lie outside the picture of the current block, the samples are part of a different slice of the current block (e.g., if the concept of slices is used), and/or the samples belong to blocks that have been inter coded and constrained intra prediction is indicated. Intra prediction may not be dependent on inter predicted blocks, for example, if constrained intra prediction is indicated.

Samples that may not be available for constructing the set of reference samples 902 may comprise samples in blocks that have not already been encoded and reconstructed at an encoder and/or decoded at a decoder based on the sequence order for encoding/decoding. Restriction of such samples from inclusion in the set of reference samples 902 may allow identical prediction results to be determined at both the encoder and decoder. In the example of FIG. 9, samples from neighboring blocks 0, 1, 2, and 8 may be available to construct reference samples 902 given that these blocks are encoded and reconstructed at an encoder and decoded at a decoder prior to coding of current block 904. The samples from neighboring blocks 0, 1, 2, and 8 may be available to construct reference samples 902, for example, if there are no other issues (e.g., as mentioned above) preventing the availability of the samples from the neighboring blocks 0, 1, 2, and 8. The portion of reference samples 902 from neighboring block 6 may not be available due to the sequence order for encoding/decoding (e.g., because the block 6 may not have already been encoded and reconstructed at the encoder and/or decoded at the decoder based on the sequence order for encoding/decoding).

In some examples, unavailable samples from reference samples 902 may be filled with one or more of the available reference samples 902. For example, an unavailable reference sample may be filled with a nearest available reference sample. The nearest available reference sample may be determined by moving in a clock-wise direction through reference samples 902 from the position of the unavailable reference. The reference samples 902 may be filled with the mid-value of the dynamic range of the picture being coded, for example, if no reference samples are available.

Samples of current block 904 may be intra predicted based on reference samples 902, for example, based on (e.g., after) determination and (optionally) filtering of reference samples 902. In some examples, a filtering scheme (e.g., a filtering algorithm) may be applied to reference samples 902 to improve prediction accuracy. The filtering scheme may be one of a plurality of filter types including at least: a smoothing filter (or reference sample smoothing filter) or an interpolation filter. In some examples, if reference samples of a given block are to be filtered, only one of the plurality of filter types is selected (e.g., activated) to be applied to the reference samples. For example, if the smoothing filter is selected (e.g., activated), the interpolation filter is not selected (e.g., disabled) or vice versa.

Many encoders/decoders may support a plurality of intra prediction modes in accordance with one or more video coding standards. For example, HEVC supports 35 intra prediction modes, including a planar mode, a direct current (DC) mode, and 33 angular modes. VVC supports 67 intra prediction modes, including a planar mode, a DC mode, and 65 angular modes. Planar and DC modes may be used to predict smooth and gradually changing regions of a picture. Angular modes may be used to predict directional structures in regions of a picture. Any quantity of intra prediction modes may be supported.

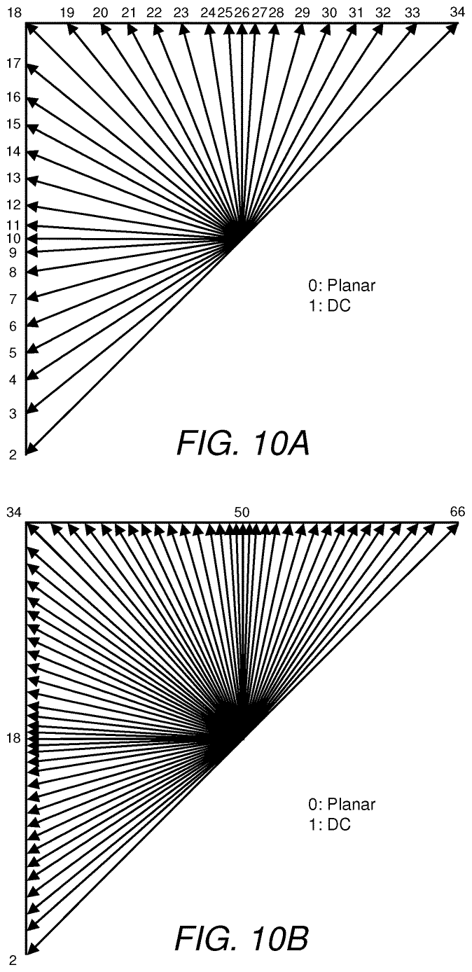

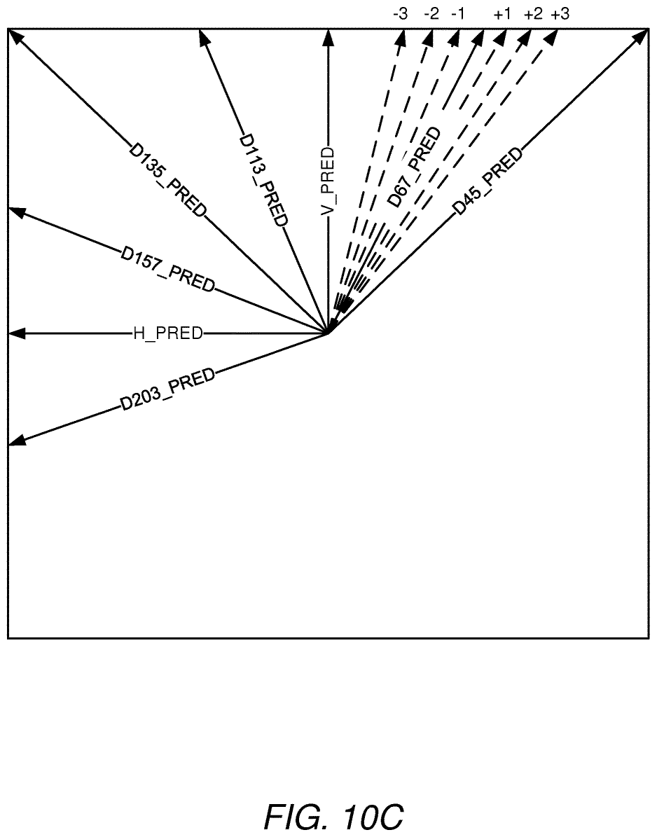

FIGS. 10A-B show example intra prediction modes. FIG. 10A shows 35 intra prediction modes, such as supported by HEVC. The 35 intra prediction modes may be indicated/identified by indices 0 to 34. Prediction mode 0 may correspond to planar mode. Prediction mode 1 may correspond to DC mode. Prediction modes 2-34 may correspond to angular modes. Prediction modes 2-18 may be referred to as horizontal prediction modes because the principal source of prediction is in the horizontal direction. Prediction modes 19-34 may be referred to as vertical prediction modes because the principal source of prediction is in the vertical direction.

FIG. 10B shows 67 intra prediction modes, such as supported by VVC. The 67 intra prediction modes may be indicated/identified by indices 0 to 66. Prediction mode 0 may correspond to planar mode. Prediction mode 1 corresponds to DC mode. Prediction modes 2-66 may correspond to angular modes. Prediction modes 2-34 may be referred to as horizontal prediction modes because the principal source of prediction is in the horizontal direction. Prediction modes 35-66 may be referred to as vertical prediction modes because the principal source of prediction is in the vertical direction. Some of the intra prediction modes illustrated in FIG. 10B may be adaptively replaced by wide-angle directions because blocks in VVC need not be squares.

In some implementations of intra prediction modes (e.g., as supported by AV1), the angular modes can be defined by specifying a set of nominal modes and a set of angle delta offsets can be defined around each of the nominal modes. For example, there may be eight nominal angular prediction modes each having a set of angle delta offsets indexed between −3 and +3 with the nominal angle located at 0. FIG. 10C shows the eight nominal modes (in solid arrows) and the set of angle delta offsets around the D67_PRED nominal angle (in dotted arrows). The prediction angle can be derived by adding the offset to the associated nominal angle. As a result, there are 56 angular modes in AV1. Note that for small blocks, such as 4×4, 4×8, and 8×4, only nominal angular modes are applied. In addition to the 56 angular modes, there are five non-angular intra-prediction modes in AV1, including DC_PRED mode (averaging samples from reconstructed neighboring blocks), SMOOTH_V AND SMOOTH_H modes (using quadratic interpolation along the vertical and horizontal directions, respectively), SMOOTH mode (averaging the quadratic interpolation results along both directions), and Paeth mode (predicting each sample from its top, left and top left reference samples). Recursive intra-prediction modes may also be used where a coding block is divided into sub-blocks and each intra-predicted sub-block can be used to intra-predict the next sub-block.

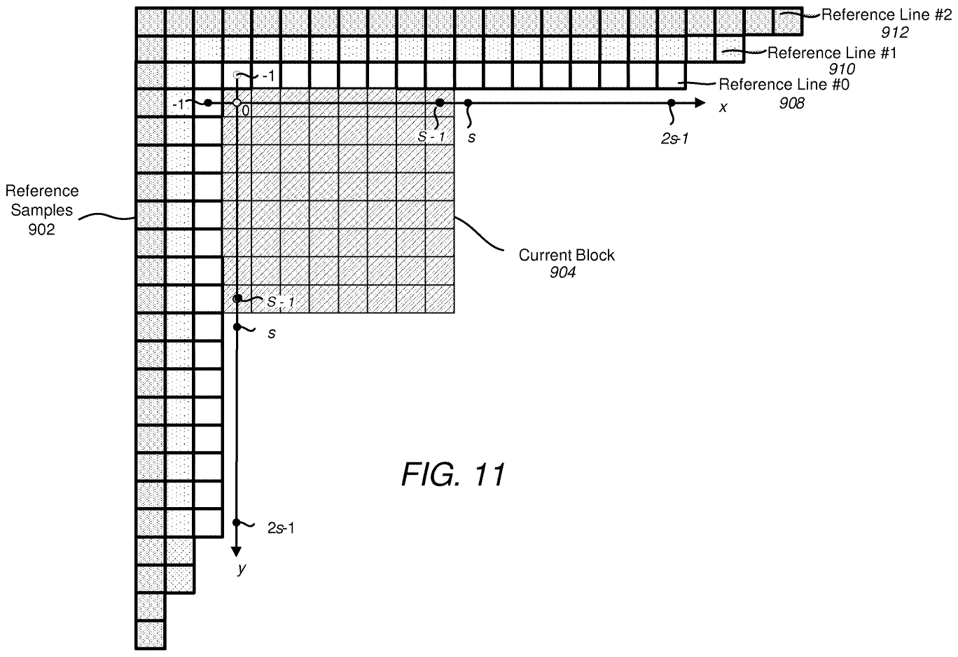

FIG. 11 shows a current block 904 and corresponding reference samples 902 from FIG. 9. To further describe how intra prediction modes are applied to determine a prediction (e.g., a prediction block) of current block 904, FIG. 11 shows current block 904 and reference samples 902, from a reference line among a set of multiple reference lines (MRL) 908-912, in a two-dimensional x, y plane, where a sample may be referenced as p[x][y]. To simplify the prediction process, reference samples 902 may be placed in two, one-dimensional arrays. The reference samples 902 belonging to a reference line l from the set of MRL 908-912, above the current block 904, may be placed in the one-dimensional array ref₁[x]:

ref₁[x]=p[−l+x][−l],(x≥0). (1)

The reference samples 902 belonging to reference line l, to the left of current block 904, may be placed in the one-dimensional array ref₂[y]:

ref₂[y]=p[−][−l+y],(y≥0). (2)

The variable/represents how many lines away the selected reference line is from current block. For example, if reference line #0 908 is selected, then/is set to 1 to indicate the reference line adjacent to current block 904. For example, if reference line #1 910 is selected, then/is set to 2. For example, if reference line #2 912 is selected, then/is set to 3.

In some examples, if MRL is not activated or selected, then reference samples 902 may be from reference line #0 908 that is immediately adjacent to current block 904. In this example, the variable/in Equations (1) and (2) is set to 1.

The prediction process may comprise determination of a predicted sample p[x][y] (e.g., a predicted value) at a location [x][y] in current block 904. For planar mode, a sample at the location [x][y] in current block 904 may be predicted by determining/calculating the mean of two interpolated values. The first of the two interpolated values may be based on a horizontal linear interpolation at the location [x][y] in current block 904. The second of the two interpolated values may be based on a vertical linear interpolation at location [x][y] in current block 904. The predicted sample p[x][y] in current block 904 may be determined/calculated as:

$$p [ x ] [ y ] = \frac{1}{2 \cdot s} ( h [ x ] [ y ] + v [ x ] [ y ] + s ) , \qquad ( 3 )$$

$$where$$

$$h [ x ] [ y ] = ( s - x - 1 ) \cdot {ref}_{2} [ y ] + ( x + 1 ) \cdot {ref}_{1} [ s ] \qquad ( 4 )$$

may be the horizonal linear interpolation at the location [x][y] in current block 904 and

v[x][y]=(s−y−1)·ref₁[x]+(y+1)·ref₂ [s]

may be the vertical linear interpolation at the location [x][y] in current block 904. s may be equal to a length of a side (e.g., a number of samples on a side) of the current block 904.

For DC mode, a sample at a location [x][y] in current block 904 may be predicted by the mean of the reference samples 902. The predicted sample p[x][y] in current block 904 may be determined/calculated as:

$$p [ x ] [ y ] = \frac{1}{2 \cdot s} ( {\sum }_{x = 0}^{s - 1} {ref}_{1} [ x ] + {\sum }_{y = 0}^{s - 1} {ref}_{2} [ y ] ) . \qquad ( 6 )$$

For angular modes, a sample at a location [x][y] in current block 904 may be predicted by projecting the location [x][y] in a direction specified by a given angular mode to a point on the horizontal or vertical line of samples comprising reference samples 902. The sample at the location [x][y] may be predicted by interpolating between the two closest reference samples of the projection point if the projection does not fall directly on a reference sample. The direction specified by the angular mode may be given by an angle φ defined relative to the y-axis for vertical prediction modes (e.g., modes 19-34 in HEVC and modes 35-66 in VVC). The direction specified by the angular mode may be given by an angle q defined relative to the x-axis for horizontal prediction modes (e.g., modes 2-18 in HEVC and modes 2-34 in VVC).

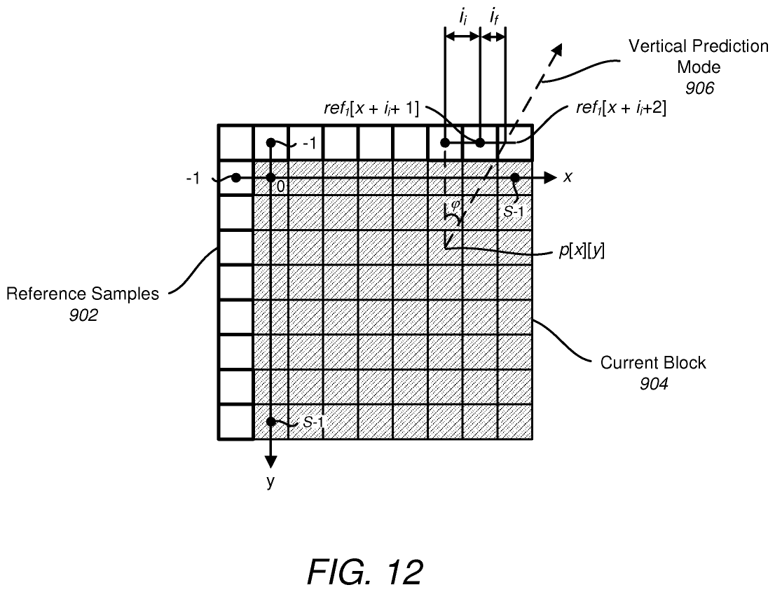

FIG. 12 shows an example of applying an intra prediction mode (e.g., an angular mode such as vertical prediction mode 906) for prediction of a current block 904. FIG. 12 specifically shows prediction of a sample at a location [x][y] in current block 904 for a vertical prediction mode 906. Vertical prediction mode 906 may be given by an angle φ with respect to the vertical axis. The location [x][y] in current block 904, in vertical prediction modes, may be projected to a point (e.g., referred to as a projection point) on the horizontal line of reference samples ref₁[x]. The reference samples 902 are only partially shown in FIG. 12 and shown as being from a reference line with reference line index of 0 for ease of illustration. Reference samples 902 may be from another reference line of the set of MRL, as explained in FIG. 9. As shown in FIG. 12, the projection point on the horizontal line of reference samples ref₁[x] may not be exactly on a reference sample. A predicted sample p[x][y] in current block 904 may be determined/calculated by linearly interpolating between the two reference samples, for example, if the projection point falls at a fractional sample position between two reference samples. The predicted sample p[x][y] may be determined/calculated as:

p[x][y]=(1−i_{f})·ref₁[x+i_{f}+1]i_{f}·ref₁[x+i₂+2]. (7)

iᵢ may be the integer part of the horizontal displacement of the projection point relative to the location [x][y]. iᵢ may be determined/calculated as a function of the tangent of the angle φ of the vertical prediction mode 906 as:

iᵢ=└(y+1)·tan φ┘. (8)

i_{f} may be the fractional part of the horizontal displacement of the projection point relative to the location [x][y] and may be determined/calculated as:

i_{f}=((y+1)·tan φ)−└(y+1)·tan φ┘, (9)

where └·┘ is the integer floor function.

For horizontal prediction modes, a location [x][y] of a sample in current block 904 may be projected onto the vertical line of reference samples ref₂[y]. A predicted sample p[x][y] for horizontal prediction modes may be determined/calculated as:

p[x][y]=(1−i_{f})·ref₂[y+iᵢ+1]+i_{f}·ref₂[y+iᵢ+2]. (10)

iᵢ may be the integer part of the vertical displacement of the projection point relative to the location [x][y]. i_{f} may be determined/calculated as a function of the tangent of the angle q of the horizontal prediction mode as:

iᵢ=└x+1)·tan φ┘. (11)

i_{f} may be the fractional part of the vertical displacement of the projection point relative to the location [x][y]. i_{f} may be determined/calculated as:

i_{f}=((x+1)·tan φ)−└(x+1)·tan φ┘, (12)

where └·┘ is the integer floor function.

The interpolation functions given by Equations (7) and (10) may be implemented by an encoder and/or a decoder (e.g., encoder 200 in FIG. 2 and/or decoder 300 in FIG. 3). The interpolation functions may be implemented by finite impulse response (FIR) filters. For example, the interpolation functions may be implemented as a set of two-tap FIR filters. The coefficients of the two-tap FIR filters may be respectively given by (1−i_{f}) and i_{f}. The predicted sample p[x][y], in angular intra prediction, may be calculated with some predefined level of sample accuracy (e.g., 1/32 sample accuracy, or accuracy defined by any other metric). For 1/32 sample accuracy, the set of two-tap FIR interpolation filters may comprise up to 32 different two-tap FIR interpolation filters-one for each of the 32 possible values of the fractional part of the projected displacement i_{f}. In other examples, different levels of sample accuracy may be used.

In some examples, the FIR filters may be used for predicting chroma samples and/or luma samples. For example, the two-tap interpolation FIR filter may be used for predicting chroma samples and a same and/or a different interpolation technique/filter may be used for luma samples. For example, a four-tap FIR filter may be used to determine a predicted value of a luma sample. Coefficients of the four tap FIR filter may be determined based on i_{f} (e.g., similar to the two-tap FIR filter). For 1/32 sample accuracy, a set of 32 different four-tap FIR filters may comprise up to 32 different four-tap FIR filters—one for each of the 32 possible values of the fractional part of the projected displacement if. In other examples, different levels of sample accuracy may be used. The set of four-tap FIR filters may be stored in a look-up table (LUT) and referenced based on if. A predicted sample p[x][y], for vertical prediction modes, may be determined based on the four-tap FIR filter as:

$$p [ x ] [ y ] = {\sum }_{i = 0}^{3} fT [ i ] \cdot {ref}_{1} [ y + ildx + i ] , \qquad ( 13 )$$

where fT[i], i=0 . . . 3, may be the filter coefficients, and Idx is integer displacement. A predicted sample p[x][y], for horizontal prediction modes, may be determined based on the four-tap FIR filter as:

$$p [ x ] [ y ] = {\sum }_{i = 0}^{3} fT [ i ] \cdot {ref}_{2} [ y + ildx + i ] . \qquad ( 14 )$$

Supplementary reference samples may be determined/constructed if the location [x][y] of a sample in current block 904 to be predicted is projected to a negative x coordinate. The location [x][y] of a sample may be projected to a negative x coordinate, for example, if negative vertical prediction angles φ are used. The supplementary reference samples may be determined/constructed by projecting the reference samples in ref₂[y] in the vertical line of reference samples 902 to the horizontal line of reference samples 902 using the negative vertical prediction angle φ. Supplementary reference samples may be similarly determined/constructed, for example, if the location [x][y] of a sample in current block 904 to be predicted is projected to a negative y coordinate. The location [x][y] of a sample may be projected to a negative y coordinate, for example, if negative horizontal prediction angles φ are used. The supplementary reference samples may be determined/constructed by projecting the reference samples in ref₁[x] on the horizontal line of reference samples 902 to the vertical line of reference samples 902 using the negative horizontal prediction angle φ.

An encoder may determine/predict samples of a current block being encoded (e.g., current block 904) for a plurality of intra prediction modes (e.g., using one or more of the functions described herein). For example, an encoder may determine/predict samples of a current block for each of 35 intra prediction modes in HEVC and/or 67 intra prediction modes in VVC and/or including extended intra prediction modes from WAIP for rectangular blocks. The encoder may determine, for each intra prediction mode applied, a corresponding prediction error for the current block based on a difference (e.g., sum of squared differences (SSD), sum of absolute differences (SAD), or sum of absolute transformed differences (SATD)) between the prediction samples, generated from reference samples 902 of a reference line (e.g., from a set of MRL), determined for the intra prediction mode and the original samples of the current block. The encoder may determine/select one of the intra prediction modes to encode the current block based on the determined prediction errors. For example, the encoder may determine/select one of the intra prediction modes that results in the smallest prediction error for the current block. In some examples, the encoder may determine/select the intra prediction mode and the associated reference line to encode the current block based on a rate-distortion measure (e.g., Lagrangian rate-distortion cost) determined using the prediction errors. The encoder may signal, in the bitstream to a decoder for decoding of the current block, an indication of the determined/selected intra prediction mode and an indication of the associated MRL index (which may indicate a reference line index). The encoder may also signal in the bitstream to the decoder a corresponding prediction error (e.g., residual) of the intra prediction mode.

A decoder may determine/predict samples of a current block being decoded (e.g., current block 904) for an intra prediction mode. For example, a decoder may receive an indication of a reference line (e.g., a reference line index or an MRL index associated with the reference line index) and an intra prediction mode (e.g., an angular intra prediction mode) from an encoder for a current block. The decoder may retrieve a set of reference samples and perform intra prediction based on the MRL index and the intra prediction mode indicated by the encoder for the current block in a similar manner (e.g., as described above for the encoder). For example, the decoder may obtain the reference samples from a reference line indicated/identified by the decoded MRL index. In some examples, when MRL is not enabled/activated/selected, the reference line has reference line index 0 and is immediately adjacent to the current block. In these examples, no indication of MRL index is signaled.

The decoder may add predicted values of the samples (e.g., determined based on the intra prediction mode) of the current block to a residual of the current block to reconstruct the current block. In some examples, a decoder need not receive an indication of an angular intra prediction mode from an encoder for a current block. Instead, the decoder may determine an intra prediction mode through other decoder-side means (e.g., by applying template-based intra mode derivation (TIMD) tool/technique).

While various examples herein correspond to intra prediction modes in HEVC and VVC, the methods, devices, and systems as described herein may be applied to/used for other intra prediction modes (e.g., as used in other video coding standards/formats, such as VP8, VP9, AV1, etc.).

Intra prediction may exploit correlations between spatially neighboring samples in the same picture of a video sequence to perform video compression. Inter prediction is another coding tool that may be used to perform video compression. Inter prediction may exploit correlations in the time domain between blocks of samples in different pictures of a video sequence. For example, an object may be seen across multiple pictures of a video sequence. The object may move (e.g., by some translation and/or affine motion) or remain stationary across the multiple pictures. A current block of samples in a current picture being encoded may have/be associated with a corresponding block of samples in a previously decoded picture. The corresponding block of samples may accurately predict the current block of samples. The corresponding block of samples may be displaced from the current block of samples, for example, due to movement of the object, represented in both blocks, across the respective pictures of the blocks. The previously decoded picture may be a reference picture. The corresponding block of samples in the reference picture may be a reference block for motion compensated prediction. An encoder may use a block matching technique to estimate the displacement (or motion) of the object and/or to determine the reference block in the reference picture.

Similar to intra prediction, an encoder may determine a difference between a current block and a prediction for a current block. An encoder may determine a difference, for example, based on/after determining/generating a prediction for a current block (e.g., using inter prediction). The difference may be a prediction error (e.g., a residual). The encoder may store and/or send (e.g., signal), in/via a bitstream, the prediction error and/or other related prediction information. The prediction error and/or other related prediction information may be used for decoding and/or other forms of consumption. A decoder may decode the current block by predicting the samples of the current block (e.g., by using the related prediction information) and combining the predicted samples with the prediction error.

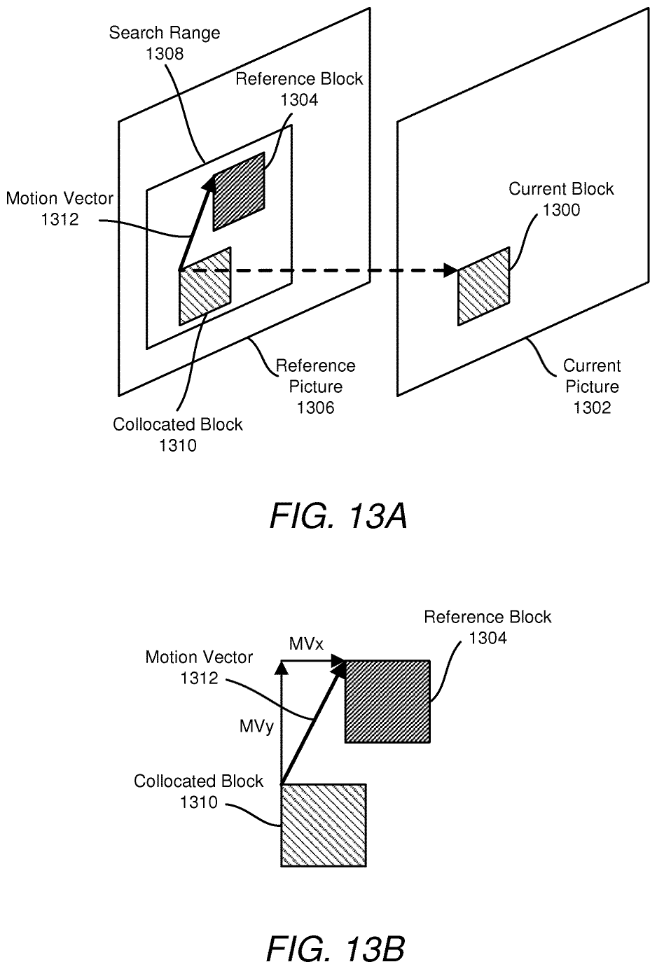

FIG. 13A shows an example of inter prediction. The inter prediction may be performed for a current block 1300 in a current picture 1302 being encoded. An encoder (e.g., encoder 200 as shown in FIG. 2) may perform inter prediction to determine and/or generate a reference block 1304 in a reference picture 1306. Reference block 1304 may be used to predict the current block 1300. Reference pictures (e.g., reference picture 1306) may be prior decoded pictures available at the encoder and/or a decoder. Availability of a prior decoded picture may depend/be based on whether the prior decoded picture is available in a decoded picture buffer, at the time, current block 1300 is being encoded and/or decoded. The encoder may search the one or more reference pictures 1306 for a block (e.g., a candidate reference block) that is similar (or substantially similar) to current block 1300. The encoder may determine the best matching block from the blocks (e.g., candidate reference blocks) tested during the searching process. The best matching block may be a reference block 1304. The encoder may determine that reference block 1304 is the best matching reference block based on one or more cost criteria. The one or more cost criteria may comprise a rate-distortion criterion (e.g., Lagrangian rate-distortion cost). The one or more cost criteria may be based on a difference (e.g., SSD, SAD, and/or SATD) between prediction samples of reference block 1304 and original samples of current block 1300.

The encoder may search for reference block 1304 within a reference region (e.g., a search range 1308). The reference region (e.g., a search range 1308) may be positioned around a collocated block (or position) 1310, of current block 1300, in reference picture 1306. Collocated block 1310 may have a same position in the reference picture 1306 as the current block 1300 in the current picture 1302. The reference region (e.g., search range 1308) may at least partially extend outside of reference picture 1306. Constant boundary extension may be used, for example, if the reference region (e.g., search range 1308) extends outside of reference picture 1306. The constant boundary extension may be used such that values of the samples in a row or a column of reference picture 1306, immediately adjacent to a portion of the reference region (e.g., search range 1308) extending outside of reference picture 1306, may be used for sample locations outside of reference picture 1306. A subset of potential positions, or all potential positions, within the reference region (e.g., search range 1308) may be searched for reference block 1304. The encoder may utilize one or more search implementations to determine and/or generate the reference block 1304. For example, the encoder may determine a set of candidate search positions based on motion information of neighboring blocks (e.g., a motion vector 1312) to the current block 1300.

One or more reference pictures may be searched by the encoder during inter prediction to determine and/or generate the best matching reference block. The reference pictures searched by the encoder may be included in (e.g., added to) one or more reference picture lists. For example, in HEVC and VVC (and/or in one or more other communication protocols), two reference picture lists may be used (e.g., a reference picture list 0 and a reference picture list 1). A reference picture list may include one or more pictures. The reference picture 1306 of reference block 1304 may be indicated by a reference index pointing into a reference picture list comprising reference picture 1306. The reference frames can include different types of frames. For example, in some implementations (e.g., such as in AV1), up to seven frames can be used as reference frames and there are four types of frames, including LAST frame (a frame that was displayed in the near past), BWD frame (a frame that will be displayed in the future), GOLDEN frame (a frame that was displayed in the distant past), and ARF frame (a frame from either the past or the future).

FIG. 13B shows an example motion vector. A displacement between reference block 1304 and current block 1300 may be interpreted as an estimate of the motion between reference block 1304 and current block 1300 across their respective pictures. The displacement may be represented by a motion vector 1312. For example, motion vector 1312 may be indicated by a horizontal component (MVx) and a vertical component (MVy) relative to the position of current block 1300. A motion vector (e.g., motion vector 1312) may have fractional or integer resolution. A motion vector with fractional resolution may point between two samples in a reference picture to provide a better estimation of the motion of current block 1300. For example, a motion vector may have ½, ¼, ⅛, 1/16, 1/32, or any other fractional sample resolution. Interpolation between the two samples at integer positions may be used to generate a reference block and its corresponding samples at fractional positions, for example, if a motion vector points to a non-integer sample value in the reference picture. The interpolation may be performed by a filter with two or more taps.

The encoder may determine a difference (e.g., a corresponding sample-by-sample difference) between reference block 1304 and current block 1300. The encoder may determine the difference between reference block 1304 and current block 1300, for example, based on/after reference block 1304 is determined and/or generated, using inter prediction, for current block 1300. The difference may be a prediction error (e.g., a residual). The encoder may store and/or send (e.g., signal), in/via a bitstream, the prediction error and/or related motion information. The prediction error and/or the related motion information may be used for decoding (e.g., decoding current block 1300) and/or other forms of consumption. The motion information may comprise the motion vector 1312 and a reference indicator/index. The reference indicator may indicate the reference picture 1306 in a reference picture list. In other examples, the motion information may comprise an indication of motion vector 1312 and/or an indication of the reference indicator/index. The reference indicator may indicate reference picture 1306 in the reference picture list comprising reference picture 1306. A decoder may decode current block 1300 by determining and/or generating the reference block 1304, which may correspond to/form (e.g., be considered as) a prediction of the current block 1300. The decoder may determine and/or generate the reference block 1304, for example, based on the related motion information. The decoder may decode current block 1300 based on combining the prediction (e.g., a reference block) with the prediction error (e.g., a residual block).

Inter prediction, as shown in FIG. 13A, may be performed using one reference picture 1306 as a source of a prediction for current block 1300. Inter prediction based on a prediction of a current block using a single picture may be referred to as uni-prediction or single reference inter prediction.

Inter prediction of a current block, using bi-prediction or compound prediction, may be based on two pictures (e.g., the source of prediction may be from the two pictures). Bi-prediction may be useful, for example, if a video sequence comprises fast motion, camera panning, zooming, and/or scene changes. Bi-prediction also may be useful to capture fade outs of one scene or fade outs from one scene to another, where two pictures may effectively be displayed simultaneously with different levels of intensity.

One or both of uni-prediction and bi-prediction may be available/used for performing inter prediction (e.g., at an encoder and/or at a decoder). Performing a specific type of inter prediction (e.g., uni-prediction/single reference prediction and/or bi-prediction/compound prediction) may depend on a slice type of current block. For example, for P slices, only uni-prediction may be available/used for performing inter prediction. For B slices, either uni-prediction or bi-prediction may be available/used for performing inter prediction. An encoder may determine and/or generate a reference block, for predicting a current block, from a reference picture list 0, for example, if the encoder is using uni-prediction. An encoder may determine and/or generate a first reference block, for predicting a current block, from a reference picture list 0 and determine and/or generate a second reference block, for predicting the current block, from a reference picture list 1, for example, if the encoder is using bi-prediction.

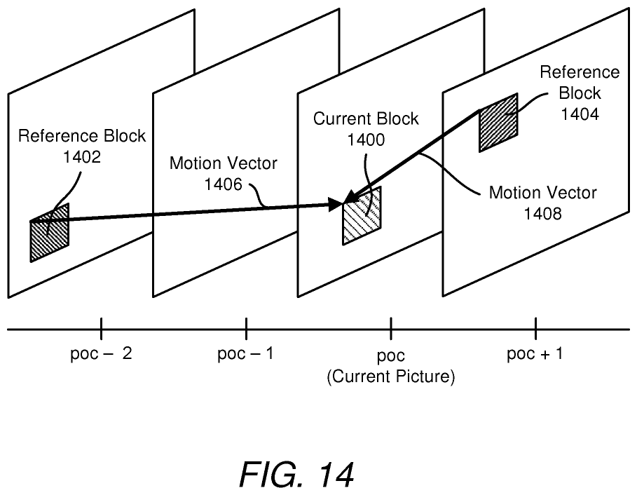

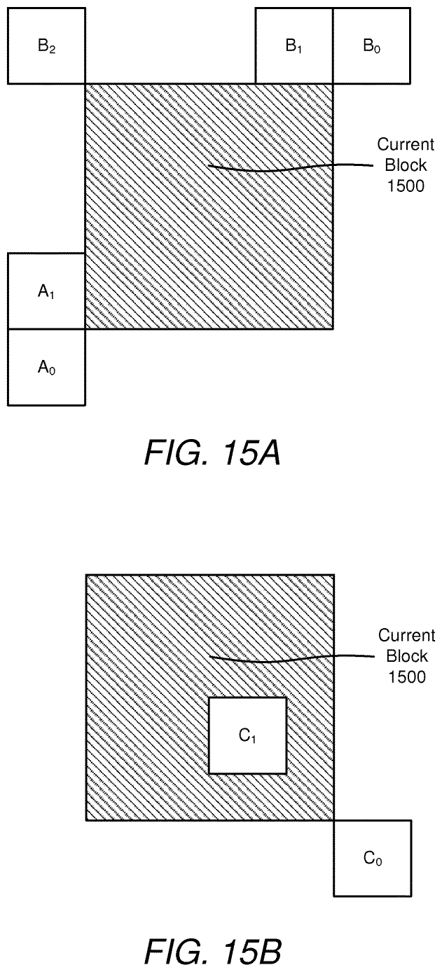

FIG. 14 shows an example of bi-prediction/compound prediction. Two reference blocks 1402 and 1404 may be used to predict a current block 1400. For example, reference block 1402 may be in a reference picture of one of reference picture list 0 or reference picture list 1. Reference block 1404 may be in a reference picture of another one of reference picture list 0 or reference picture list 1. As shown in FIG. 14, reference block 1402 may be in a first picture that precedes (e.g., in time) a current picture of current block 1400, and the reference block 1404 may be in a second picture that succeeds (e.g., in time) the current picture of current block 1400. The first picture may precede the current picture in terms of a picture order count (POC) or a display order. The second picture may succeed the current picture in terms of the POC or the display order. In other examples, the reference pictures may both precede or both succeed the current picture in terms of POC or the display order. A POC may be/indicate an order in which pictures are output (e.g., from a decoded picture buffer). A POC may be/indicate an order in which pictures are generally intended to be displayed. Pictures that are output may not necessarily be displayed but may undergo different processing and/or consumption (e.g., transcoding). The two reference blocks determined and/or generated using/for bi-prediction may correspond to (e.g., be comprised in) a same reference picture. The reference picture may be included in both the reference picture list 0 and the reference picture list 1, for example, if the two reference blocks correspond to the same reference picture.

A configurable weight and/or offset value may be applied to one or more inter prediction reference blocks. An encoder may enable the use of weighted prediction using a flag in a picture parameter set (PPS) or a set of parameters at a similar level. The encoder may send/signal the weight and/or offset parameters in a slice segment header for current block 1400. Different weight and/or offset parameters may be sent/signaled for luma and/or chroma components.

The encoder may determine and/or generate the reference blocks 1402 and 1404 for the current block 1400 using inter prediction. The encoder may determine a difference between current block 1400 and each of reference blocks 1402 and 1404. The differences may be prediction errors or residuals. The encoder may store and/or send/signal, in/via a bitstream, the prediction errors and/or their respective related motion information. The prediction errors and their respective related motion information may be used for decoding and/or other forms of consumption.

The motion information for reference block 1402 may comprise a motion vector 1406 and/or a reference indicator/index. The reference indicator may indicate a reference picture, of the reference block 1402, in a reference picture list. In some examples, the motion information for reference block 1402 may comprise an indication of motion vector 1406 and/or an indication of the reference index. The reference index may indicate the reference picture, of reference block 1402, in the reference picture list.

The motion information for reference block 1404 may comprise a motion vector 1408 and/or a reference index/indicator. The reference indicator may indicate a reference picture, of the reference block 1404, in a reference picture list. The motion information for reference block 1404 may comprise an indication of motion vector 1408 and/or an indication of the reference index. The reference index may indicate the reference picture, of the reference block 1404, in the reference picture list.

A decoder may decode current block 1400 by determining and/or generating the reference blocks 1402 and 1404. The decoder may determine and/or generate the reference blocks 1402 and 1404, for example, based on the respective related motion information for the reference blocks 1402 and 1404. The reference blocks 1402 and 1404 may correspond to/form (e.g., be considered as) the prediction (e.g., used to generate a prediction block) of the current block 1400. The decoder may decode the current block 1400 based on combining the prediction with the prediction errors.

Motion information may be predictively coded, for example, before being stored and/or sent/signaled in/via a bit stream (e.g., in HEVC, VVC, and/or other video coding standards/formats/protocols). The motion information for a current block may be predictively coded based on motion information of one or more blocks neighboring the current block. The motion information of the neighboring block(s) may often correlate with the motion information of the current block because the motion of an object represented in the current block is often the same as (or similar to) the motion of objects in the neighboring block(s). Motion information prediction techniques (such as those in HEVC and VVC) may comprise advanced motion vector prediction (AMVP) and/or inter prediction block merging (e.g., merge mode).

An encoder (e.g., encoder 200 as shown in FIG. 2), may code a motion vector. The encoder may code the motion vector (e.g., using AMVP) as a difference between a motion vector of a current block being coded and a motion vector predictor (MVP). An encoder may determine/select the MVP from a list of candidate MVPs. The candidate MVPs may be/correspond to previously decoded motion vectors of neighboring blocks in the current picture of the current block, and/or blocks at or near the collocated position of the current block in other reference pictures. The encoder and/or a decoder may reciprocally generate and/or determine the list of candidate MVPs.

The encoder may determine/select an MVP from the list of candidate MVPs. Then, the encoder may send/signal, in/via a bitstream, an indication of the selected MVP and/or a motion vector difference (MVD). The encoder may indicate the selected MVP in the bitstream using an index/indicator. The index may indicate the selected MVP in the list of candidate MVPs. The MVD may be determined/calculated based on a difference between the motion vector of the current block and the selected MVP. For example, for a motion vector (e.g., comprising a horizontal component (MVx) and a vertical component (MVy)) that indicates a position relative to a position of the current block being coded, the MVD may be represented by two components MVDₓ and MVD_{y}. MVDₓ and MVD_{y} may be determined/calculated as:

MVDₓ=MVₓ−MVPₓ, (15)

MVD_{y}=MV_{y}−MVP_{y}. (16)

MVDx and MVDy may respectively represent horizontal and vertical components of the MVD. MVPx and MVPy may respectively represent horizontal and vertical components of the MVP.

A decoder (e.g., decoder 300 as shown in FIG. 3) may decode the motion vector by adding the MVD to the MVP indicated in/via the bitstream. The decoder may decode the current block by determining and/or generating the reference block. The decoder may determine and/or generate the reference block, for example, based on the decoded motion vector. The reference block may correspond to/form (e.g., be considered as) the prediction of the current block (e.g., a prediction block). The decoder may decode the current block by combining the prediction with the prediction error.

The list of candidate MVPs (e.g., in HEVC, VVC, and/or one or more other communication protocols), for AMVP, may comprise two or more candidates (e.g., candidates A and B). Candidates A and B may comprise: up to two (or any other quantity of) spatial candidate MVPs determined/derived from five (or any other quantity of) spatial neighboring blocks of a current block being coded; one (or any other quantity of) temporal candidate MVP determined/derived from two (or any other quantity of) temporal, co-located blocks (e.g., if both of the two spatial candidate MVPs are not available or are identical); and/or zero motion vector candidate MVPs (e.g., if one or both of the spatial candidate MVPs or temporal candidate MVPs are not available). Other quantities of spatial candidate MVPs, spatial neighboring blocks, temporal candidate MVPs, and/or temporal, co-located blocks may be used for the list of candidate MVPs.

FIG. 15A shows example spatial candidate neighboring blocks for a current block. For example, five (or any other quantity of) spatial candidate neighboring blocks may be located relative to a current block 1500 being encoded. The five spatial candidate neighboring blocks may be A0, A1, B0, B1, and B2. FIG. 15B shows temporal, co-located blocks for the current block. For example, two (or any other quantity of) temporal, co-located blocks may be located relative to current block 1500 being coded. The two temporal, co-located blocks may be C0 and C1. The two temporal, co-located blocks may be in one or more reference pictures that may be different from the current picture of current block 1500.

An encoder (e.g., encoder 200 as shown in FIG. 2) may code a motion vector using inter prediction block merging (e.g., a merge mode). For example, the encoder (e.g., using merge mode) may reuse the same motion information of a neighboring block (e.g., one of neighboring blocks A0, A1, B0, B1, and B2) for inter prediction of a current block. For example, the encoder (e.g., using merge mode) may reuse the same motion information of a temporal, co-located block (e.g., one of temporal, co-located blocks C0 and C1) for inter prediction of a current block. An MVD need not be sent (e.g., indicated, signaled) for the current block because the same motion information as that of a neighboring block or a temporal, co-located block may be used for the current block (e.g., at the encoder and/or a decoder). A signaling overhead for sending/signaling the motion information of the current block may be reduced because the MVD need not be indicated for the current block. The encoder and/or the decoder may reciprocally generate a candidate list of motion information from neighboring blocks or temporal, co-located blocks of the current block (e.g., in a manner similar to AMVP). The encoder may determine to use (e.g., inherit) motion information, of one neighboring block or one temporal, co-located block in the candidate list, for predicting motion information of the current block being coded. The encoder may signal/send, in/via a bitstream, an indication of the determined motion information from the candidate list. For example, the encoder may signal/send an indicator/index. The index may indicate the determined motion information in the list of candidate motion information. The encoder may signal/send the index to indicate the determined motion information.

A list of candidate motion information for merge mode (e.g., in HEVC, VVC, or any other coding formats/standards/protocols) may comprise: up to four (or any other quantity of) spatial merge candidates derived/determined from five (or any other quantity of) spatial neighboring blocks (e.g., as shown in FIG. 15A); one (or any other quantity of) temporal merge candidate derived from two (or any other quantity of) temporal, co-located blocks (e.g., as shown in FIG. 15B); and/or additional merge candidates comprising bi-predictive candidates and zero motion vector candidates. In some examples, the spatial neighboring blocks and the temporal, co-located blocks used for merge mode may be the same as the spatial neighboring blocks and the temporal, co-located blocks used for AMVP.

In some examples (e.g., AV1), a list of derived MV predictors may be generated by pooling the spatial and temporal MV candidates and ranking them based on weightings determined by evaluating each of the candidates. Up to four candidates may be added to the list of MV predictors, which may also be referred to as the dynamic reference list (DRL). The DRL may be used in dynamic MV prediction modes.

Inter prediction may be performed in other ways and variants than those described herein. For example, motion information prediction techniques other than AMVP and merge mode may be used. While various examples herein correspond to inter prediction modes, such as used in HEVC and VVC or AV1, the methods, devices, and systems as described herein may be applied to/used for other inter prediction modes (e.g., as used for other video coding standards/formats such as VP8, VP9, etc.). History-based motion vector prediction (HMVP), combined intra/inter prediction mode (CIIP) or compound inter-intra prediction, warped motion compensation, overlapped block motion compensation (OBMC), and/or merge mode with motion vector difference (MMVD) (e.g., as described in VVC) may be performed/used.

A block matching operation (or technique) may be applied/used (e.g., in inter prediction) to determine a reference block in a different picture than that of a current block being coded (e.g., encoded and/or decoded). A block matching operation also may be applied/used to determine a reference block in a same picture as that of a current block being coded. The reference block, in a same picture as that of the current block, as determined using block matching may often not accurately predict the current block (e.g., for camera captured videos). Prediction accuracy for screen content videos may not be similarly impacted, for example, if a reference block in the same picture as that of the current block is used for encoding. Screen content videos may comprise, for example, computer generated text, graphics, animation, etc. Screen content videos may comprise (e.g., may often comprise) repeated patterns (e.g., repeated patterns of text and/or graphics) within the same picture. Using a reference block (e.g., as determined using block matching), in a same picture as that of a current block being encoded, may provide efficient compression for screen content videos.

A prediction technique may be used (e.g., in HEVC, VVC, AV1, and/or any other coding standards/formats/protocols) to exploit correlation between blocks of samples within a same picture (e.g., of screen content videos). The prediction technique may be intra block copy (IBC or IntraBC) or current picture referencing (CPR). An encoder may apply/use a block matching technique (e.g., similar to inter prediction) to determine a displacement vector (e.g., a block vector (BV). The BV may indicate a relative position of a reference block (e.g., in accordance with intra block compensated prediction), that best matches the current block, from a position of the current block. For example, the relative position of the reference block may be a relative position of a top-left corner (or any other point/sample) of the reference block. The BV may indicate a relative displacement from the current block to the reference block that best matches the current block. The encoder may determine the best matching reference block from blocks tested during a searching process (e.g., in a manner similar to that used for inter prediction). The encoder may determine that a reference block is the best matching reference block based on one or more cost criteria. The one or more cost criteria may comprise a rate-distortion criterion (e.g., Lagrangian rate-distortion cost). The one or more cost criteria may be based on, for example, one or more differences (e.g., an SSD, an SAD, an SATD, and/or a difference determined based on a hash function) between the prediction samples of the reference block and the original samples of the current block. A reference block may correspond to/comprise prior decoded blocks of samples (e.g., reconstructed samples) of the current picture. The reference block may comprise decoded blocks of samples of the current picture prior to being processed by in-loop filtering operations (e.g., deblocking, SAO filtering, CDEFs, and/or LR filters). In some examples, the reference block may be restricted to a certain area. For example, in AV1, if the top-left pixel coordinate of a superblock is (x0, y0), IntraBC prediction is available at pixel position (x,y) only if the value of the vertical coordinate y is less than y0 and the value of the horizontal coordinate x is less x0+2 (y0−y). Further, due to hardware write-back delays, the immediate reconstructed area may not be accessible by IntraBC prediction.

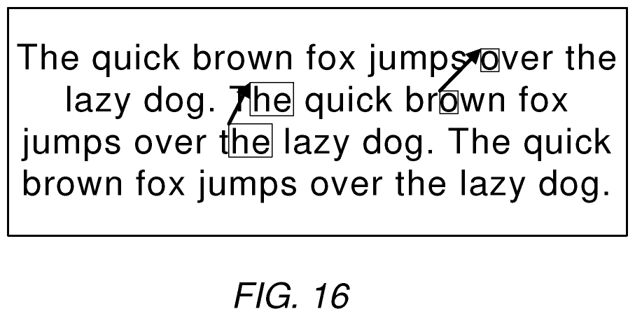

FIG. 16 shows an example of IBC (e.g., an IBC mode or an IntraBC mode). The example shown in FIG. 16 may correspond to screen content. The rectangular portions/sections with arrows beginning at their boundaries may be the current blocks being encoded. The rectangular portions/sections that the arrows point to may be the reference blocks for predicting the respective current blocks.

A reference block may be determined and/or generated, for a current block, using IBC. The encoder may determine a difference (e.g., a corresponding sample-by-sample difference) between the reference block and the current block. The difference may be a prediction error or residual. The encoder may store and/or send/signal, in/via a bitstream the prediction error and/or related prediction information. The prediction error and/or the related prediction information may be used for decoding and/or other forms of consumption. The prediction information may comprise a BV. The prediction information may comprise an indication of the BV. A decoder (e.g., decoder 300 as shown in FIG. 3), may decode the current block by determining and/or generating the reference block. The decoder may determine and/or generate the current block, for example, based on the prediction information (e.g., the BV). The reference block may correspond to/form (e.g., be considered as) the prediction (e.g., a prediction block) of the current block. The decoder may decode the current block by combining the prediction (e.g., prediction block) with the prediction error (e.g., residual or residual block).

A BV may be predictively coded (e.g., in HEVC, VVC, and/or any other coding standards/formats/protocols) before being stored and/or sent/signaled in/via a bitstream. For example, the BV for a current block may be predictively coded based on a BV of one or more blocks neighboring the current block. For example, an encoder may predictively code a BV using the merge mode (e.g., in a manner similar to as described herein for inter prediction), AMVP (e.g., as described herein for inter prediction), or a technique similar to AMVP. The technique similar to AMVP may be BV prediction and difference coding (or AMVP for IBC).

An encoder (e.g., encoder 200 as shown in FIG. 2) performing BV prediction and coding may code a BV as a difference between the BV of a current block being coded and a block vector predictor (BVP). An encoder may select/determine the BVP from a list of candidate BVPs. The candidate BVPs may comprise/correspond to previously decoded BVs of neighboring blocks in the current picture of the current block. The encoder and/or a decoder may reciprocally generate or determine the list of candidate BVPs.

The encoder may send/signal, in/via a bitstream, an indication of the selected BVP and a block vector difference (BVD). The encoder may indicate the selected BVP in the bitstream using an index/indicator. The index may indicate (e.g., point to) the selected BVP in the list of candidate BVPs. The BVD may be determined/calculated based on a difference between a BV of the current block and the selected BVP. For example, for a BV (e.g., represented by a horizontal component (BVx) and a vertical component (BVy) that indicates a position relative to a position of the current block being coded, the BVD may be represented by two components BVDₓ and BVD_{y}. BVDₓ and BVD_{y} may be determined/calculated as:

BVDₓ=BVₓ−BVPₓ, (17)

BVD_{y}=BV_{y}−BVP_{y}. (18)

BVDx and BVDy may respectively represent horizontal and vertical components of the BVD. BVPx and BVPy may respectively represent horizontal and vertical components of the BVP. A decoder (e.g., decoder 300 as shown in FIG. 3), may decode the BV by adding the BVD to the BVP indicated in/via the bitstream. The decoder may decode the current block by determining and/or generating the reference block. The decoder may determine and/or generate the reference block, for example, based on the decoded BV. The reference block may correspond to/form (e.g., be considered as) the prediction (e.g., a prediction block) of the current block. The decoder may decode the current block by combining the prediction (e.g., the prediction block) with the prediction error (e.g., residual or residual block).

A same BV as that of a neighboring block may be used for the current block and a BVD need not be separately signaled/sent for the current block, such as in the merge mode. A BVP (in the candidate BVPs), which may correspond to a decoded BV of the neighboring block, may itself be used as a BV for the current block. Not sending the BVD may reduce the signaling overhead.

A list of candidate BVPs (e.g., in HEVC, VVC, and/or any other coding standard/format/protocol) may comprise two (or more) candidates. The candidates may comprise candidates A and B. Candidates A and B may comprise: up to two (or any other quantity of) spatial candidate BVPs determined/derived from five (or any other quantity of) spatial neighboring blocks of a current block being encoded; and/or one or more of last two (or any other quantity of) coded BVs (e.g., if spatial neighboring candidates are not available). Spatial neighboring candidates may not be available, for example, if neighboring blocks are encoded using intra prediction or inter prediction. Locations of the spatial candidate neighboring blocks, relative to a current block, being encoded using IBC may be illustrated in a manner similar to spatial candidate neighboring blocks used for coding motion vectors in inter prediction (e.g., as shown in FIG. 15A). For example, five spatial candidate neighboring blocks of a current block being coded using IBC may be respectively denoted A0, A1, B0, B1, and B2 as shown in FIG. 15A.

The most probable mode (MPM) refers to the intra prediction mode (IPM) that is most likely to be the best mode for the current block being encoded or decoded. In current intra prediction techniques, the MPM is determined by analyzing the intra prediction modes of the neighboring CUs (e.g., also referred to as blocks) of a current block (or CU) to be coded (e.g., encoded or decoded). For example, a list of 6 MPMs (referred to as the “MPM list”) may be constructed for intra prediction. The MPM list is derived from the intra prediction modes of the neighboring CUs, and is updated as the encoder progresses through the video frame. When encoding a block, the encoder may determine if the current block is a candidate for any of the MPMs in the MPM list. If it is, the encoder then compares the prediction errors of the respective MPMs to determine which MPM from the MPM list is the best mode for the current block. If the current block is not a candidate for any of the MPMs in the MPM list, the encoder may then evaluate remaining intra prediction modes (e.g., from a total of 67 intra prediction modes which may include a planar mode, a DC mode, and 65 angular directional modes) to determine the best mode for the current block.

The use of MPMs can significantly improve the coding efficiency because the encoder does not need to explicitly signal the intra prediction mode for the current block if it is one of the MPMs. Instead, the decoder can infer the intra prediction mode for the current block from the corresponding MPM list identically generated at the decoder. Thus, signaling overhead in the bitstream may be reduced.

In some examples, three types of intra modes may be considered to construct the MPM list: default intra modes; neighboring intra modes; and derived intra modes. A unified 6 MPM list may be used for intra blocks irrespective of whether Multiple Reference Lines (MRL) and Intra Sub-Partitions (ISP) coding tools are applied. The MPM list for the current block is constructed based on intra modes of the left neighbor block (e.g., block corresponding to A1 in FIG. 15A) and the above neighbor block (e.g., block corresponding to B1 in FIG. 15A) of the current block. Suppose the mode of the left neighbor block is denoted as Left and the mode of the above neighbor block is denoted as Above, the unified MPM list may be constructed as follows: when a neighboring block is not available, its intra mode is set to planar mode by default; if both modes Left and Above are non-angular modes, then the MPM list is set to include {planar, DC, V, H, V−4, V+4}, where “V” and “H” refer to vertical mode and horizontal mode, respectively; if one of modes Left and Above is an angular mode, and the other is non-angular, set a mode Max as the larger mode of Left and Above, and set MPM list to include {planar, Max, Max−1, Max+1, Max−2, Max+2}; if Left and Above are both angular and they are different, set a mode Max and a mode Min as the larger mode in Left and Above and as the smaller mode in Left and Above, respectively, and thereafter, if Max-Min is equal to 1, then set MPM list to include {planar, Left, Above, Min−1, Max+1, Min−2}, if Max-Min is greater than or equal to 62, then set MPM list to include {planar, Left, Above, Min+1, Max−1, Min+2}, if Max-Min is equal to 2, set MPM list to include {planar, Left, Above, Min+1, Min−1, Max+1}, or otherwise, set MPM list to include {planar, Left, Above, Min−1, −Min+1, Max−1}; and if Left and Above are both angular and they are the same, set MPM list to include {planar, Left, Left−1, Left+1, Left−2, Left+2}.

The encoder may encode an MPM index in the bitstream to indicate the position of the selected intra prediction mode in the MPM list to the decoder. The encoder may represent the MPM index as a codeword and entropy encode the codeword into the bitstream. The decoder may derive the MPM list in a manner identical to the encoder, and use the MPM index obtained from the codeword decoded from bitstream to obtain the intra prediction mode from the MPM list derived at the decoder. In some instances, the first bin of codeword, representing the MPM index, is context coded using an arithmetic coder (e.g., CABAC) so as to achieve additional coding efficiencies. For example, three contexts may be used, corresponding to whether the current intra block is MRL enabled, ISP enabled, or a normal intra block.

In some examples, during the 6 MPM list generation process, pruning may be used to remove duplicated intra modes so that the MPM list includes only unique intra modes. For entropy coding of the 61 non-MPM modes (that is, the 67 modes in VVC minus the 6 MPM), a truncated binary code (TBC) may be used.

In some implementations, the MPM list is extended to include 16 additional candidates, and is divided into two parts, the primary MPM (PMPM) (e.g., including 6 entries) and the secondary (SMPM) (e.g., including 16 entries). In some implementations, the first entry in the general MPM list is the planar mode. The remaining entries include the intra modes of the adjacent neighboring blocks corresponding to positions left (L), above (A), below-left (BL), above-right (AR), and above-left (AL) (e.g., shown in FIG. 15A as A1, B1, A0, B0, and B2), and decoder-side intra mode derivation (DIMD) modes which are sorted in ascending order of a cost such as, for example, SAD, SSD, SATD, etc. In some examples, up to a preconfigured/predetermined number of modes (e.g., 5) with the smallest costs are added to the MPM list. The cost for a respective MPM (e.g., an IPM corresponding to an entry in the MPM list) may be computed between the prediction of the reconstructed samples of the template of the current block and the reconstructed samples. For example, the prediction may be generated by applying the respective MPM for the template. Sorted directional modes are added into the general MPM list, and then the default modes, until the general MPM list with 22 entries is constructed. In some examples, if a CU block is vertically oriented, the order of neighboring blocks corresponds to A, L, BL, AR, AL; otherwise, it is L, A, AL, AR, BL.

Referring back to FIG. 16, in IBC mode applied for screen content, a reference block (RB) may be determined as a “best matching” reference block to a current block. For example, the arrows correspond to block vectors (BVs) that indicate respective displacements from respective current blocks (CBs) to respective reference blocks that best match the respective current blocks. In the examples shown in FIG. 16, the reference blocks match the respective current blocks and the calculated residuals would be small, if not zero. However, often, video content may be more efficiently encoded by considering symmetry properties. For example, it has been observed that symmetry is often present in video content, especially in text character regions and computer generated graphics in screen content video.

In some implementations, a Reconstruction-Reordered intra block copy IBC (RRIBC) mode (e.g., also referred to as IBC-Mirror Mode) is used for screen content video coding to take advantage of symmetry within video content to further improve the coding efficiency of IBC. In some examples, the RRIBC mode may be signaled based on IBC mode with an indication (or flag) indicating whether flipping is applied and if flipping is applied, further signaling an indication (or flag) indication a direction of flipping.

In some embodiments, when the RRIBC mode is indicated for encoding a current block, a residual for the current block may be calculated based on samples of a reference block (e.g., corresponding to an original reference block being encoded and decoded to form a reconstructed block) being flipped relative to the current block according to a flip direction indicated for the current block. In an example, at the encoder side, the current block (to be predicted) may be flipped before matching and residual calculation, while the reference block (used to predict the current block) may be derived without flipping. Similarly, at the decoder side, the current block (that was flipped at the encoder) may be determined based on the reference block and residual information, then flipped back to restore the original orientation of the current block before being flipped at the encoder side. In another example, instead of the current block being flipped, the reference block may be flipped instead such that the reference block is flipped to encode the current block (at the encoder) and flipped back (at the decoder) to restore the original orientation of the reference block at the encoder. As described in this specification, reference to flipping the current block may alternatively refer to flipping the reference block and not the current block such that the reference block and the current block are flipped in the direction with respect to each other.

In an example, in the RRIBC mode, the flip direction may include one of a horizontal direction (e.g., along an x-axis) or a vertical direction (e.g., along a y-axis) for RRIBC coded blocks. In an embodiment, for a current block coded in the RRIBC mode (e.g., an IBC advanced motion vector prediction (AMVP) coded block), a first indication (e.g., a first syntax flag) may indicate/signal whether to use flipping (e.g., also referred to as mirror flipping) to encode/decode the current block. Additionally, for the current block, a second indication (e.g., a second syntax flag) may indicate/signal the direction for flipping (e.g., vertical or horizontal). For IBC merge, the flip direction may be inherited from neighboring blocks, without syntax signaling. In an example, for RRIBC, flipping of a current block (or a reference block in an alternative embodiment) in a horizontal and a vertical direction can be represented in (19) and (20), respectively:

Reference(x,y)=Sample(w−1−x,y) (19)

Reference(x,y)=Sample(x,h−1−y) (20)

where w and h are the width and height of a current block, respectively. Sample (x,y) may indicate a sample value located in (x,y). Reference (x,y) may indicate a corresponding reference sample value after flipping. In other words, for horizontal flipping, (19) shows that the current block is flipped in the horizontal direction by sampling from right to left. Similarly, for vertical flipping, (20) shows that the current block is flipped in the vertical direction by sampling the current block from down to up.

Considering the horizontal or vertical symmetry, the current block and the reference block are normally aligned horizontally or vertically, respectively. Therefore, in an example, based on the RRIBC mode and a flipping direction, the reference block may be determined from a reference region (including candidate reference blocks) aligned in the same flipping direction, as will be further described below. As a result, when flipping in a horizontal direction is applied/indicated, the vertical component (BVy) of the BV (indicating a displacement from the current block to the reference block) may not need to be signaled because it may be inferred to be equal to 0. Similarly, when flipping in a vertical direction is applied/indicated, the horizontal component (BVx) of the BV may not need to be signaled because it may be inferred to be equal to 0. In other words, in an example, only one component, aligned with the direction for flipping, of the BV may be encoded and signaled for the current block.

For a current block coded in IBC mode, a BV for the current block may be constrained to indicate a relative displacement from the current block to a reference block within an IBC reference region. In some examples, a BVP used to predicatively code a BV may be similarly constrained. This is because a BVP may be derived from a BV of a spatially neighboring block of the current block or a prior coded BV as explained above. Based on the BVP, a BVD may be determined as a difference between the BV and the BVP. This BVD may be encoded and transmitted along with an indication of the selected BVP in a bitstream to enable decoding of the current block, as described above.

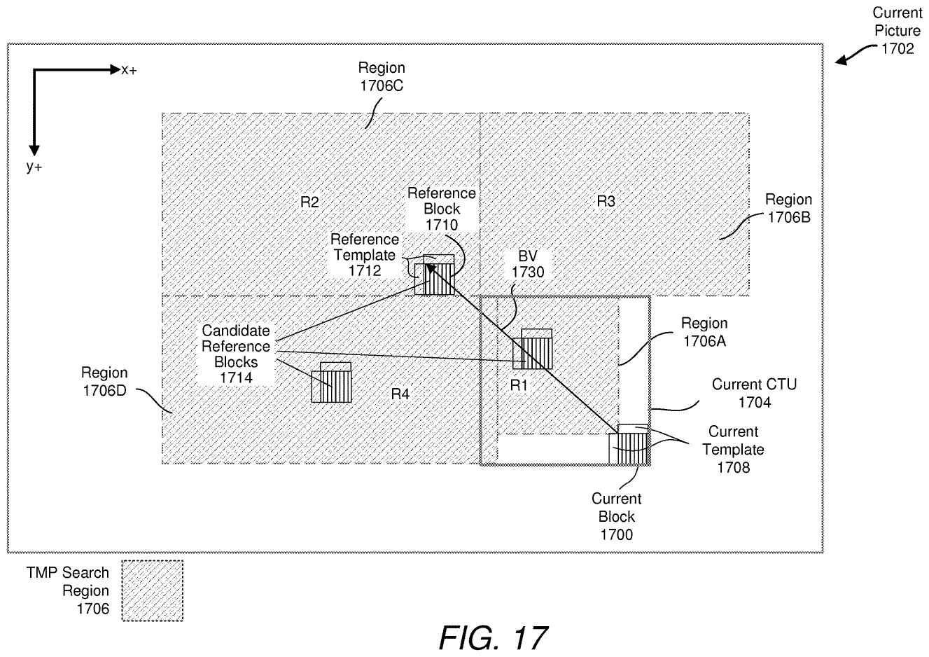

FIG. 17 shows an example of intra template matching prediction (IntraTMP) for predicting or determining a current block 1700, according to some embodiments. IntraTMP is an intra prediction mode that copies a reference block, from a reconstructed part of a current picture 1702 (e.g., current frame), whose template (e.g., an L-shaped template, above-only template, or left-only template) is determined to best matches current template 1708 (e.g., the L-shaped template, above only template, or left-only template) of current block 1700 to predict current block 1700. Current block 1700 comprises a rectangular block of samples, in a picture or video frame of current picture 1702, to be encoded by the encoder or decoded by the decoder. Current template 1708 may be determined based on samples in a reconstructed region neighboring current block 1700. For example, current template 1708 may comprise samples that are adjacent to current block 1700 such as including one or more rows of samples above current block 1700 and/or and one or more columns of samples to the left of current block 1700. In some examples, the current template 1708 may be an L-shaped template, a top-only template, or a left-only template of the current block 1700. For example, the L-shaped template may include the top-only template and the left-only template. For example, the L-shaped template may further include an above-left template.

In IntraTMP, a plurality of reference templates of respective candidate reference blocks 1714, from a predefined TMP search region 1706, are matched with current template 1708 to determine or select a reference template 1712 that best matches or is most similar to current template 1708. A reference block (RB) 1710 from the candidate reference blocks 1714 and indicated by the selected reference template 1712 may be used as a prediction block to determine or predict current block 1700. Block vector (BV) 1730 indicates a displacement from current block 1700 (e.g., the top left sample of current block 1700) to reference block 1710 (e.g., the top left sample of reference block 1710).

In some examples, TMP search region 1706 comprises a portion of a reconstructed region of current picture 1702. TMP search region 1706 indicates the regions that the encoder or decoder may search for candidate templates (such as candidate templates of candidate reference blocks 1714) to determine reference template 1712 and corresponding reference block 1710. In some examples, TMP search region 1706, may include region 1706A (R1) from a current CTU 1704, region 1706B (R3) including a portion of the above CTU, region 1706C (R2) including a portion of the above-left CTU, and region 1706D (R4) including a portion of the left CTU. The CTUs are a result of picture partitioning operations described above. It is to be understood that TMP search region 1706 may include other regions of reconstructed samples of current picture 1702.

In some examples, the dimensions of TMP search region 1706 (SearchRange_w, SearchRange_h) may be set to be proportional to the dimensions of current block 1700 (BIKW, BlkH) to have a fixed number of cost comparisons (e.g., SAD) per pixel. For example, the dimensions of TMP search region 1706 may be calculated as follows:

SearchRange_w=min(64,α*BlkW) (21)

SearchRange_h=min(64,α*BlkH) (22)

α (or alpha) is a constant that controls a gain/complexity trade-off for the encoder or decoder. For example, a may be equal to 5. In FIG. 17, it should further be noted that the dimensions of TMP search region 1706 are illustrated by example and not by limitation. In practical implementation, for example, the dimensions of the regions may vary, and/or one or more of the regions may not be present. In the example illustrated by FIG. 17, portions of reconstructed region directly above and directly left of current block 1700 may not be available for prediction or determination and may be excluded from TMP search region 1706. For example, this may be because a reference block in these portions would overlap with current block 1700, which would be an invalid location for prediction or determination of current block 1700. A similar restriction may also be based on the unavailability of samples because of the sequence order of encoding or decoding, or because the samples may be outside of TMP search region or current picture 1702.

In some examples, the candidate templates of candidate reference blocks 1714 have the same shape and size as current template 1708. In an example, the candidate templates further have the same orientation as current template 1708. In some examples, matching templates includes calculating a template matching (TM) cost between samples of a candidate reference template of a candidate RB (indicated by a respective candidate block vector) and corresponding samples of current template 1708. For example, the difference may be based on a sum of squared differences (SSD), a sum of absolute differences (SAD), a sum of absolute transformed differences (SATD), or a difference determined based on a hash function. The template matching cost represents a similarity between the templates with a smaller cost representing more similar templates.

In some examples, a position of each sample in TMP search region 1706 may be selected as a location of a candidate reference block whose respective reference template is compared against current template 1708 to determine a TM cost. The position may be indicated by a candidate block vector that represents a displacement from current block 1700 (e.g., a top-left sample of current block 1700) to the position. To speed up the template matching process, one or more of TMP search region 1706 may be subsampled by a subsampling interval (e.g., 3) such that not every position is considered as a location of a candidate reference block. After finding a set of candidates (e.g., to generate the list of candidates), a refinement process may be performed to select additional candidate block vectors. The refinement process may be performed via a second template matching search in a search region around one or more of the set of candidates. The search region may be a reduced search range associated with the subsampling interval.

In some examples, based on the encoder selecting IntraTMP for coding the current block, the encoder may signal the usage of this mode, and the same prediction and matching operations are performed at the decoder.

In some examples, by performing template matching operations on candidate reference templates in TMP search regions 1706A-D, the decoder (and also encoder) may construct a candidate list of up to a predetermined maximum number (e.g., 19) of candidate block vectors (or candidate block vector predictors). These candidate block vectors may be in ascending order according to the template matching costs of respective reference templates of candidate reference blocks indicated by the candidate block vectors. In some examples, a prediction block (e.g., a predictor) of current block 1700 may be generated using one or more of the reference blocks (e.g., reference block 1710) determined using IntraTMP as well as applying one or more optional filters. For example, the following modes may be supported: single predictor, fusion of multiple predictors, sub-pel precision, and linear filter model. In the single predictor mode, a single predictor is selected from the candidate list such as selecting reference block 1710. In the fusion of multiple predictors mode, multiple predictors are blended to derive the final prediction block such as selecting two or more candidate reference blocks 1714. The blending weights may be either computed from the template matching cost of each predictor, or with a Wiener-filter based weight derivation method. In the sub-pel precision mode, when a single predictor is used, sub-pel precision can be used with ½-pel precision, ¼-pel precision, or ¾-pel precision, each with 8 possible directions. In the linear filter model mode, a linear filter can be learned (e.g., generated or derived) between the reference template and current template and be applied to the reference block. This mode can be used for the single predictor when sub-pel precision is not used.

In the example illustrated in FIG. 17, reference template 1712 of reference block 1710 may be determined to best match current template 1708 based on the template matching cost between reference template 1712 and current template 1708 being a minimum TM cost. In another example, the encoder may select reference block 1710 as a prediction of current block 1700 and signal an index of a candidate block vector, indicating reference block 1710, in the candidate list. The decoder may generate the same candidate list and determine reference block 1710 based on decoding the index from the bitstream. A block vector (BV) may indicate the displacement of a reference block (e.g., reference block 1710) relative to the current block 1700.

In some examples, the IntraTMP mode may be enabled for blocks (e.g., CUs) with a size (e.g., width times height) less than or equal to a threshold size (e.g., 64). In an example, the threshold size for IntraTMP is configurable. The IntraTMP prediction mode may be signaled at a block (e.g., per CU) level through a dedicated flag.

In some examples, an encoder may determine a difference (e.g., a corresponding sample-by-sample difference) between current block 1700 and reference block 1710 used to predict current block 1700. The difference may be referred to as a prediction error or residual. The encoder may store and/or signal in a bitstream the prediction error or residual for decoding by a decoder.

To perform TMP to code current block 1700, a decoder may perform the same operations as the encoder as described above. For example, based on receiving an indication from the encoder that IntraTMP is used to predict current block 1700 (e.g., via a flag), the decoder may similarly determine or construct current template 1708 of current block 1700. After determining or constructing current template 1708, the decoder may further similarly search TMP search region 1706 to generate a list of candidates from which reference block 1710 may be determined. Because, in some examples, the reference block may be indicated by a block vector candidate with the lowest cost in the list of candidates, the decoder may obtain the block vector candidate by decoding, from the bitstream, the index of the block vector candidate in the list of candidates. The decoder may combine the residual, decoded from the bitstream, with reference block 1710 to reconstruct current block 1700. In this way, the encoder does not need to encode BV 1730 that indicates reference block 1710 in the bitstream.

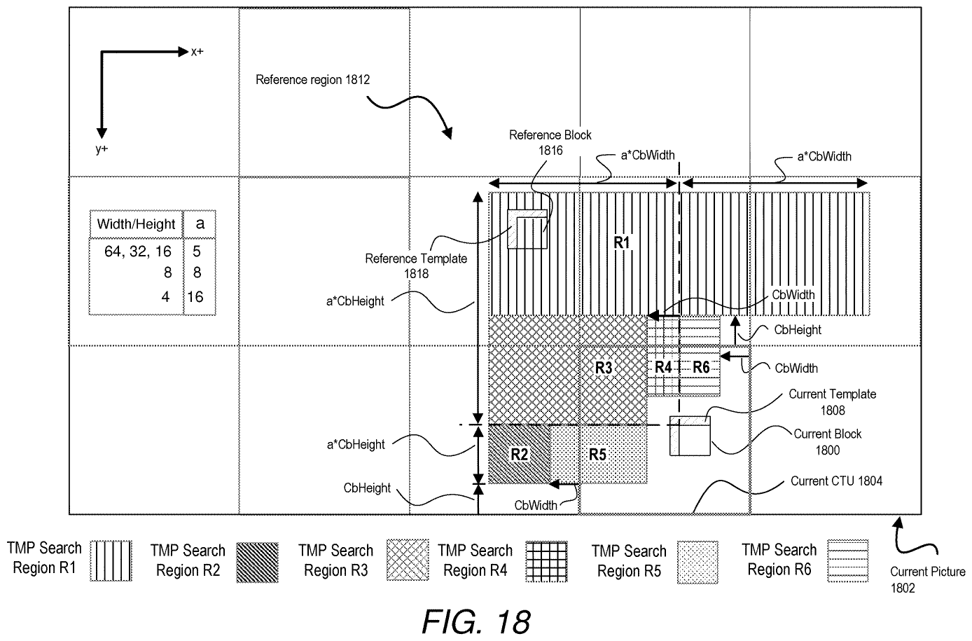

FIG. 18 illustrates a current block 1800 in a current CTU 1804, and the reference region 1812 with example corresponding TMP search regions R1-R6 identified. An example reference block 1816, and reference block template 1818 and current block template 1808 are also illustrated.

In order to reduce the high computational burn of the exhaustive template matching searching in the whole RR, the searching process is split into 2 steps: a sparse search step, and a refinement search step.

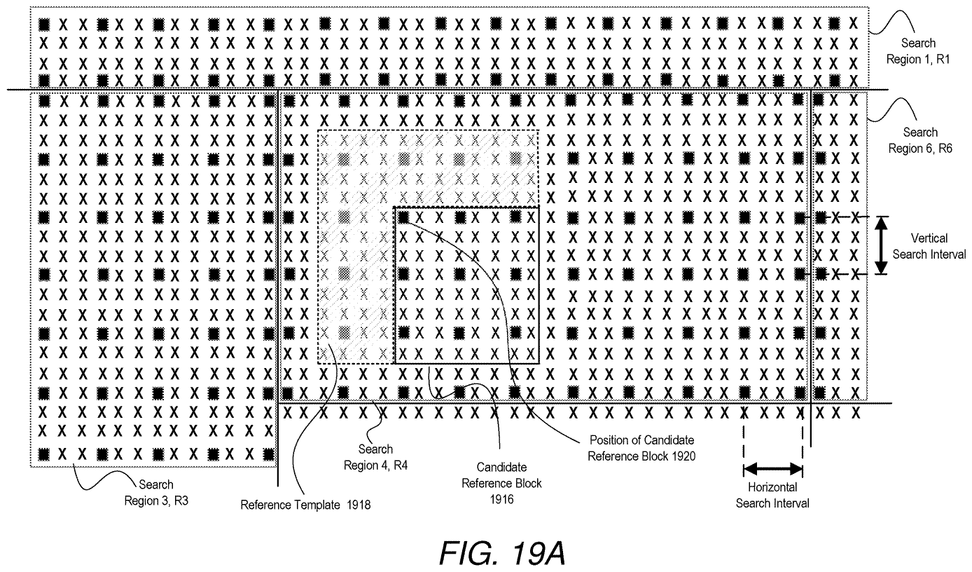

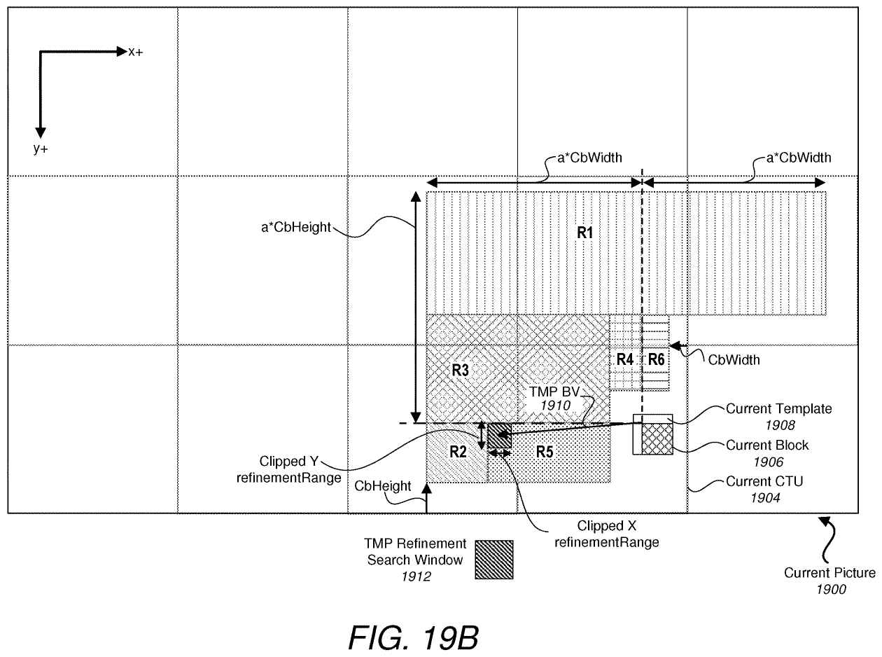

The sparse search is illustrated in FIG. 19A. The sparse search in some implementations is carried out in a regular grid using a subsampling interval (e.g., 4 pixels or 3 pixels) in the horizontal and vertical directions. FIG. 19A shows an example candidate reference block 1916 in search region 4 (R4) and the corresponding reference template 1918. The template cost is computed for each reference block position within a search region (e.g., reference block position 1920 of reference block 1916), and the BVP candidates associated with the best (e.g., least cost) reference block are recorded in a sparse list and sorted in an ascending order based on the cost. The subsample positions are shown in the form of dark squares within the RR region, separately determined for each search region. In some implementations of IntraTMP, the size of the sparse list is set to 30.

The refinement search, the second step, is a refinement of the reference block candidates (correspondingly, BVP candidates) in the sparse list. In some implementations, the refinement is made in a window of a predetermined size (e.g., 5×5 pixels or 3×3 pixels) around the respective sparse BVP candidates using a sampling interval of 1. In other words, in addition to the sparse BVP, one or more additional BVP candidates can be generated within the refinement search window at the integer pixel positions. If the refinement window crosses into another search region, the refinement window is clipped to the region boundary to which the candidate belongs. FIG. 19B illustrates a current block 1906 and template 1908 located in a current CTU 1904 of a current frame 1900 (i.e., current picture), corresponding RR with respective search regions R1-R6, and an example BVP 1910 with its refinement search window 1912 being clipped where R5 (search region in which the BVP 1910 is located) borders R2 and R3. The 19 candidates with the lowest template costs (e.g., SAD costs) among the generated additional candidates and the sparse BVP candidates are selected to generate a “refined IntraTMP list.”

Once the encoder/decoder has constructed the refined IntraTMP list, the encoder/decoder can select among different intraTMP sub-modes by checking the rate-distortion performance of each sub-mode. The IntraTMP sub-mode is signaled to the decoder in combination with an index to the best candidate in the refined IntraTMP list or a cluster of candidates (e.g. the fusion mode). The IntraTMP sub-modes may be the single predictor sub-mode, the fusion sub-mode, the sub-pel precision sub-mode, and the linear filter mode sub-mode. In the single predictor sub-mode, a single BVP candidate is selected from the refined IntraTMP list and signaled to the decoder. In the fusion sub-mode, multiple BVP candidates are blended to derive the final BV prediction block. The blending weights may be either computed from the template matching cost of each predictor or with a Wiener-filter-based weight derivation method. In the sub-pel precision sub-mode, when a single predictor is used, sub-pel precision can be used with ½-pel precision, ¼-pel precision, and ¾-pel precision, each with 8 possible directions. In the linear filter model sub-mode, a linear filter can be learned between the reference and current templates and applied to the reference block. This mode can be used for a single predictor when sub-pel precision is not used and a single predictor is used.

In some implementations of IntraTMP, several types of template shapes may be used. Five types of templates have been proposed according to the current block location in the frame: top template, left template, L-shape template, an only top template type, and an only left template type.

The template type of top template may be used when only the current block's top samples are available, such as when the current block is located to the left boundary of the picture. Consequently, the TMP cost is computed using the top samples of the current and reference blocks. In some implementations, the top template is four samples in height.

The template type of left-template may be used when only the left samples of the current block are available, such as when the current block is located at the top boundary of the picture. Consequently, the TMP cost is computed using exclusively the left samples of both the current and the reference block. In some implementations, the left template is four samples in width.

The L-shape template type is used in the other cases (e.g., the current block is not located at the top or left boundary of the picture) where the samples surrounding the current block included in the L-Shape are available. Consequently, the TMP cost is computed using the L-shape template of both the current and the reference block. In some implementations, the L-shape template is four samples in width and height.

The L-shape template introduces two more template types: the Only-Top (Only-T) and Only-Left (Only-L) templates. Therefore, in addition to the L-shape TMP cost, the TMP cost for the Only-T and Only-L templates are also computed, and the best N BV candidates are stored in different Only-T and Only-L lists.

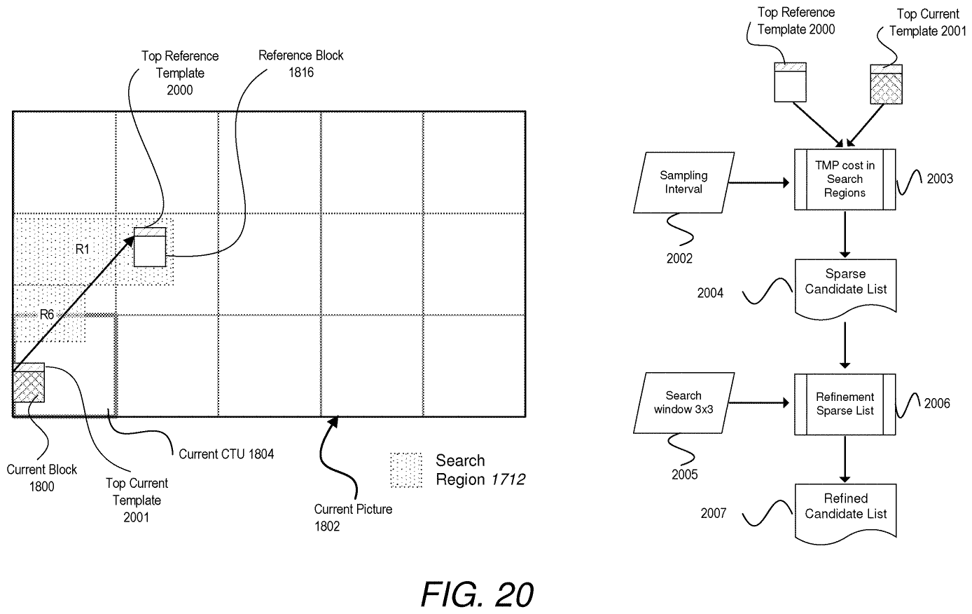

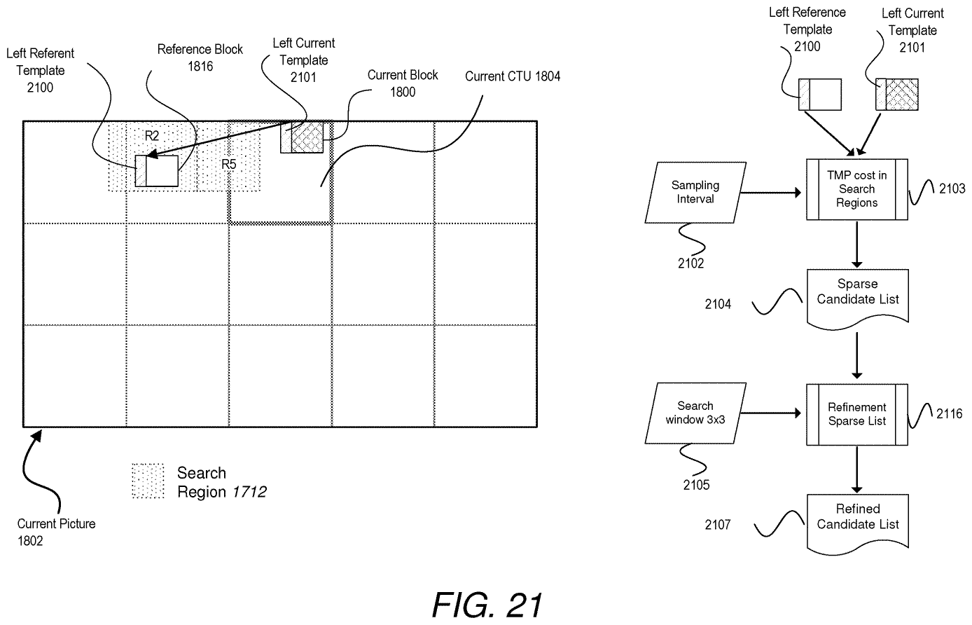

FIG. 20 depicts an example of the top-template type. Only the top templates (e.g., template 2001 of current block and template 2000 of reference block 1816) are used for the TMP cost computation in 2003. The sparse search 2003 is computed using a sampling interval (SI) 2002 of three, and one Sparse List (sparse candidates list) 2004 is built using the best (lower cost) 30 BV candidates in some implementations. Those candidates are refined in 2006 using a 3×3 window 2005 with an SI of 1, and a Refined Candidates List 2007 is built.

For the left-template type, the same top-template type logic is applied, but the left templates (2100 and 2101) of reference and current blocks are used instead of the top templates illustrated in FIG. 21. The TMP cost calculation in search regions 2103, search intervals for sparse search 2102, sparse candidates list 2104, refinement of the sparse list 2116, refinement search windows 2105, and the refined candidates list 2107 of the Only-L process shown in FIG. 21 may be identical (except for the use of Only-L template instead of Only-T template) to 2003, 2002, 2004, 2006, 2005, and 2007, respectively, described in relation to FIG. 20.

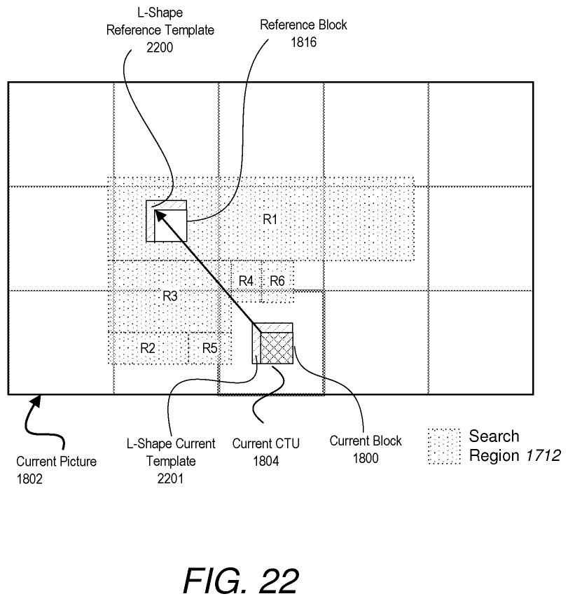

FIG. 22 depicts an example of a current block that has available (e.g., reconstructed samples are available for) the L-shape template 2201, and the L-shape template 2200 of the reference block is used to compute the L-shape TMP cost in all search regions, as it was described for the top-template and left-template type.

In addition to the L-shape cost, the Only-Top TMP and Only-Left TMP costs may also be computed. In some implementations, the sparse search builds three sparse lists, one sparse L-shape list with a size of 30 BV candidates, and two additional lists, the Only-T sparse list and Only-L sparse list, both with a length of 6 BV candidates.

These three sparse lists are refined by computing the respective template type cost using a window of 3×3 in some implementations. The best N BV candidates, which have obtained the lower TMP costs, are stored in three new refined lists: the refined L-shape list with a size of 19 BV candidates, the refined Only-T list with a length of 3 BV candidates and refined Only-L list with a size of 3 BV candidates. In some implementations, the final IntraTMP List has 19 candidates as the L-Shape List, but it is a combination of the BVs candidates in the L-Shape List, and the Refined Only-T and Only-L Lists.

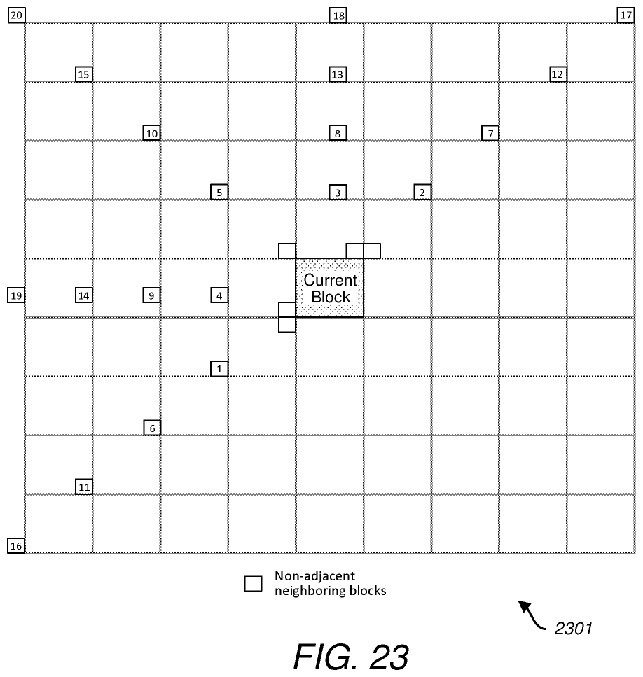

In addition to the sparse BVP candidates obtained by TMP searching within the RR in IntraTMP, a set of merge BVP candidates is generated using another technique called “IntraTMP with merge candidates.” In some implementations, merge BVP candidates are a subset of the IBC merge candidates, including only the spatial candidates of the current block. In particular, the TMP merge BVP candidates may use the 5 adjacent BVs from the adjacent blocks (e.g., 1500 in FIG. 15A) and multiple (e.g., 20) non-adjacent BV candidates (e.g., 2301 in FIG. 23) from the non-adjacent neighboring blocks encoded using an IBC or TMP mode.

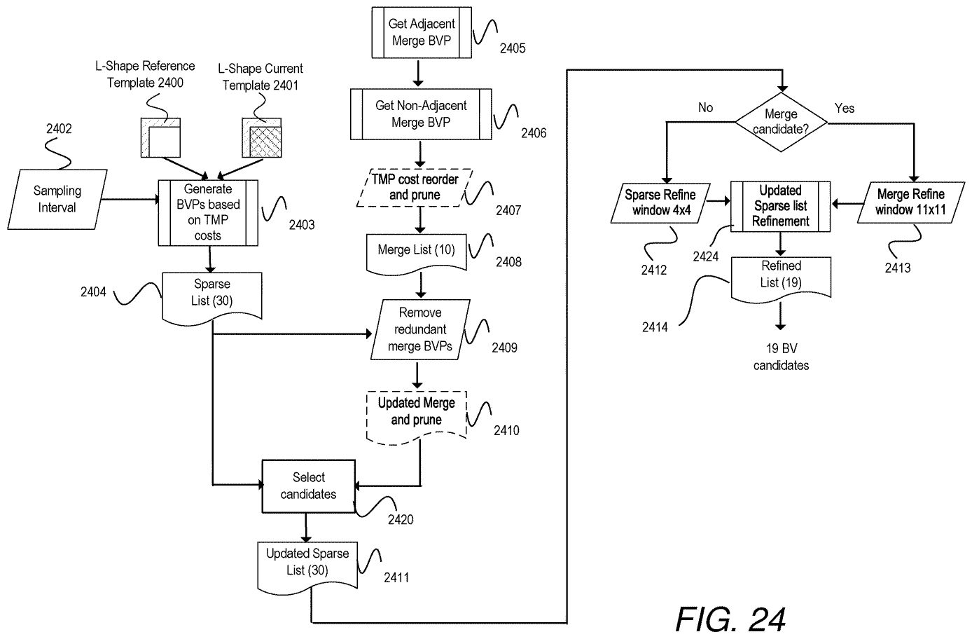

An example of the IntraTMP with merge candidates process is illustrated in FIG. 24. In this example, a maximum of 50 BVP candidates including BVP candidates 2405 from the adjacent blocks and BVP candidates 2406 from non-adjacent blocks are reordered and pruned in block 2407 to remove duplicate BVP candidates. In some examples, the BVP candidates are ranked in an ascending order based on the associated TMP costs, and the best 10 candidates (candidates with the lowest TMP costs) may be selected to generate the TMP merge list 2408. The TMP merge list 2408 can be ordered ascendingly according to the TMP costs of the BVP candidates. The BVP candidates in the TMP merge list 2408 may also be referred to as “merge BVP candidates.” In addition, a sparse list 2404 is generated at block 2403 for the current block, as described above in relation to IntraTMP. For example, the sparse list 2404 can be generated by calculating TMP costs for reference templates (e.g., L-shape reference templates) 2400 and the current block's template 2401 in search regions using a predetermined sampling interval 2402. In some implementations, up to 10 top merge BVP candidates in the TMP merge list 2408 may be checked in the sparse list 2404 for duplicates, and the redundant BVPs in the TMP merge list 2408 may be removed in block 2409 to generate the updated TMP merge list 2410. In some embodiments, the merge BVP candidate list may be only pruned after the redundant checking at 2410. In another embodiment, the merge BVP candidates list may not be reordered based on the TMP. The merge BVP candidates may be ordered according to their position relative to the Sparse search regions, ranking the BVP outside the Sparse search regions first and thereafter consecutively ordering the candidates overlapping any Sparse search regions (inner BV candidates). Some implementation may not prune and reorder the merge BVP candidate list.

Thereafter, the merge BVP candidates from the updated TMP merge list 2410 are considered along with the BVP candidates in the sparse list 2404 to select (e.g., based on the TMP costs) the candidates at block 2420 for refinement. In some example, the best 30 candidates (e.g., having the lowest TMP costs) are selected to form the updated sparse list 2411.

BVP candidates in the updated sparse list 2411 can be refined at block 2424 using a refinement search window (also referred to as a “search window” or “refinement window”) to generate a refined candidates list 2414. In some implementations, the refinement search window for a BVP candidate has a fixed window size that depends on the type of the BVP candidate. For example, BVP candidates generated from the sparse searching in the regular TMP reference region (in the initial sparse list 2404) can use a 4×4 refinement window 2412 (with a sampling interval of 4 samples). BVP candidates from the updated TMP merge list 2410, inside or outside the regular reference region, can use a search window size of 11×11 samples 2413 for refinement. In some implementations, the refined candidate list 2414 includes 19 BV candidates.

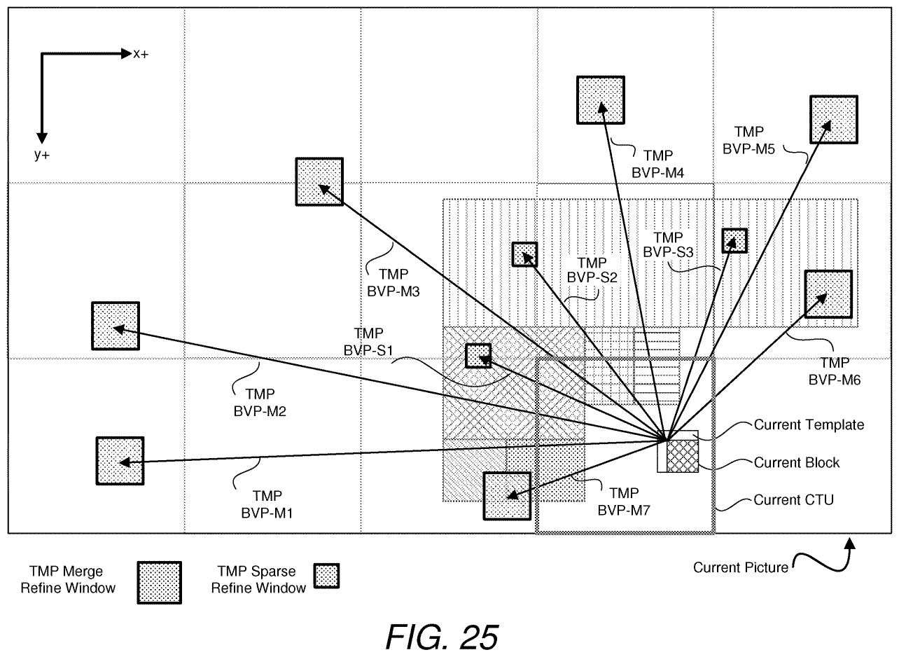

FIG. 25 depicts an example of refinement windows of 5 merge BVP candidates (BVP-M1 to BVP-M5) located outside of the regular TMP reference region, one merge BVP candidate (BVP-M6) located inside the regular TMP reference region, and one merge BVP candidate (BVP-M7) which is partially overlapping with the regular TMP reference region. FIG. 25 also shows an example of refinement windows of three sparse BVP candidates (BVP-S1 to BVP-S3) positioned within the regular TMP reference region.

IntraTMP with Merge Candidates is described in K. Naser et al, “EE2-1.2: IntraTMP with Merge Candidates,” JVET-AG0151, January 2024, the content of which is herein incorporated by reference.

Another technique, known as Auto-relocated block vector prediction (AR-BVP), may be used in the construction of the AMVP and/or merge IBC list. In some implementations, a guiding BV is selected from the BVP candidates in the AMVP and/or merge IBC list. A BV (referred to herein as a “coding BV”) pointing to a reference block of a block containing a position derived relative to a position pointed to by the guiding BV is identified. An AR-BVP candidate can be determined as the combination of the guiding BV and the identified coding BV. For example, the coding BV may be similar to a block vector displacement (BVD) in AMVP IBC.

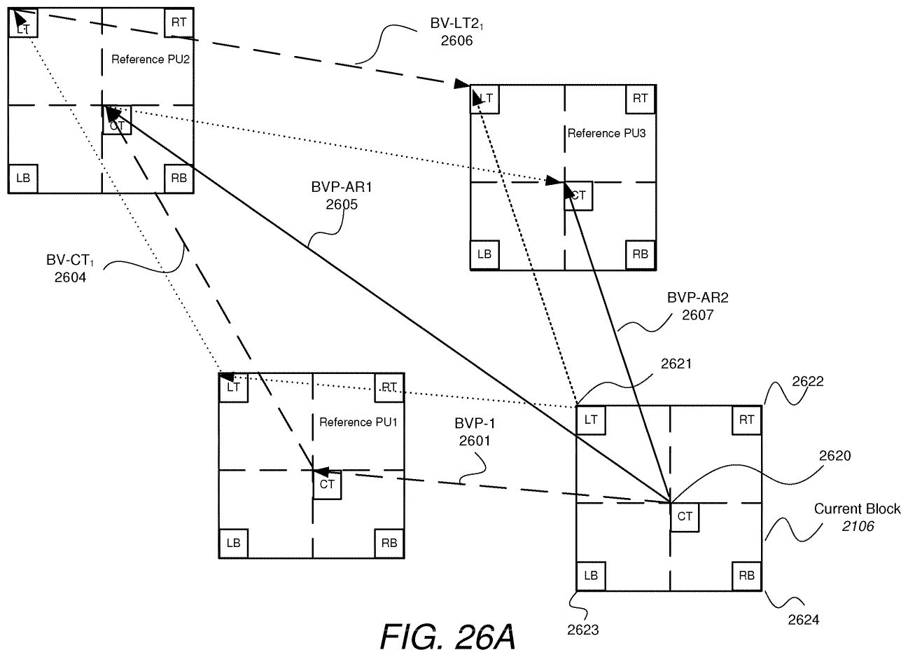

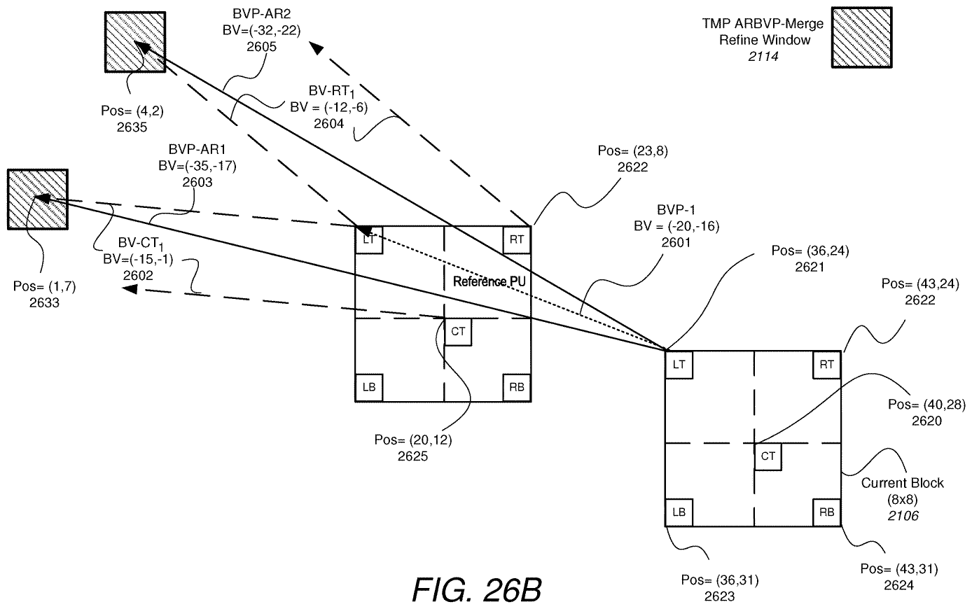

FIG. 26A shows an example of AR-BVP applied to IBC where the guiding BV (BV-1) 2601 is a BVP candidate in the IBC list, according to some embodiments. The guiding BV may be used to identify a first reference block (e.g., reference PU1), and five positions of the first reference block that are aligned with the five positions of the current block 2106 are also identified. Each of the five positions is checked to determine if a coding block containing the sample at the position is encoded/decoded using the IBC mode or IntraTMP mode. These positions are denoted correspond to the center of block (CT) 2620, left-top (LT) 2621, right-top (TR) 2622, left-bottom (LB) 2623, and right-bottom (RB) 2624. In the case that AR-BVP is used in IBC and a block containing a sample at a position of at least one of the five positions (CT, LT, RT, LB, and RB) defined relative to the first reference block was encoded/decoded using IntraTMP or IBC mode, the block vector used to indicate the reference block of the first reference block is used as the coding BV to combine with the guiding BV.

FIG. 26A further shows one example of multiple candidate AR BVPs iteratively derived from the initial guiding BV 2601. Guiding BV 2601 points to the first reference block (PU1). The five positions of the first reference block PU1, correspond to the guiding BV 2601 applied to the five respective positions (CT, LT, RT, LB, and RB) of current block 2106. Each of the five positions of the first reference block may be checked to determine if a block at any of those positions was coded in an IBC or IntraTMP mode. For example, a block at the position CT of the first reference block may be determined to be coded using BV-CT1 2604. Then, BV-CT1 2604 may be applied to the first reference block to determine a second reference block (reference PU2), from which five positions of the second reference block may be checked to derive one or more AR-BVPs. For example, the first AR-BVP candidate (BVP-AR1) 2605 may be derived as the addition of the guiding BV 2601 and the coding BV (BV-CT1) 2604 used for the encoding/decoding of the block containing/at position CT of the first reference block. The second AR-BVP candidate, BV-AR2 2607, may be derived as the addition of previous AR-BVP (BVP-AR1 2605) and a block vector BV-LT21 2606 derived from a block at LT position of the second reference block (reference PU2). For example, each of the five positions of the second reference block (reference PU2) may be checked to determine if a block containing the sample at those respective positions was encoded/decoded in an IntraTMP or IBC mode. For example, the block at the LT position may satisfy the condition and was coded using BV-LT21 2606, which points to a third reference block (reference PU3).

This cascading process may be iterated multiple times and referred to a number of hops. In some examples, the cascading process may be constrained to one hop. For example, BVP-AR1 2605 may be added as a candidate AR BVP derived from BVP-1 2601, but BVP-AR2 2607—which corresponds to a second hop-would not be determined and added as a second candidate AR BVP.

In some embodiments, the AR-BVP candidates 2605 (and 2607) may be included in the AMVP and/or merge lists after the spatial adjacent candidates. In some embodiments, AR-BVP candidates 2605 (and 2607) may be included in the AMVP and/or merge lists after the spatial non-adjacent candidates. In some embodiments, AR-BVP candidates 2305 (and 2307) may be included in the AMVP and/or merge lists after the HMVP candidates.

In some examples, AR-BVP technique may be implemented for IntraTMP and is referred to as IntraTMP AR-BVP merge. This technique uses the BVPs in the IntraTMP merge list as guiding BVs for the AR-BVP process.

In some examples, the TMP AR-BVP candidates, 2605 and 2607, may be included in the TMP merge lists after the adjacent and non-adjacent merge candidates. In some examples, TMP AR-BVP candidates 2605 and 2607 and the adjacent and the non-adjacent merge candidates may be sorted in an ascending order of the TMP costs within the TMP merge list. In some embodiments, the merge candidates (adjacent and non-adjacent candidates) and the AR-BVP candidates outside the TMP reference region may be included first within the TMP merge list.

In some examples, the refinement window for the AR-BVP candidates may have a different window size than that of the TMP merge candidates and the TMP sparse candidates. FIG. 26B shows examples of refinement windows for AR-BVP candidates derived from different positions associated with the initial guiding BV 2601, according to some embodiments. The first AR-BVP candidate (BVP-AR1) 2603 is derived as the addition of the guiding BV 2601 and the coding BV (BV-CT1) 2602 used for the encoding/decoding of a block containing the central position (CT) of the reference block (reference PU). Since the BVs of a block are typically referenced with respect to the upper left conner of the block, the guiding BV 2601 is illustrated as starting from the upper left conner of the current block 2106. The BV associated with the block containing the central position CT, BV-CT1 2602, is shifted based on the guiding BV 2601 so that the addition of these two BVs can generate AR-BVP candidate BVP-AR1 2603. Similarly, another AR-BVP candidate, BV-RT1 2605, is derived based on the BV associated with a block containing the sample at the RT position of the reference block. An AR-BVP candidate may be refined with a refinement window 2114. Specific refinement window 2114 for a given AR-BVP candidate is set according to the AR-BVP candidate. For example, positions 2633 and 2635 pointed to by BVP-AR1 2603 and BVP-AR2 2605, respectively, are used to determine the respective refinement windows.

In some embodiments, the following source code represent an example implementation for obtaining the five positions relative to a guiding BV and determining if a block at each of the five positions is coded based on IBC or IntraTMP mode:

const PredictionUnit & pu = *cs.getPU(area.pos( ), CHANNEL_TYPE_LUMA); // pu is the top left corner of the CB
// posCand indicate the 5 offset positions related to the CB. The pu position is equal to the topleft( ) not center( )
Position posCand[5] = {pu.Y( ).center( ),pu.Y( ).topLeft( ), pu.Y( ).topRight( ), pu.Y( ).bottomLeft( ),pu.Y().bottomRight( )};
// EXAMPLE
pu: {PU: x = 32, y = 24, width = 8, height = 8}
posCand = {x = 36 y = 28}, {x = 32 y=24}, {x = 39 y = 24}, {x = 32 y = 31}, {x = 39 y = 31}}
// Loop FOR to test the five positions around a first IBC Merge/AMVP candidate or TMP merge candidate
// bvBasedMergeCandidatesITMP_AR is the list of TMP merge candidates
for (int mergeIndex = 0; (mergeIndex < 25) && (bvBasedMergeCandidatesITMP_AR.size( ) < totalNum);
mergelndex++)
{
cMv_Sparse = SparseCandidatesITMP[mergeIndex];
offsetX = cMv_Sparse.m_pX;
offsetY = cMv_Sparse.m_pY;
CMv = Mv(offsetX, offsetY); // This is the Merge candidate to use as base for the AR-BVP
for (int n = 0; n < 5 && bvBasedMergeCandidatesITMP_AR.size () < totalNum; n++)/ Check the 5 positions
around the Merge BV
{
// puCascadedid the Merge candidate + one of the offset (CT, TL, TR, BL, BR)
const PredictionUnit* puCascaded = pu.cs->getPURestricted(posCand[n].offset(offsetX, offsetY), pu, pu.ch Type);
if (!puCascaded || (puCascaded->cu->predMode != MODE_IBC) && (!puCascaded->cu->tmpFlag)))
{
continue; // If the block in that position was not encoded with IBC or TMP, skip it and go to the next among the 5
}
Mv arbv = cMv + puCascaded->bv; //Build the AR-BVP candidate
// Check if reference block pointed out for the AR-BVP is already decoded
if (PU::validltmpBv(pu, arbv.hor, arbv.ver))
{
if (!PU:CheckBvAvailable(bvBasedMergeCandidatesITMP, arbv) &&
!PU::CheckBvAvailable(bvBasedMergeCandidatesITMP_AR, arbv))
{
// If the AR-BVP is valid and it is not already in the TMP merge list, it is added at the end of the TMP Merge list
bvBasedMergeCandidatesITMP_AR.push_back(arbv);
if (bvBasedMergeCandidatesITMP_AR.size( ) >= totalNum)
{
break; // If the list is complete, finish the TMP AR-BVP process
}
}
}

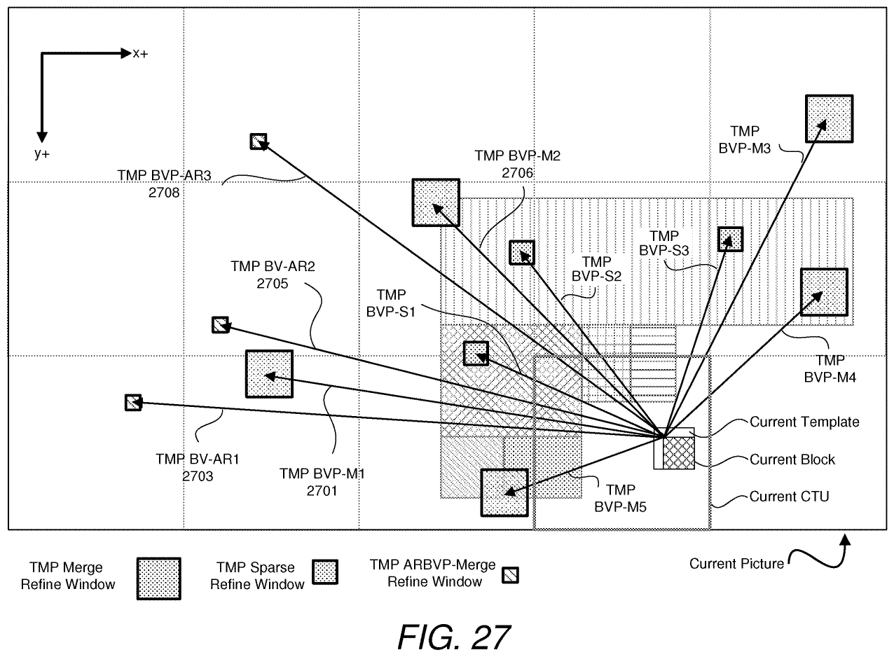

FIG. 27 shows one example of IntraTMP with BVP candidates derived using IntraTMP AR-BVP merge as discussed above with respect to FIGS. 26A and 26B. In FIG. 27, TMP merge candidate BVP-M1 2701 pointing to a location outside the TMP reference region is used as a guiding BV to derive two AR-BVP candidates, BV-AR1 2703 and BV-AR2 2705. Likewise, TMP Merge candidate BVP-M2 2706 is used as guiding BV to derive a new ARBVP candidate BV-AR3 2708.

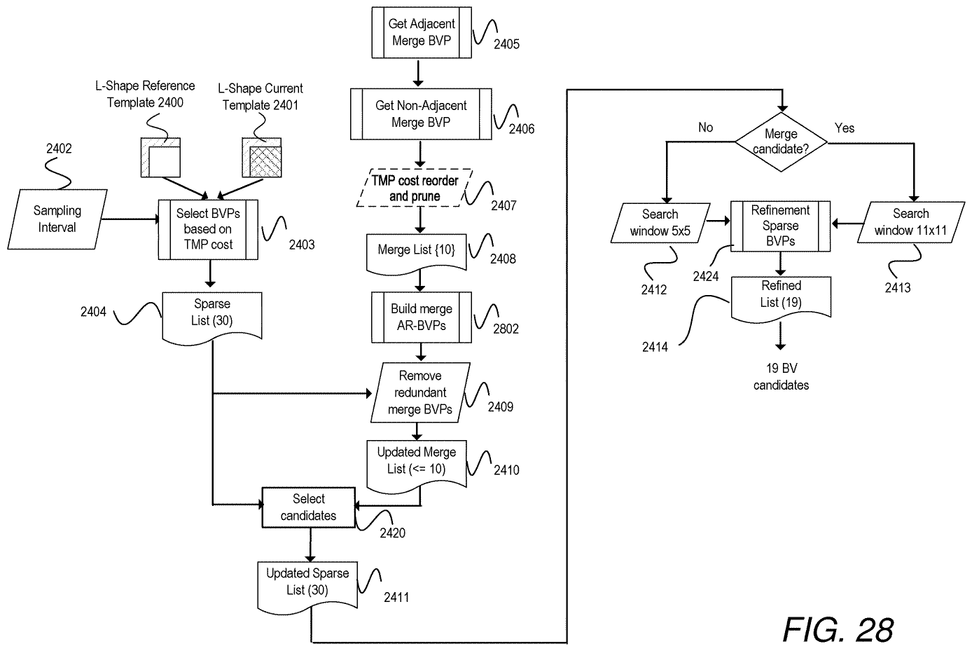

FIG. 28 shows an example of the IntraTMP AR-BVP merge process. The process shown in FIG. 28 is similar to the process shown in FIG. 24 except that a block 2802 is added to apply the AR-BVP to the merge list 2408 to generate AR-BVP candidates using the BVPs in the merge list 2408 as guiding BVs. Block 2409 is applied to the merge list 2408 and the generated AR-BVP candidates.

As discussed above, the AR-BVP technique may be applied to TMP merge candidates in the initial merge list 2408, optionally after reordering in accordance with TMP cost and pruning to a predetermined number at 2407, to derive additional BVP candidates (referred to as “merge AR-BVP candidates”) to be used in generating an updated merge list 2410. However, the number of TMP merge candidates in the initial merge list 2408 may be small for reasons such as a limited number of the adjacent and non-adjacent blocks being coded (encoded or decoded) using the IBC mode or the IntraTMP mode, the BVs of such adjacent and non-adjacent neighboring blocks being invalid, or the candidates derived from these merge candidates being duplicated in the list. This leads to a small number of merge AR-BVP candidates being generated which significantly reduces the efficiency of the AR-BVP merge technique.

Embodiments relate to the use of the AR-BVP technique on TMP BVP candidates to derive additional BVP candidates to provide diversity of candidates. For example, the AR-BVP technique may be applied to the BVP candidates derived in a search process using the TMP such as the sparse list to generate sparse AR-BVP candidates for use in the IntraTMP coding. The number of candidates in the sparse list is typically larger than the number of BV candidates in the initial merge list 2408. Consequently, there can be more derived sparse AR-BVP candidates than the merge AR-BVP candidates, leading to better BVP candidates to be selected for the refinement stage.

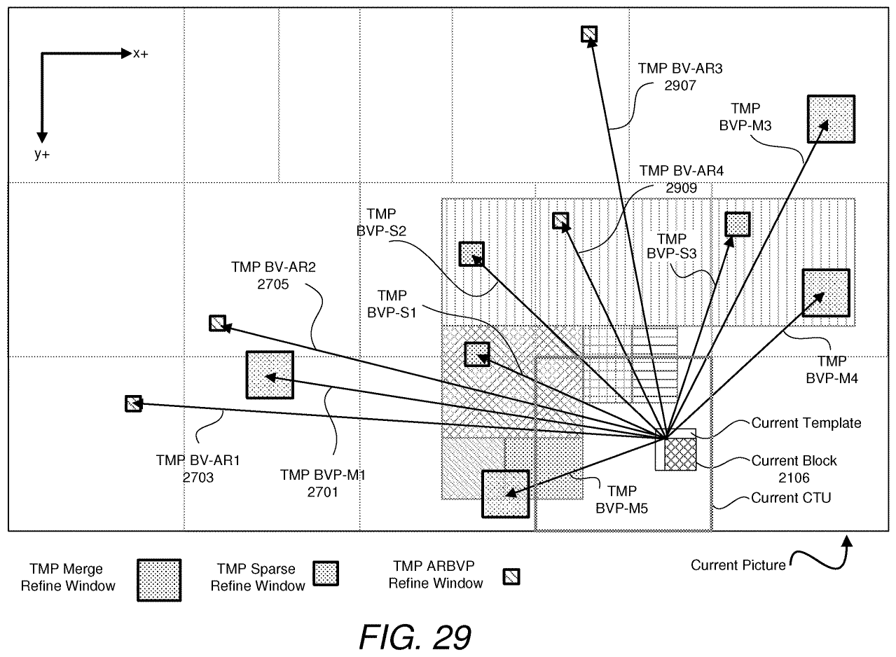

FIG. 29 shows an example of sparse AR-BVP candidates in IntraTMP generated by applying the AR-BVP technique to the TMP BV candidates, according to some embodiments. Compared with FIG. 27, in addition to the BV-AR1 2703 and BV-AR2 2705, which are merge AR-BVP candidates derived from the BVP-M1 merge candidate as explained above, a few sparse AR-BVP candidates are generated. For example, the sparse candidate TMP BVP-S2 may be used as a guiding BV, from which two new sparse ARBVP candidates, BV-AR3 2907 and BV-AR4 2909 can be derived using the AR-BVP technique as discussed above with respect to FIGS. 25-26B.

In some embodiments, the five positions used to determine the coding BVs for deriving the sparse AR-BVP candidates may be based on the size of current block 2106, as explained in FIGS. 26A-B. In other words, the reference block of the current block may be the same size as the current block and thus the size of the reference block determines the five positions, CT, LT, RT, LB, and RB in the reference block. In other embodiments, the five positions used to determine the coding BVs for deriving the sparse AR-BVP candidates may be based on the size of the refinement window at the position pointed to by the TMP sparse BVP candidate. For example, the positions may include a first position pointed to by the TMP sparse BVP candidate in the sparse list and the four corners of the refinement window centered at the first position.

In some embodiments, the TMP sparse AR-BVP candidates 2907 and 2909 may be included in the TMP merge lists after the adjacent and non-adjacent merge candidates, e.g., after adding BVP candidates from lists 2405 and 2406 of FIG. 24 or FIG. 28. In some embodiments, TMP sparse AR-BVP candidates 2907 and 2909, and the adjacent and the non-adjacent merge candidates may be sorted in an ascending order based on the TMP costs within the TMP merge list. In some embodiments, the merge candidates (adjacent and non-adjacent), and the AR-BVP candidates pointing outside of the TMP reference region may be included first within the TMP merge list before other candidates. In another embodiment, the refinement window for the sparse AR-BVP candidates may use a different refinement window size than that of the TMP merge candidates and the TMP sparse candidates as shown in FIG. 29.

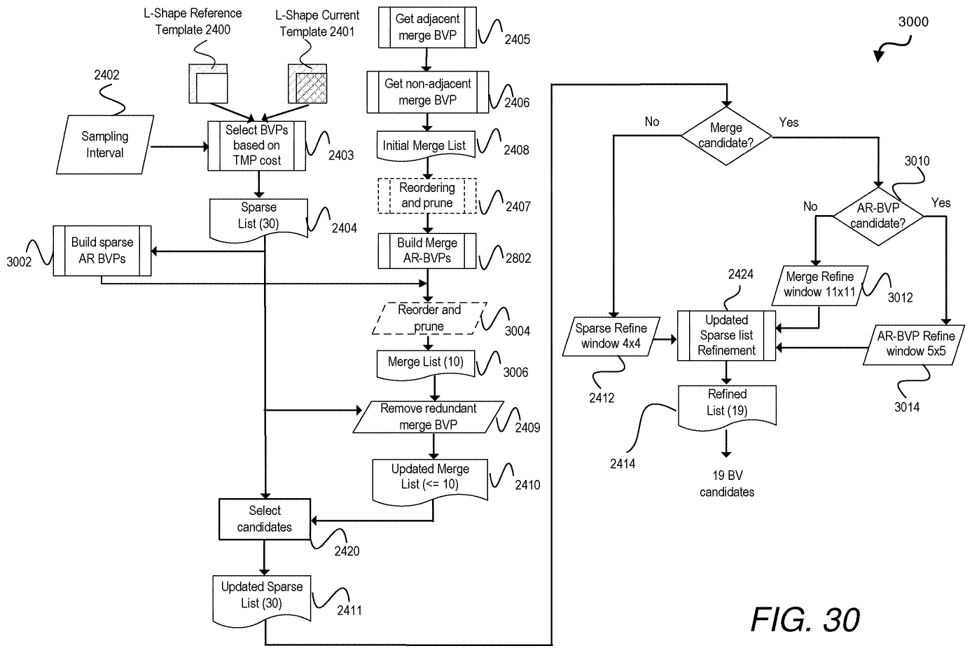

FIG. 30 shows an example process 3000 for applying TMP sparse AR-BVP candidates to the TMP, according to some embodiments. Process 3000 may be performed at the encoder and the decoder to generate the same refined list 2414 at block 2424. Operations of process 3000 that have the same labels as those in FIGS. 24 and 28 are performed in the same or similar way.

Compared with FIG. 28, process 3000 may include a new block 3002, which may generate one or more sparse AR-BVP candidates from BVP candidates in sparse list 2404. In some examples, the sparse AR BVP candidates may be derived by setting each BVP candidate in sparse list 2404 as a guiding BV, as explained in reference to FIGS. 25-29. For example, for a BVP in the sparse list 2404, the reference block pointed to by the BVP can be identified. Five locations, such as the CT, LT, LB, RT, and RB, of the reference block may be determined. For each of the five locations, the coding block that contains the sample at the location can be identified and the associated coding mode of the coding block can be determined. If the coding block is coded using an intra prediction mode having a BV associated therewith, such as the IntraTMP mode or the IBC mode, the BV of the coding block (coding BV) can be combined with the guiding BV to generate the sparse AR-BVP candidate. The remaining locations can be evaluated similarly. The same process can be repeated for other BVP candidates in the sparse list 2404 to generate additional sparse AR-BVP candidates.

In some embodiments, operations at block 3002 may be performed after obtaining adjacent and non-adjacent BVP candidates of lists 2405 and 2406, respectively. In some embodiments, operations at block 3002 may be performed before operations of obtaining BVP candidates of lists 2405 and 2406. In some examples, the various candidates such as adjacent candidates 2405, non-adjacent candidates 2406, merge AR-BVP candidates (block 2802) and sparse AR-BVP candidates (block 3002) may be reordered and/or pruned at block 3004 to generate the resulting merge list 3006. The merge list 2408 before the sparse AR-BVP candidates and the merge AR-BVP candidates are added is referred to as the initial merge list 2408.

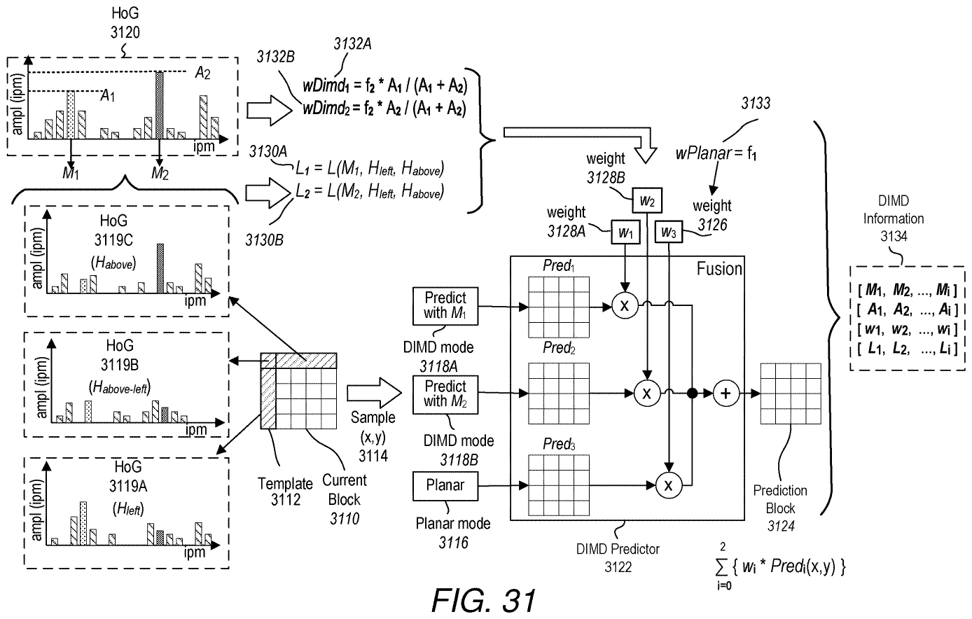

FIG. 31 is a diagram showing an example of decoder-side intra mode derivation (DIMD) for coding a current block 3110, according to some embodiments. DIMD is an intra coding mode in which one or more IPMs used to generate a prediction block 3124 of current block 3110 are not transmitted in the bitstream. Instead, the one or more IPMs may be derived by the decoder using a gradient analysis of neighboring reconstructed pixels (or reference samples) of current block 3110. In some examples, the one or more IPMs may be determined by the encoder, for example, by a rate distortion optimization (RDO) algorithm.

In DIMD, texture gradient analysis is performed on samples in template 3112 (e.g., reference template) associated with the current block 3110 to generate a histogram of gradient (HoG) 3120. From the HoG 3120, a number (e.g., 2) of DIMD modes such as one or more of DIMD modes 3118A-B may be derived. Each entry in HoG 3120 corresponds to a respective angular intra prediction mode (IPM) with amplitudes (or magnitudes) of the entries determined based on the gradient analysis.

In some examples, to derive the DIMD modes 3118A-B (and DIMD predictor 3122) for current block 3110, template 3112 including a set of reference samples (e.g., neighboring pixels) may be selected and used to perform a gradient analysis. These reference samples are part of the reconstructed portion of the picture containing current block 3110. Template 3112 may be a 3-samples wide (in width or height) template area (composed of left, above, and above-left areas) defined relative to a position of current block 3110.

In some examples, the gradient analysis may be performed using edge detection filters applied to 3×3 window positions centered on the reference samples/pixels selected from template 3112. The edge detection filters can determine the amplitude and the angle of luminance direction (e.g., orientation) for each reference sample. For example, the set of reference samples selected from template 3112 may include the samples in the middle line of template 3112. In some examples, the edge detection filters may include a horizontal Sobel gradient filter (Mₕₒᵣ) and/or a vertical Sobel gradient filter (Mᵥₑᵣ), represented by the following 3×3 matrices that will be convoluted with selected reference samples of template 3112:

$${M}_{hor} [ \begin{matrix}- 1 & 0 & 1 \\ - 2 & 0 & 2 \\ - 1 & 0 & 1\end{matrix} ] and {M}_{ver} = [ \begin{matrix}- 1 & - 2 & - 1 \\ 0 & 0 & 0 \\ 1 & 2 & 1\end{matrix} ]$$

For each of selected reference samples (e.g., pixels) of template 3112, point-by-point multiply of each of these two matrices with a 3×3 Sobel filter window may be performed and the results are summed. The 3×3 Sobel filter window may be centered around the current reference sample and composed of its 8 direct neighbors. Thus, two values Gₕₒᵣ (from the multiplication with Mₕₒᵣ), and Gᵥₑᵣ (from the multiplication with Mᵥₑᵣ) are obtained corresponding to the gradient intensities at the current sample, in the horizontal and vertical direction, respectively. An angle may be calculated for the window as angle=arctan (Gₕₒᵣ/Gᵥₑᵣ). The calculated angle may correspond to (e.g., be converted into) one of the angular IPMs (e.g., one of the 65 angular IPMs), and an associated amplitude (i.e., the amplitude for the window position) amplitude=|Gᵥₑᵣ|+|Gₕₒᵣ| may be added to the HOG indexed by the respective IPM. After an amplitude and angle for each window position in template 3112 are processed, each entry in resulting HoG 3120 represents the cumulated amplitudes for a respective IPM.

As shown in FIG. 31, a number of DIMD modes 3118A-B may be determined by selecting the IPMs from HoG 3120 based on amplitudes of the IPMs. For example, IPMs M1 and M2 with the highest respective amplitudes A1 and A2 in HoG 3120 may be selected and used to determine DIMD modes 3118A and 3118B, respectively. For example, up to a predetermined number (e.g., 4) of angular intra modes with the highest amplitudes may be selected from HoG 3120. In some examples, the number of DIMD modes 3118A-B may be combined in a fusion/blending scheme to generate a DIMD predictor 3122.

In some examples, a plurality of IPMs such as DIMD modes 3118A-B may be determined and combined with a planar mode 3116 in the blending/fusion process corresponding to DIMD predictor 3122. DIMD predictor 3122 may comprise a linear combination (e.g., a weighted average) of DIMD modes 3118A-B and planar mode 3116 with weights 3128A-B and 3126, respectively. In some examples, weights 3128A-B for DIMD modes 3118A-B may be determined based on amplitudes (e.g., magnitudes) associated with DIMD modes 3118A-B, respectively. For example, weight 3128A for DIMD mode 3118A may correspond to DIMD weight 3132A (e.g., wDIMD₁), which may be based on an amplitude A₁, from HoG 3120, associated with DIMD mode 3118A (e.g., IPM M₁) divided by a sum of amplitudes of DIMD modes 3118A-B. For example, weight 3128B for DIMD mode 3118B may correspond to DIMD weight 3132B (e.g., wDIMD₂), which may be based on an amplitude A2, from HoG 3120, associated with DIMD mode 3118B (e.g., IPM M₂) divided by the sum.

In some examples, planar mode 3116 may have a weight 3126 corresponding to planar weight 3133 that may be a fixed weight f₁ (e.g., ¼ or 16/64 in 6-bit integer precision). The remaining DIMD weights 3132A-B may include a fixed weight portion f₂ (e.g., ¾) that is based on the fixed weight of planar weight 3133. For example, the sum of fixed weights f₁ and f₂ may be equal to 1.

DIMD predictor 3122 may be applied to template 3112 (e.g., current template) to determine a prediction block 3124 for current block 3110. For example, each sample (x,y) 3114 of prediction block 3124, denoted as fusionPred, may be determined based on applying DIMD predictor 3122 comprising a weighted average (e.g., a linear combination) of applying DIMD modes 3118A-B and planar mode 3116 with corresponding weights (w) as follows:

$$fusionPred ( x , y ) = {\sum }_{i = 0}^{2} \{ {w}_{i} * {Pred}_{i} ( x , y ) \}$$

In some examples, the weights (wᵢ) may be the DIMD weights 3132A-B (wDimdᵢ for mode i) for DIMD modes 3118A-B and the planar weight 3133 (wPlanar) for planar mode 3116. The weights (w) may be constant and uniformly applied to determine each sample (x,y) 3114 of prediction block 3124. The predictor Predᵢ for mode i may be a DIMD mode predictor (dimdPred) for DIMD modes 3118A-B or a planar mode predictor (dimdPlanar) for planar mode 3116. Accordingly, DIMD predictor 3122 may be represented and computed equivalently as follows:

$$fusionPred ( x , y ) = ( {\sum }_{i = 0}^{1} \{ {wDimd}_{i} * {dimdPred}_{i} ( x , y ) \} + wPlanar * dimdPlanar ( x , y ) ) ≫ 6.$$

Note the shifting operation is performed due to the 6-bits integer precision being used.

The selection of DIMD is signaled in the bitstream for intra coded blocks using a flag. At the decoder, if the DIMD flag is true, the intra prediction mode is derived in the reconstruction process using the same previously encoded neighboring pixels. If not, the intra prediction mode is parsed from the bitstream as in classical intra coding mode.

In some examples, a location-dependent DIMD mode is introduced to adjust weights 3128A-B of angular IPMs (e.g., DIMD modes 3118A-B) in DIMD. During DIMD IPM derivation, a location-dependency process is applied to determine the impact that different template regions of template 3112 has in selecting each of the IPMs. To determine how specific samples in template 3112 contribute to inferring specific DIMD modes, template 3112 may be divided into three separate regions-including a region above current block 3110, a region to the left of current block 3110, and an above-left region of current block 3110. The gradient analysis computation may be performed separately for samples in each region, resulting in three histograms, HoG 3119C (H_{above}), HoG 3119A (H_{left}), and HoG 3119B (H_{aboveLeft}), respectively. For a directional IPM m, Hᵢ[m] for region i (e.g., above, left, or above-left) represents the cumulative magnitude of all samples in region i at direction (or IPM) m.

HoG 3120, corresponding to the full histogram of gradients for the whole template 3112, may be computed as the sum of the three separate HoGs 3119A-C. In some examples, the two directional IPMs with largest and second-largest cumulative amplitude (e.g., magnitude) in HoG 3120 may be selected as main and secondary DIMD modes, e.g., dimdMode₀ and dimdMode₁, respectively.

In some examples, HoGs 3119C and 3119A corresponding to histograms H_{above} and H_{left} may be used to determine whether dimdMode₀ and/or dimdMode₁ depend on a specific template region ABOVE or LEFT. In a first example, the location-dependency of dimdModeᵢ, denoted as locDepᵢ (e.g., shown in FIG. 31 as Lᵢ=L (Mᵢ, H_{left}, H_{above}) for DIMD mode i), can be defined as:

If: (H_{above} [dimdModeᵢ] > 2H_{left} [dimdModeᵢ]), then:
locDepᵢ = 1, that is dimdModeᵢ depends on region
ABOVE.
Else if: (H_{left} [dimdModeᵢ] > 2H_{above} [dimdModeᵢ]), then:
locDepᵢ = 2, that is dimdModeᵢ depends on region LEFT.
Else:
locDepᵢ = 0, that is dimdModeᵢ is not location dependent.

In a second example, the location-dependency of dimdModeᵢ, denoted as locDepᵢ (e.g., shown in FIG. 31 as Lᵢ=L (Mᵢ, H_{left}, H_{above}) for DIMD mode i), can be defined as:

If : (H_{left} [dimdModeᵢ] <
average of (H_{left} [dimdModeᵢ], H_{above} [dimdModeᵢ],
H_{aboveLeft} [dimdModeᵢ])) then:
locDepᵢ = 1, that is dimdModeᵢ depends on region
ABOVE.
Else if : (H_{above} [dimd Modeᵢ] <
average of (H_{left} [dimdModeᵢ], H_{above}
[dimdModeᵢ], H_{aboveLeft} [dimdModeᵢ])), then:
locDepᵢ = 2, that is dimdModeᵢ depends on region
LEFT.
Else:
locDepᵢ = 0, that is dimdModeᵢ is not location
dependent.

In this example, the indication of location-dependency may be determined based on comparing an amplitude of a HoG corresponding to a specific template portion with the average amplitude of the HoGs of all the template portions of the template.

Thus location-dependency in DIMD may be determined based on the analysis of HoG peaks amplitudes of the selected angular IPM. For example, location-dependency indications 3130A-B may be determined for DIMD modes 3118A-B, respectively. Location-dependency indication for DIMD mode 3116, which may be a planar mode, may be determined as a value representing that it is not location dependent or that it is diagonally dependent.

In some embodiments, the fusion/blending scheme by which DIMD predictor 3122 is determined may be adjusted based on the location-dependent DIMD modes. For example, blending may be performed to fuse the main and secondary DIMD predictors, dimdPred₀ and dimdPred₁, with the Planar predictor dimdPlanar. If no DIMD mode is determined to be location-dependent (e.g., locDep₀==locDep₁==0), then blending/fusion with uniform weights wDimd₀, wDimd₁ and wPlanar may be applied as explained above.

In some embodiments, if at least one of the DIMD modes 3118A-B is inferred to be location-dependent, then sample-based blending may be used to determine DIMD predictor 3122. A location varying/dependent weight may be used to blend the predictors at each location of sample (x,y).

In some examples, if locDepᵢ≠0, the sample-based weights wLocDepDimdᵢ(x,y) for predictor dimdPred; may be computed so that the average weight used within the block is approximately equal to the uniform weight wDimdᵢ with higher weights being used in the portion of the block closer to the region (e.g., ABOVE or LEFT) corresponding to locDepᵢ (e.g., indication Lᵢ). A fixed range Δᵢ may be determined and is predefined, (e.g., Δᵢ=10) corresponding to the largest deviation of wLocDepDimdᵢ(x,y) from wDimdᵢ. Higher values of Δᵢ result in a higher variation of the weights within the block. For a block of size H×W:
If locDepᵢ=1, then:

$${wLocDepDimd}_{i} ( x , y ) = {wDimd}_{i} + {Δ}_{i} - 2 {Δ}_{i} \frac{y}{( H - 1 )}$$

Else if locDepᵢ=2, then:

$${wLocDepDimd}_{i} ( x , y ) = {wDimd}_{i} + {Δ}_{i} - 2 {Δ}_{i} \frac{x}{( W - 1 )}$$

If both DIMD modes 3118A-B (i=0 and i=1) are associated with location-dependency indications Lᵢ that indicate location dependency (i.e., locDepᵢ≠0 for modes i=0,1), then the weights wLocDepDimdᵢ(x,y) may be computed for both predictors depending on the value of locDepᵢ, as shown above.

In some examples, if only one of DIMD modes 3118A-B is associated with a location dependency indication Lᵢ indicating that it is location dependent, e.g., locDepᵢ=0 and locDep₍₁₋ₜ₎≠0, then the weights for wLocDepDimdᵢ(x,y) may be computed as:

$${wLocDepDimd}_{i} ( x , y ) = {wDimd}_{i} - \frac{{wLocDepDimd}_{( 1 - i )} ( x , y ) - {wDimd}_{( 1 - i )}}{2}$$

Finally, weight 3126 for the planar predictor wLocDepPlanarᵢ(x,y) may be computed as:

$$wLocDepPlanar ( x , y ) = 64 - {\sum }_{i = 0}^{1} \{ {wLocDepDimd}_{i} ( x , y ) \}$$

In some examples, the final location-dependent DIMD predictor 3122 may be applied to generate each sample (x,y) of prediction block 3124 as follows:

$$fusionPred ( x , y ) = ( \begin{matrix}{\sum }_{i = 0}^{1} \{ {wLocDepDimd}_{i} ( x , y ) * {dimdPred}_{i} ( x , y ) \} + \\ wLocDepPlanar ( x , y ) * dimdPlanar ( x , y ) + 32\end{matrix} ) ≫ 6$$

In some examples, as explained above, planar mode 3116 may be systematically applied in the blending process with a fixed weight f₁ (e.g., ¼ or 21/64). Note the shifting operation is performed due to the 6-bits integer precision being used.

In some embodiments, based on current block 3110 being coded using DIMD, DIMD information 3134 may include DIMD parameters that are generated and stored in association with current block 3110. For example, the DIMD parameters may include indications of the selected DIMD modes 3118A-B (M₁, M₂, . . . , Mᵢ), amplitudes from HOG 3120 (A₁, A₂, . . . , Aᵢ) of the selected DIMD modes 3118A-B, and/or weights 3128A-B (w₁, w₂, . . . , wᵢ) of the selected DIMD modes 3118A-B. For example, weights 3128A-B may be the DIMD weights 3132A-B corresponding to selected DIMD modes 3118A-B. In some examples, the DIMD parameters may further include location-dependency indications (L₁, L₂, . . . , Lᵢ) of the selected DIMD modes 3118A-B. In some examples, DIMD information 3134 may include a plurality of lists (e.g., arrays) of DIMD parameters with each list corresponding to a different DIMD parameter type. For example, the plurality of lists may include a list of IPMs, a list of amplitudes, a list of weights, and/or a list of indications of location-dependency. Parameters at the same index across the plurality of lists correspond to the same DIMD mode or IPM indicated by the index to the list of IPMs.

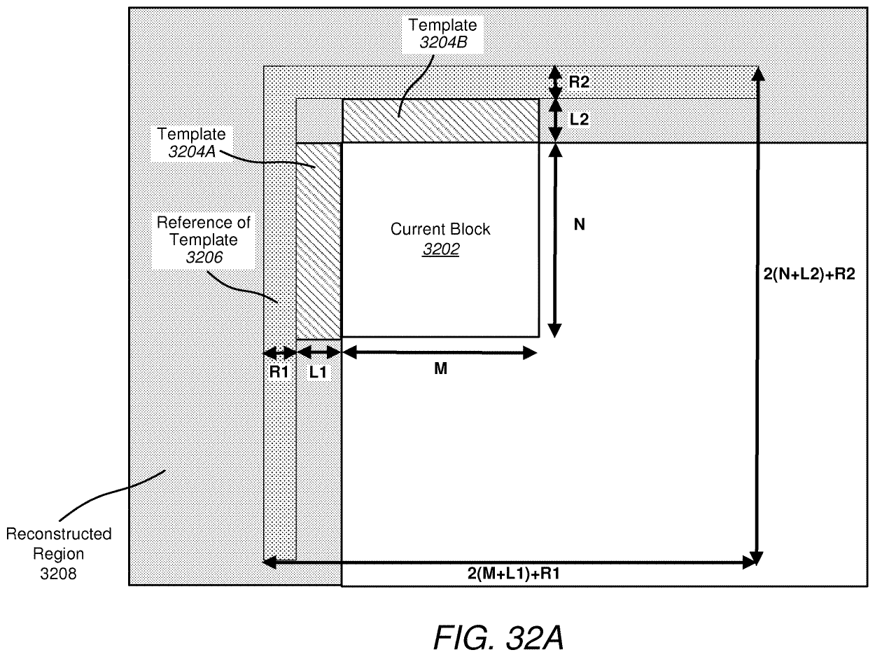

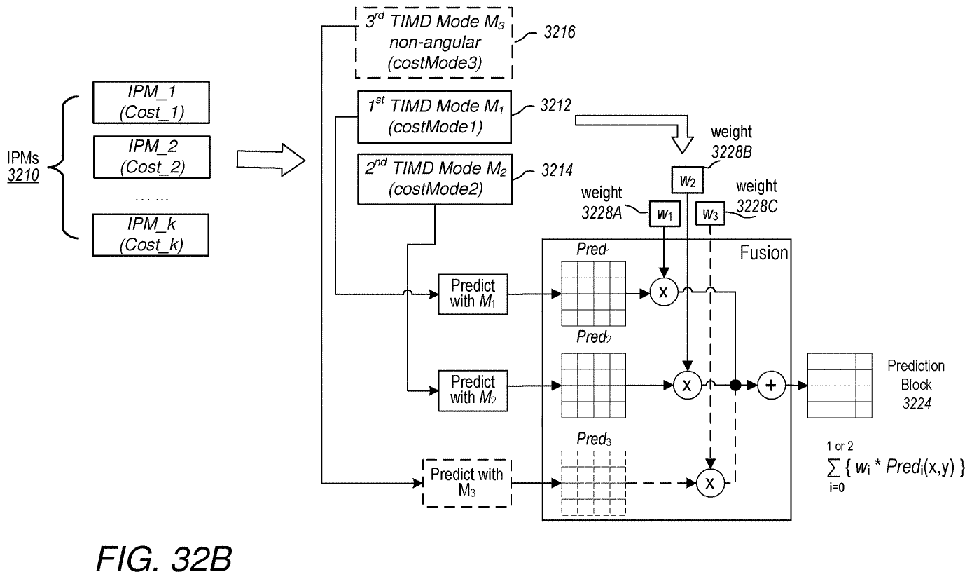

FIG. 32A and FIG. 32B show an example of template-based intra mode derivation (TIMD) for coding a current block, according to some embodiments. The TIMD mode is a type of intra prediction in which an intra prediction mode (IPM) may be identically determined (e.g., independently derived) by an encoder (e.g., encoder 200) and a decoder (e.g., decoder 300) such that the IPM(s) determined (e.g., selected) by the encoder does not need to be signaled to the decoder. Hence signaling bandwidth is reduced and TIMD may be considered as a type of decoder-side intra mode derivation process.

As shown in FIG. 32A, in the TIMD mode, a video coder (e.g., encoder 200 or decoder 300) may determine a template 3204 for current block 3202. Template 3204 may comprise one or more regions of samples in a reconstructed region 3208 of a current picture (or frame) of current block 3202. The one or more regions may include reconstructed samples neighboring (e.g., adjacent to) current block 3202. In some examples, the one or more regions of template 3204 may comprise a template region 3204A to the left of current block 3202 (e.g., a left template) and a template region 3204B above current block 3202 (e.g., an above template). In some examples, template 3204 may include a region that is above and to the left of current block 3202 (e.g., the region enclosed by reference of template 3206 and template regions 3204A-B). Template regions 3204A and 3204B may have a thickness (e.g., width and height respectively) of L1 and L2 samples, respectively. For example, L1 and/or L2 may be 2 samples, 4 samples, 8 samples, etc. Template region 3204A may have a height of N samples, which may be a height of current block 3202. Template region 3204B may have a width of M samples, which may be a width of current block 3202.

In the TIMD mode, reference of template 3206 is used to derive a template predictor for template 3204. The video coder may determine (e.g., select and obtain) reference of template 3206 as a region of samples (in reconstructed region 3208) neighboring (e.g., adjacent to) template 3204. For example, reference of template 3206 may comprise reconstructed samples left and above template 3204. Reference of template 3206 may have a thickness to the left of template region 3204A of R1 samples and a thickness above template region 3204B of R2 samples. For example, R1 and/or R2 may be 1 sample, 2 samples, 4 samples, etc. In some examples, reference of template 3206 may include an upper region having a width greater than template region 3204B (e.g., a width that is greater or equal to twice the width of template region 3204B, 2(M+L1) samples, 2(M+L1)+R1 samples, etc.). In some examples, reference of template 3206 may include a left region having a height greater than template region 3204A (e.g., a height that is greater or equal to twice the height of template region 3204A, 2(N+L1) samples, 2(N+L1)+R2 samples, etc.).

In some examples, a TIMD mode predictor may be determined using a list of candidate intra prediction modes (IPMs), such as the list of IPMs 3210 shown in FIG. 32B. For example, the list may include IPMs from a most probable mode (MPM) list. In some examples, one or more of a DC mode, a planar mode, a horizontal and/or vertical DC mode, or a horizontal and/or vertical planar, may be added to the list of candidate IPMs. A cost (e.g., SAD or SATD) for each candidate IPM in the list may be determined based on differences between reconstructed samples in template 3204 and predicted samples of template 3204 generated based on reference of template 3206 and using the candidate IPM. For example, the video coder may determine the predicted samples by applying the candidate IPM to samples of reference of template 3206. For example, applying the candidate IPM may include interpolating the predicted samples of template 3204 from samples in the reference of template 3206 according to the candidate IPM (e.g., a direction or angle corresponding to the candidate IPM), similar to the intra prediction process described above with respect to FIGS. 10-12.

In some examples, a first IPM and a second IPM, from the list, with the lowest costs of costs determined for candidate IPMs in the list are selected to determine (e.g., derive) a first TIMD mode 3212 and a second TIMD mode 3214. In an example, the first and second TIMD modes are determined as the first and second IPMs, respectively.

In some examples, the first and second TIMD modes may be determined by refining the first and second IPMs. For example, an angular mode range may be extended from a first range of the list (e.g., 67 modes) to a second range (e.g., 131 modes) and costs of the two adjacent modes (i.e., +/−1 mode) of each selected IPM may be determined. For example, the first TIMD mode may be determined as an IPM having the smallest cost among costs of the first IPM and its two adjacent modes in the second range. The second TIMD mode may be determined as an IPM having the smallest cost among costs of the second IPM and its two adjacent modes in the second range.

In some embodiments, a TIMD mode predictor 3222 may be determined based on combining (e.g., blending or fusing) the first TIMD mode 3212 and the second TIMD mode 3214. For example, the TIMD mode predictor may be a linear combination of the predictors generated by the first TIMD mode 3212 and the second TIMD mode 3214. Each weight (3228A or 3228B) of the first and second TIMD modes, in the linear combination, may be determined based on costs costMode1 and costMode2 of the first and second TIMD modes, respectively. For example, a weight, for a TIMD mode, may be determined as being inversely proportional to a cost of the TIMD mode. The TIMD mode predictor may be applied to template 3204 to determine a prediction block 3224 for current block 3202.

In some examples, a third TIMD mode 3216 may be selected for the current block 3202. The third TIMD mode 3216 may be a non-angular intra prediction mode (i.e., DC or Planar) with the lowest cost among the non-angular IPMs. This non-angular mode 3216 and the first two TIMD modes 3212 and 3214 may be fused to generate the prediction block 3224.

In some cases, not all three TIMD modes are used to generate the TIMD mode predictor. For example, the third TIMD mode (the non-angular intra prediction mode) is used in the fusion only when certain conditions are satisfied. For example, the conditions may include one or more of (1) the non-angular intra prediction mode being different from each of the first two TIMD modes, and (2) the cost of the third TIMD mode being smaller than a threshold. The threshold can be determined as a scaled value of the lowest cost value of the first two TIMD modes, i.e., costMode3<α*costMode1. Here, costMode3 is the cost of third TIMD mode 3216 (the non-angular IPM) and costMode1 is the cost of the first TIMD mode 3212 (i.e., the TIMD mode having a lower cost among the first and second TIMD modes). In one example, the scaling factor α can be 1.5. If both conditions are satisfied, three TIMD modes 3212-3216 are used to generate the prediction block 3224. The weight 3228 of the i-th intra prediction mode (i=1, 2, 3) can be computed from the costs of these three modes as follows:

$${weight}_{i} = \frac{sumCost - {costMode}_{i}}{2 \times sumCost} , sumCost = {\sum }_{j = 1}^{3} {costMode}_{j} .$$

If the above two conditions are not both satisfied, the third TIMD mode 3216 (i.e., the non-angular intra prediction mode) is not used in the prediction.

In further examples, the costs of the first two selected TIMD modes 3212 and 3214 are compared to determine whether the fusion is to be applied. For example, a ratio of the costs of the two TIMD modes can be compared with a threshold as follows:

$$\frac{costMode 2}{costMode 1} < β .$$

In some examples, β=2. If this condition is satisfied, the two TIMD modes 3212 and 3214 are fused to generate the prediction block 3224 as discussed above. Otherwise, only the first TIMD mode 3212 (the mode having the lower cost) is used to generate the prediction block 3224.

With the generated TIMD prediction block 3224, an encoder may generate a residual (e.g., prediction error) based on a difference between the prediction block 3224 and current block 3202. A decoder may reconstruct current block 3202 based on the reciprocally generated prediction block and the residual received from the encoder in a bitstream.

In some examples, the TIMD modes may be stored as corresponding (refined) IPMs in DIMD information used in coding current block 3202. Additionally, the DIMD information may include parameters such as the costs and/or derived weights for the IPMs corresponding to the TIMD modes. Different from the DIMD information stored for intra coding modes such as DIMD, MIMD, OBIC, DIMD Merge List, the DIMD information stored for the TIMD mode does not include amplitudes of histograms. In some examples, the DIMD information may also include parameters such as indications of location-dependency, referred to as directionalities, determined for the IPMs corresponding to the TIMD modes.

In some examples, directionalities (e.g., first and second directionality) of the TIMD modes (e.g., first and second TIMD modes) may be determined based on costs of the TIMD modes. For example, a directionality or indication of location dependency may include horizontal indicating prediction samples closer to the left boundary of the current block are likely to be more spatially correlated with the parameters (e.g., weight) for the determined TIMD mode, vertical indicating prediction samples closer to the above boundary of the current block are likely to be more spatially correlated with the parameters (e.g., weight) for the determined TIMD mode, no direction, and/or diagonal indicating a combination of horizontal and vertical. In an example, no direction may correspond to and indicate the diagonal direction.

For a selected TIMD mode (e.g., a candidate minimizing SATD cost computed in the template area), the directionality (indicating location-dependency) may be determined based on which portion(s) of the current template contributes the most to the selection of the TIMD mode. There are as many location-dependency directionalities as regions of the current template. For instance, a current template may comprise a first region (e.g., template region 3204B) and a second region (e.g., template region 3204A). If it is determined that the above template is the most impactful template for the selection of the TIMD mode, the location-dependency state associated to the TIMD mode is set to “vertical” i.e. sample-wise vertical fusion will be operated for blending this TIMD mode. If it is determined that left template is the most impactful template for the selection of the TIMD mode, the location-dependency state associated to said selected predictor is set to “horizontal” i.e. sample-wise horizontal fusion will be operated for blending this TIMD mode. If templates participation in the selection of the TIMD mode is balanced, the associated location-dependency state is set to “non-location-dependent” and neither sample-wise process is operated (meaning regular block-wise weight blending is achieved) or a sample-wise diagonal fusion will be operated for blending this TIMD mode. Thus, location-dependency state associated to selected TIMD mode impacts directionality of the sample-wise TIMD fusion process. In some examples, the first region and the second region do not overlap. In other examples, they may overlap.

In some examples, the directionality may be determined according to availability of template samples and/or template regions. For example, only one template region may be available at the picture border. For example, if only the first region (e.g., left template) is present or available, a first directionality may be determined (e.g., location-dependency being set to 2 indicating horizontal) corresponding to that first region. Otherwise, if only the second region (e.g., above template) is present or available, a second directionality may be determined (e.g., location-dependency being set to 1 indicating vertical) corresponding to that second region. In some examples, when the location dependency is determined as being not enabled (e.g., disabled) the value may be set to, e.g., 0, which may indicate a diagonal direction.

In some examples, the impact may be determined based on comparing a first cost of the first region with a second cost of the second region. The cost may be calculated much like how TIMD costs are calculated, e.g., using SATD, sum of squared error (SSE), or SAD. In some examples, a lower cost indicates higher impact. In some examples, a ratio may be calculated between the first cost and the second cost to determine which region has greater impact and thus determine the directionality of the TIMD mode.

For example, for the first cost for the first region (e.g., a left template region/area) and the second cost for the second region (e.g., an above template region/area), determination of the directionality of the TIMD mode may be determined as follows:

If SATD_{A} < k. SATD_{L}, locDepᵢ = 1
Else if SATD_{L} < K. SATD_{A}, locDepᵢ = 2
Otherwise, locDepᵢ = 0

For illustrative purposes, the costs are represented as SATD costs, but other costs are possible. SATD_{A} is the SATD cost associated with a selected TIMD mode and computed in the second region (e.g., above template). SATD_{A} is the SATD cost associated with a selected TIMD mode and computed in the first region (e.g., left template). locDepᵢ is the location-dependent parameter value associated with the i-th selected TIMD mode (e.g., i belongs to [0;2]). A value of 0 may indicate no location-dependency; a value of 1 may indicate vertical location-dependency of the i-th selected TIMD mode; and a value of 2 may indicate horizontal location-dependency of the i-th selected TIMD mode. k is a scaling factor and, e.g., may be a value less than 1. For example, k may be a value comprised in the range [ 1/10; ⅙] such as ⅛.

In some examples, when a candidate TIMD mode is non-angular (e.g. DC or Planar mode), the associated location-dependency state (e.g., directionality) may be set to 0 (e.g., indicating no-location-dependency) as it is expected that these “flat” modes when selected do not exhibit large differences in terms of relative template SATD. However, in other examples, a location-dependency state may be determined (e.g., derived) for the candidate non-angular TIMD mode similar to how the location-dependency state is determined for an angular TIMD mode, as described above.

In some examples, a directionality of a non-angular mode may be derived/determined based on a plurality of directional non-angular modes (e.g., directional DC, directional planar) corresponding to that non-angular mode. For example, the directionality may be determined as being corresponding to direction of the lowest cost (e.g., SATD cost) of the directional non-angular modes (e.g., among vertical, horizontal and original modes). For instance, template SATD cost may be computed for original, horizontal and vertical Planar modes. If horizontal planar mode has the minimum SATD among the three planar modes, location-dependency or the directionality for the planar mode may be set to horizontal. If vertical planar mode has the minimum SATD among the three planar modes, location-dependency or the directionality for the planar mode may be set to vertical. Otherwise, if the original planar mode has the minimum SATD, then the directionality may be set to diagonal (or possibly sample-wise fusion is deactivated). It is noted that although a directional non-angular mode has a lowest SATD, the regular original non-angular mode may be used during the fusion process.

Another intra mode prediction technique proposes to combine the benefits of TIMD and inter-prediction merge modes to obtain a new efficient intra-prediction mode referred to herein as the “TIMD merge mode.” For each CU predicted, TIMD merge mode includes building a list of TIMD information and selecting one to be used to reconstruct the current block. This list, referred to as “list of TIMD merge candidates,” can be built from the TIMD information from various spatial neighbors (e.g., neighboring blocks in the current frame). The TIMD information may already be available for several of the intra neighboring CUs (i.e., spatial neighboring blocks) coded in TIMD mode or non-TIMD mode as many intra coding modes require TIMD information to increase the coding speed. The TIMD information can include prediction modes, fusion flag, fusion weights, and wide-angle conditions of TIMD modes.

An initial list of TIMD merge candidates can be constructed according to a given checking order of respective TIMD merge candidate families, such as TIMD information of spatial adjacent candidates, TIMD information of spatial non-adjacent candidates. The list of TIMD merge candidates may have a predetermined maximal number of TIMD merge candidates (e.g., 10), and the generation process can be stopped when the maximal number is reached (i.e., when the list is full). Moreover, the generation of the list may ensure that no TIMD merge candidates with duplicate TIMD information is added to the list.

After forming the TIMD merge list, the merge candidates are sorted based on the SATD cost over the template of the current block. For the weight calculation, the SATD costs of the pair TIMD modes may be normalized using their respective fusion weights. For example, if a merge candidate has two intra modes (IPM1, IPM2) with fusion weights (W1, W2), the candidate's cost is calculated as:

Cost=(SATD(IPM₁)*W₁+SATD(IPM₂)*W₂)>>shift.

The template size and the template cost calculation aspects may be the same as those in the TIMD mode. After sorting the TIMD merge candidates, the two best candidates from the list are selected to be used in encoder RDO algorithm.

Usage of the mode can be signaled with a CABAC-coded CU-level flag. The TIMD merge mode may be used as a sub-mode of the TIMD tool. Moreover, when the TIMD merge mode is enabled, a CABAC-coded index can also be signaled to indicate whether the first or the second candidate is used from the merge.

The TIMD merge list can be extended to consider TIMD information of history-based spatial candidates, TIMD information of combined candidates, and default TIMD information candidates. Furthermore, the maximal number of candidates per family can be bounded.

The TIMD mode, the TIMD merge mode, and any other mode derived from TIMD mode may be collectively referred to as “TIMD-based modes or sub-modes.” The process involved in a TIMD-based mode or a DIMD-based mode may be referred to as the “intra coding sub-mode derivation process.”

In some embodiments, TIMD can be modified to support the use of block vectors to derive one of the intra modes. When deriving the TIMD intra modes (up to three IPMs), the IBC block vector candidates or IntraTMP block vector candidates of neighboring blocks (e.g., in the merge list) can be evaluated and considered to replace one of the TIMD intra modes such as one of TIMD modes 3216, 3212, and 3214 described above with respect to FIGS. 32A-B. In some examples, a BV candidate is used to replace any one of the TIMD modes if the cost associated with the block vector candidate is lower than the cost of that TIMD mode. As a result, the reference block indicated by the BV candidate is used to replace the prediction generated by the TIMD intra mode for fusion with the predictions of remaining TIMD intra modes, if there are any. In other examples, only the third non-angular TIMD intra mode is replaced by the BV candidate if the cost associated with the block vector candidate is lower than the cost of the non-angular TIMD intra mode. The BV candidate used to replace one of the TIMD intra modes may be referred to as a “TIMD BV.”

As discussed above, some intra coding modes, such as the DIMD-based mode (DIMD, MIMD, DIMD Merge, OBIC) or the TIMD-based mode (TIMD or TIMD merge), generate a prediction of the block by combining a first prediction based on an intra prediction mode (IPM) and a second prediction based on the coding BV. These types of intra coding modes may be collectively referred to as an “IPM-based intra coding mode.”

In several technologies, intra-based prediction modes, including both directional/angular and non-directional/non-angular intra prediction mode, require explicit signaling of the index of intra coding mode utilized. For instance, when the Most Probable Mode (MPM), Secondary MPM, or non-MPM lists are utilized for coding, the index of the selected IPM must be explicitly signaled in the bitstream. These extra bits used to signal the indices of the selected intra prediction modes increase the bitrate of the coded bitstream, thereby decreasing the coding efficiency.

To solve this problem, a technology named block vector-based intra mode derivation (BVIMD) has been proposed where the intra coding mode for a block is derived at both the encoder and decoder instead of signaled in the bitstream. For example, the intra coding mode for a block can be derived using reference block(s) (RBs) pointed to by block vector(s) (BV) associated with the block instead of using the block itself which is only available at the encoder. This eliminates the need for explicit signaling of the intra prediction mode of the block and reduces signaling overhead. Compared with other intra mode derivation mechanisms, such as the DIMD and TIMD discussed above which rely on gradient analysis of neighboring reconstructed pixels, the BVIMD uses the reconstructed reference block pixels themselves for intra mode derivation which have more direct correlation with the current block and thus provide more accurate predictions. As a result, the mode derivation is more accurate, and fewer bits are needed to represent the prediction residual which further reduces the bitrate.

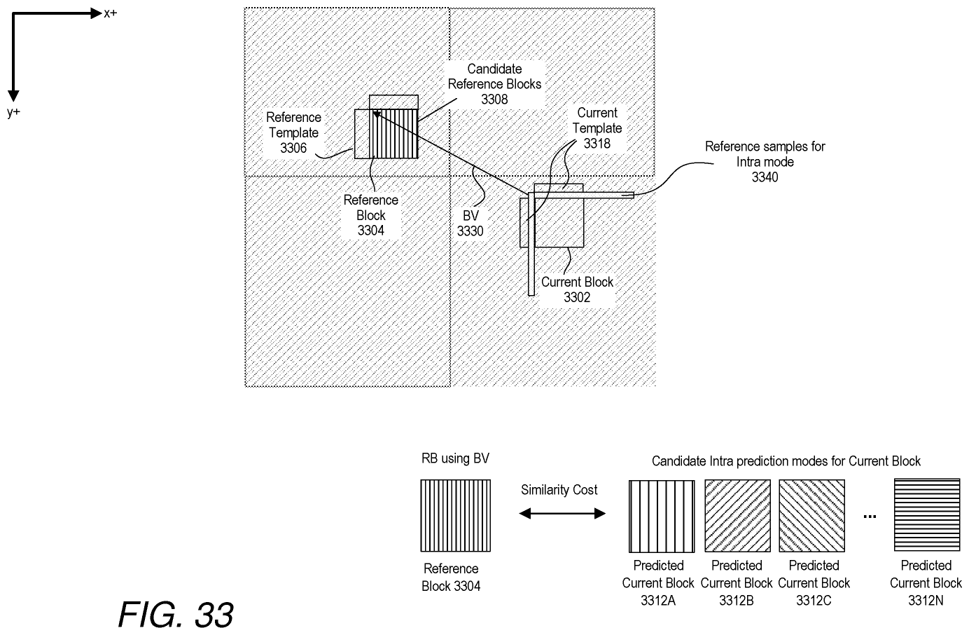

FIG. 33 shows an example of determining the intra coding mode for a block using the BVIMD, according to some embodiments. In this example, for a current block 3302, reference samples 3340 for determining intra coding mode of the current block 3302 are determined. The reference samples 3340 may include reconstructed samples from neighboring blocks of the current block, such as the samples of neighboring block(s) above the current block and/or samples of neighboring block(s) to the left of the current block. An IPM may be applied to the reference samples 3340 to determine a predicted current block. Thus, by applying each IPM in a list of candidate IPMs to the reference samples 3340, a set of predicted current blocks 3312A-3312N can be generated. If the current block is coded using the multiple reference line (MRL) mode, the reference samples 3340 may include multiple reference lines and the predicted current blocks 3312A-3312N are generated based on these multiple reference lines which can enhance the robustness of the derived intra prediction. In other examples, the MRL mode is used only at the prediction stage of the current block without using the MRL mode during the intra mode derivation process.

To determine the intra coding mode for the current block, the IPM leading to the predicted current block 3312 that is the most similar to the current block 3302 should be selected. However, because the decoder does not have access to the current block 3302, the similarity needs to be measured between a predicted current block and a block that resembles the current block 3302. In the BVIMD, a reference block pointed to by a block vector (BV) 3330 associated with the current block 3302 is used to calculate the similarity for determining the intra coding mode of the current block 3302. For example, a similarity may be determined based on a difference between the predicted current block and the reference block. The reference block was obtained for being representative of the current block 3302.

For example, the BV 3330 associated with the current block 3302 may be a BV determined via the template matching prediction (TMP or IntraTMP) applied on the current block 3302. As discussed above (e.g., in FIGS. 24, 28, 30), the TMP/IntraTMP may generate various BVP lists, such as the merge list 2408, the sparse list 2404 or 2411, the refined list 2414 and so on. The BV 3330 used to determine the intra coding mode for the current block 3302 may be selected from one or more of these BVP lists. For example, the TMP/IntraTMP may be applied to the current block 3302 based on the current template 3318 and reference templates of potential reference blocks. A set of BV candidates may be determined to include BV candidates in the BVP lists generated by applying the TMP/IntraTMP to the current block 3302, such as the merge list, the sparse list, and the refined list.

In some examples, to reduce the complexity of the BVIMD, a partial process of the TMP/IntraTMP search may be applied to derive fewer BVP lists. For instance, the TMP/IntraTMP search may be applied only to derive the sparse BVP candidates. In another example, the TMP/IntraTMP search may be applied only to derive the merge BVP candidates, including or not including the ARBVP candidates. In yet another example, the TMP/IntraTMP search may be applied to derive the sparse list and the merge list, but not the refined list. Other partial implementations of the TMP/IntraTMP to obtain BVP candidates may be possible. The BV associated with the current block can also be a BV derived from any type of BV-based process, such as IBC and so on.

The derived BV candidates can be reordered based on their associated template matching costs, and the BV candidate with the lowest template matching cost can be selected to identify the reference block for intra coding derivation. For example, in FIG. 33 the BV 3330 is selected to be the BV candidate having the lowest template matching cost in the set of BV candidates, and the reference block 3324 pointed to by the BV 3330 can be used to replace the current block 3302 for derivation of the intra coding mode. For example, each of the predicted current blocks 3312A-N can be compared with the reference block 3304 to determine a similarity metric. The IPM whose corresponding predicted current block is most similar to the reference block 3304 can be selected as the intra coding mode of the current block 3302.

In some examples, the similarity may be evaluated using cost metrics such as Sum of Absolute Differences (SAD), Sum of Absolute Transformed Differences (SATD), sum of squared error (SSE), or Hadamard Transform (HAD) cost. Eqn. (23) shows the example of using the SAD metric for determining the intra coding mode, denoted as m, of the current block. In some examples, the encoder and the decoder independently calculate the SAD cost between the reference block (RB) pointed to by the selected block vector (BV) and the predicted coding block (CB) generated using the intra prediction mode m.

$${arg min}_{m} SAD ( RB , {\text{?}}_{m} ) = {arg min}_{m} {\sum }_{i = 1}^{M} {\sum }_{j = 1}^{N} \vert RB ( i , j ) - {\text{?}}_{m} ( i , j ) \vert \qquad ( 23 )$$

Here, RB(i,j) represents the pixel value at position (i,j) in the reference block; [symbol] ₘ denotes the predicted pixel value at position (i,j) using the intra prediction mode m; M and N are the dimensions of the block.

The intra coding mode m is selected based on the criterion of minimizing the SAD cost. Specifically, the mode m that yields the lowest SAD value is chosen as the intra coding mode of the current block. This process ensures prediction accuracy by selecting the mode that best approximates the reference block.

In some examples, more than one BV candidate may be selected for the derivation of the intra coding mode of the current block. For example, multiple BV candidates with the lowest TM costs can be selected and for each of the multiple BV candidates, the intra prediction mode with the lowest (prediction) cost (highest similarity) derived from the respective RB is selected. Eqn. (24) demonstrates the derivation of intra prediction mode m from different BVs (indexed by k) and its corresponding block, RBₖ. For each BV k, at least one prediction mode m is selected.

$${arg min}_{m} SAD ( {RB}_{k} , {\text{?}}_{m} ) = {arg min}_{m} {\sum }_{i = 1}^{M} {\sum }_{j = 1}^{N} \vert RB ( i , j ) - {\text{?}}_{m} ( i , j ) \vert \qquad ( 24 )$$

The selected multiple IPMs from the multiple BV candidates may be further evaluated to determine the intra coding mode for the current block. For example, the multiple IPMs can be filtered to remove duplicates. If there are still more than one IPM, the IPM among the multiple IPMs that has the lowest cost (highest similarity) can be selected as the intra coding mode of the current block.

In some examples, the BV or multiple BVs used for deriving the intra coding mode of the current block can be determined by selecting the BV(s) that minimize the difference between the reference block and the original current block. In this scenario, the index(es) corresponding to the selected BV(s) can be explicitly signaled in the bitstream.

In some examples, the intra prediction using the intra prediction mode m can be performed through conventional methods, such as angular or non-angular modes. Alternatively, or additionally, it can utilize a neural-based prediction mode which uses sequential matrix multiplications and LeakyReLUs (piecewise-linear functions), or a matrix-based intra prediction such as MIP or PDP (matrix-based position dependent intra prediction). For example, in MIP, a matrix of weights can be defined for a block shape and intra mode. These weights can be multiplied by the neighbour reference template to derive the prediction samples replacing conventional intra prediction as described in JVET-AH0209: EE2-2.13: Matrix based intra prediction replacing conventional intra modes, the content of which is incorporated by reference in its entirety.

If the BVIMD is used by the encoder to determine the intra coding mode of a block, it may be signaled in the bitstream so that the decoder can perform the same process to derive the intra coding mode. In some examples, the BVIMD can be signaled as an independent mode, similar to DIMD or TIMD. Alternatively, or additionally, it may be implemented as a sub-mode within another mode such as the DIMD. For example, BVIMD can be signaled when the obicMode flag is set to false in DIMD mode.

In some examples, the coder (encoder or decoder) can apply BVIMD when a condition for enabling the BVIMD is satisfied. The condition can be based on one or more of a size of the current block, a coding mode of the current block, a quantization parameter of the current block, a quantization parameter of a slice comprising the current block, or a type of a slice comprising the current block. For example, the condition can include the size of the current block is higher than a predetermined value and the width and height of the current block are different (or the same). The encoder can signal, in a bitstream, an indication of the condition for enabling the BVIMD. The decoder can obtain, from the bitstream, the indication of the condition for enabling the BVIMD. The indication can specify a maximum block size comprising a maximum block width or height, or a minimum block size comprising a minimum block width or height. In other examples, the indication specifies a maximum ratio or a minimum ratio between a maximum of a block width and a block height and a minimum of the block width and the block height.

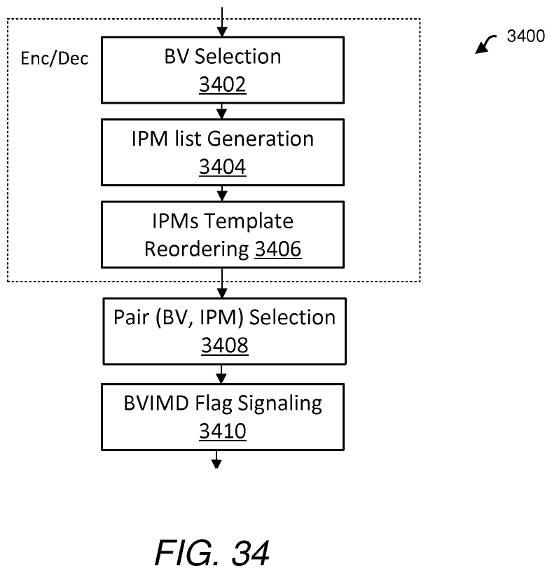

FIG. 34 shows an example flowchart 3400 of the BVIMD, according to embodiments. At block 3402, the BV(s) used to determine the reference block (e.g., reference block 3304) is selected. As discussed above, the BV(s) may be determined by applying the TMP/IntraTMP or a portion thereof on the current block (e.g., current block 3302). In some examples, one BV is selected (e.g., by selecting the BV with the lowest template matching cost). In other examples, multiple BVs (e.g., N BVs) may be selected (e.g., by selecting the N BVs having the lowest template matching costs).

At block, 3404, a list of candidate IPMs are generated. The list of candidate IPMs may include one or more IPMs from the most probable mode (MPM), non-MPM, and/or the secondary MPM. In some examples, the list of candidate IPMs may further include IPMs determined during the DIMD process, the TIMD process, or both. The list of candidate IPMs may further include other IPMs.

At block 3406, the list of candidate IPMs may be reordered based on the similarities between the reference block and the predicted current block using the respective candidate IPMs, such as according to the cost metrics SAD, SATD, or HAD. In some examples, instead of using the entire reference block and the predicted current block, a portion of the respective blocks are used for similarity calculation. For example, a down-sampled version of the reference block and a similarly down-sampled version of the predicted current block are used to calculate the similarity. In other examples, a cropped portion of the reference block and a similarly cropped portion of the predicted current block are used to calculate the similarity. The reference block or the portion thereof used for calculating the similarity and the predicted current block or the portion thereof used for calculating the similarity are referred to as “block-shaped templates.” The IPM leading to the highest similarity between the two block-shaped templates is selected as an intra coding mode for the current block. Again, a similarity between a block-shaped template (e.g., reference block) and the predicted current block may be a difference (e.g., using one of the cost metrics above) between the block-shaped template the predicted current block.

Blocks 3402-3406 are performed at both the encoder and decoder so that the same intra coding mode is derived for the current block at the encoding and decoding.

In some examples (e.g., when multiple BVs are used) the IPM leading to the highest similarity between the block-shaped templates may not be the best intra coding mode for the current block. In those examples, the list of candidate IPMs and the BVs may be reordered based on the similarities between the reference block and the predicted current block using the respective candidate IPMs and BVs according to the cost metrics. As such, each entry in the reordered list includes a BV and IPM pair. The encoder can select, at 3408, the BV and IPM pair that provides the most accurate prediction for the current block based on the current block. The selection can be indicated using the index of the selected IPM and BV pair in the reordered list.

At block 3410, an indication of using the BVIMD for the current block is signaled by the encoder in the bitstream as discussed above. At the decoder, the indication is obtained from the bitstream and the intra coding mode for the current block can be determined as described above. If block 3408 is performed, the index for the BV and IPM pair is also signaled in the bitstream by the encoder. The decoder can build the ordered list and identify the IPM from the list based on the index parsed from the bitstream.

The most dominant intra prediction (MDIP) mode is an intra mode based on histogram of gradients (HoG) extracted from neighboring templates or template areas. In some examples, the MDIP process selects up to 8 intra prediction modes with 4 intra prediction modes derived from the L-shaped template area of the current block, 2 intra prediction modes derived from the left template area of the current block, and 2 intra prediction modes derived from the above template area. In this process, duplicate intra prediction modes are excluded. The number of identified intra prediction modes varies according to the neighboring pixels of the template areas of the current block.

In some examples, up to 8 intra prediction modes are ordered according to their respective template matching costs. The template matching cost of an intra prediction mode may be calculated based on a cost template of the current block and the template of the cost template. For example, the cost template can include one row or multiple rows above the current block and one column or multiple columns to the left of the current block. In some examples, the cost template may be smaller than the template area. For instance, the cost template may be a subset of the template area. In some examples, the intra prediction mode with the minimum template matching cost is designated as the MDIP mode (also referred to as “MDIP IPM”).

The MDIP IPM is signaled before MPM information at each coding unit (CU) level. To avoid redundancy, the MDIP IPM derivation process excludes the MDIP IPM from the MPM, secondary MPM (SMPM), and non-MPM lists. To further reduce signaling overhead, after computing the HoG, a number (e.g., 20) of improbable intra modes with small HoG amplitude are also removed from MPM, SMPM, and non-MPM lists. The improbable modes are the IPMs with small HoG amplitudes. If the MDIP is not applied due to block size restriction, the HoG of DIMD is used to exclude intra prediction modes instead. When both the MDIP and the excluding improbable intra modes are applied, non-MPM mode size reduces from 45(=67−22) to 24(=67−22−1 (MDIP)−20 (excluding improbable intra prediction modes)). Therefore, signaling overhead of non-MPM can be significantly reduced.

As noted above, compared with many other intra mode derivation mechanisms, BVIMD uses the reconstructed reference block pixels themselves for intra mode derivation which have more direct correlation with the current block and thus provide more accurate predictions. As a result, the mode derivation is more accurate, and fewer bits are needed to represent the prediction residual which further reduces the bitrate. Embodiments of the present disclosure provide for using BVIMD, or more specifically the IPM selection of BVIMD, to exclude improbable IPMs from the MPM and non-MPM lists in order to improve encoder/decoder efficiency. The IPM selection of the BVIMD process can be used to identify irrelevant IPMs and to excluded those identified irrelevant (improbable) IPMs from the MPM list and/or non-MPM candidate lists. Alternatively, instead of being excluded from signaling, these modes can be removed only during the encoder Rate-Distortion Optimization (RDO) process to refine mode selection without affecting the transmitted candidate lists (e.g., the MPM list and/or non-MPM candidate lists). Thus, example embodiments may be considered as providing for using techniques of BVIMD for two key aspects: excluding irrelevant IPMs from MPM and non-MPM signaling lists; and excluding irrelevant IPMs at the encoder side (RDO-based exclusion).

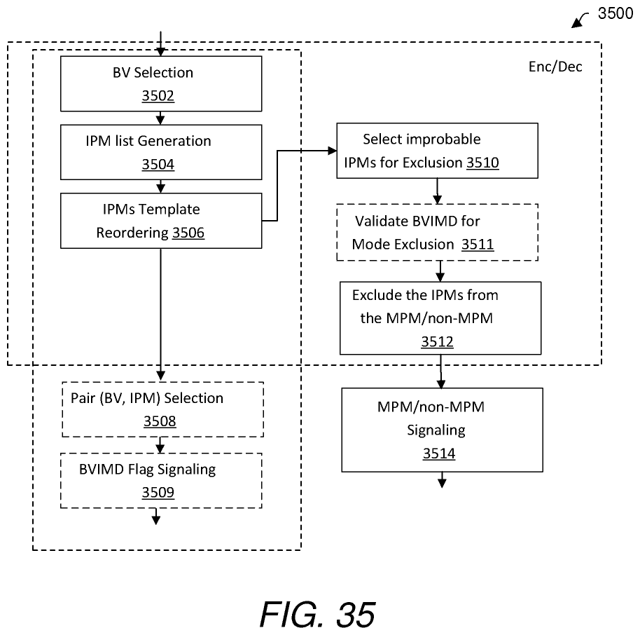

The BVIMD-based intra mode exclusion of example embodiments may involve the steps of selecting IPMs for exclusion, optionally validating the BVIMD, excluding the IPMs selected for exclusion, and signaling. FIG. 35 illustrates a process for BVIMD-based excluding of irrelevant IPMs from MPM and non-MPM signaling lists, according to some embodiments.

The process of flowchart 3500 may begin at block 3502. The processing in blocks 3502, 3504, and 3506 may be identical to the processing in blocks 3402, 3404, and 3406 described in relation to FIG. 34. At block 3506, in the same manner as described in block 3406, the list of candidate IPMs are reordered based on the similarities between the reference block and the predicted current block using the respective candidate IPMs, such as according to the cost metrics SAD, SATD, or HAD.

Following block 3506, example embodiments include the processing at block 3510 to select IPMs for exclusion from candidate lists. The selecting of IPMs for exclusion at block 3510 may be performed during, or following, the BVIMD reordering process. During the BVIMD reordering process at block 3506 IPMs in the BVIMD candidate list are ranked based on block-shaped template costs. The IPMs selected for exclusion at block 3510 may be those having a block-shaped template cost that is greater than a threshold or a threshold multiplied by a scalar factor, where the threshold is determined based on the reordered BVIMD candidates list obtained at block 3506. The threshold is determined based on the BVIMD-based reordering of the list of Pissoir example, the threshold may be set as the cost of the first IPM (e.g., the lowest cost (highest similarity) IPM) in the BVIMD-reordered list. The subsequent exclusion operation may exclude any IPM that has a higher cost (e.g., block-shaped template cost) than the threshold or threshold multiplied by a scalar value. One or more IPMs may be identified for exclusion in this manner.

As shown in block 3511, optionally, the BVIMD-derived IPM is validated before excluding the IPMs identified as exceeding the threshold. The BVIMD-derived IPM may be validated by checking whether that IPM is in the RDO candidate list. For example, validation may include determining whether the IPM that has the lowest block-shaped template cost in the BVIMD-reordered list obtained at block 3506 has an RDO cost that allows it to be considered in the final list of candidates for encoding/decoding the current block. In some examples, this may include checking whether the RDO cost of the IPM that has the lowest block-shaped template cost in the BVIMD-reordered list is lower than a predetermined RDO cost. In some examples, the validation is based on checking the final list of candidate IPMs for which the RDO costs are determined. The validation may also include checking whether the block-shaped template cost of the IPM that has the lowest block-shaped template cost in the BVIMD-reordered list, the BVIMD IPM, is lower than a designated reference mode.

Following the determining at block 3510 the threshold cost for identifying of the improbable IPMs, optionally after the validation of the BVIMD IPM at block 3511, the IPM exclusion is applied at block 3512. In some embodiments, the exclusion is applied to the intra mode signaling of the MPM or non-MPM candidate lists. For example, the excluded IPMs are removed from the MPM, SMPM, and non-MPM candidate lists, reducing the number of intra modes that are required to be transmitted on the bitstream. When the excluding N improbable intra modes from BVIMD are applied, non-MPM mode size reduces from 24 (=67−22−1 (MDIP)−20 (excluding improbable intra prediction modes)) to 24-N. Therefore, signaling overhead of non-MPM can be reduced.

The processing of blocks 3510-3512, as with the processing of blocks 3502-3506, may be performed by the encoder and the decoder.

Following block 3512, at block 3514, the encoder signals the updated MPM, SMPM and/or non-MPM candidate lists to the decoder. As noted above, the updated candidate lists have excluded one or more improbable IPMs and therefore require less bits to be transmitted on the bitstream from the encoder to the decoder. Block 3514 is performed only at the encoder.

Aside from the processes of block 3510-3512 that determines updated MPM, SMPM and/or non-MPM candidate lists, following block 3506, the BVIMD IPM determination and signaling may happen at blocks 3508 and 3509. The processing at blocks 3508 and 3509 may be identical to the processing of blocks 3408 and 3410 described above in relation to FIG. 34. For intra mode exclusion in the MPM or non-MPM lists, the encoder and decoder always perform the BVIMD process to determine improbable modes. Otherwise, a flag is transmitted to indicate whether IPMs are excluded based on BVIMD.

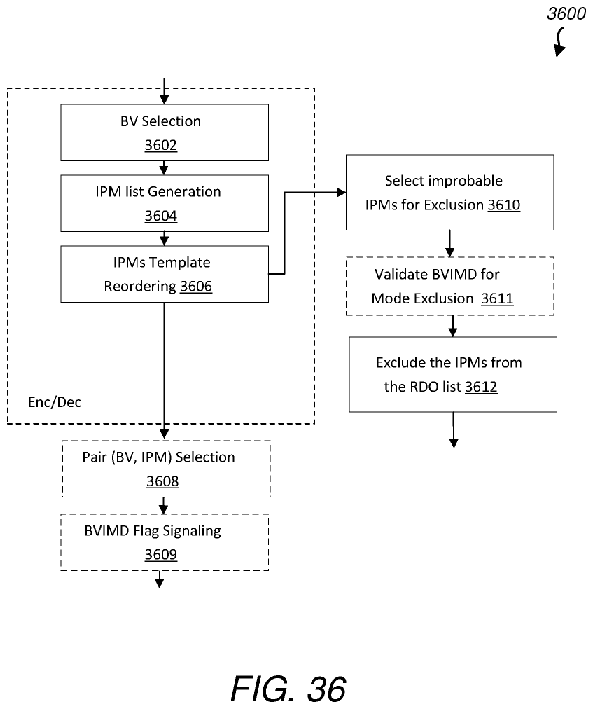

Flowchart 3600 shows a process in which the exclusion of the improbable IPMs is applied for RDO calculations at the encoder, but the signaled candidate lists are not updated. For example, the one or more IPMs identified as improbable are ignored when checking RDO costs, but those IPMs are not removed from the MPM or non-MPM candidate lists. FIG. 36 illustrates a process for BVIMD-based excluding of irrelevant IPMs that are then ignored during the RDO calculation process, according to some embodiments.

The process of flowchart 3600 may begin at block 3602. Operations of blocks 3602, 3604 and 3606 may be identical to operations of blocks 3402, 3404, and 3406 described in relation to FIG. 34.

After the BVIMD-reordered list of IPM is built at block 3606, the threshold block-shaped template cost is determined for identifying improbable IPMs at block 3610. This may be performed similarly to the description above at block 3510. Similar to the optional block 3511, optional processing of block 3611 may be performed after block 3610 to validate the BVIMD IPM.

As described above, improbable IPMs are IPMs that have block-shaped template costs that are higher than the threshold determined at block 3610 or higher than the threshold multiplied by a scalar factor. After determining the threshold at block 3610, and if the BVIMD is successfully validated at block 3611, the improbable IPMs are excluded from the candidate list for which the encoder calculates RDO costs at block 3612. In this manner, the encoder reduces the compute required to determine the IPM for encoding the current block.

In the embodiment of FIG. 36, blocks 3610-3612 are performed only at the encoder. Since the identified improbable IPMs are not removed from the MPM or non-MPM candidate lists, the decoder does not perform operations of blocks 3610-3611 to identify improbable IPMs.

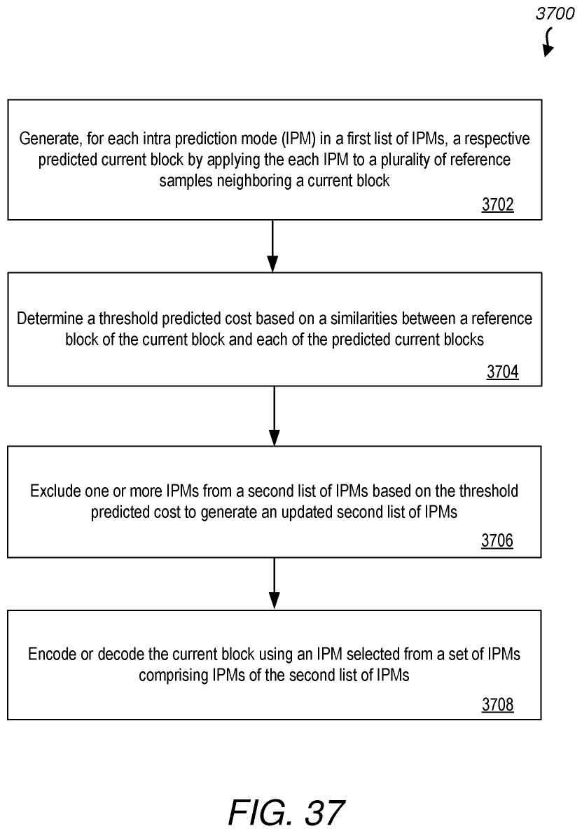

FIG. 37 shows an example flowchart 3700 illustrating a process for coding (encoding or decoding) a block based on excluding improbable IPMs from candidate lists, where the excluding of the improbable IPMs is using BVIMD, according to some embodiments. Operations of flowchart 3700 may be performed by an encoder, such as, for example, encoder 200 in FIG. 2, or by a decoder, such as, for example, decoder 300 in FIG. 3.

The process of flowchart 3700 may begin at block 3702. At block 3702, for each intra prediction mode (IPM) in a first list of IPMs, a respective predicted current block is generated by applying the each IPM to a plurality of reference samples neighboring a current block.

The first list of IPMs may include one or more IPMs from the most probable mode (MPM), non-MPM, and/or the secondary MPM. In some examples, the list of candidate IPMs may further include IPMs determined during the DIMD process, the TIMD process, or both. The first list of IPMs may further include other IPMs.

Each IPM from the first list of IPMs may be applied to a plurality of reference samples neighboring the current block (e.g., by performing the intra prediction process) to generate a predicted current block corresponding to that IPM. For example, as described in relation to FIG. 33, an IPM can be applied to a plurality of reference samples 3340 neighboring the current block 3302 to determine a predicted current block corresponding to that IPM. Thus, by applying each IPM in the first list of IPMs to the reference samples 3340, a set of predicted current blocks 3312A-3312N can be generated, each predicted current block corresponding to a respective IPM in the first list of IPMs. The reference samples may include reconstructed samples above the current block and/or reconstructed samples to the left of the current block

If the current block is coded using the multiple reference line (MRL) mode, the reference samples 3340 may include multiple (two or more) reference lines and the predicted current blocks 3312A-3312N are generated based on these multiple reference lines which can enhance the robustness of the derived intra prediction.

At block 3704, a threshold predicted cost is determined based on similarities between a reference block of the current block and each of the predicted current blocks.

Referring to FIG. 33, a reference block pointed to by a block vector (BV) 3330 associated with the current block 3302 may be used to calculate the similarity for determining the intra coding mode of the current block 3302. The BV 3330 associated with the current block 3302 may be a BV determined via the template matching prediction (TMP or IntraTMP) applied on the current block 3302. For example, the TMP/IntraTMP may be applied to the current block 3302 based on the current template 3318 and reference templates of potential reference blocks.

In some embodiments, the reference block may be determined based on template matching or IntraTMP on any one or a combination of the sparse list, merge list, or refined list. The templates considered in IntraTMP may be any of L-shaped, top-only, or left-only templates.

In some embodiments, the reference block is selected from candidate blocks indicated by block vector predictors (BVPs) in a sparse list, in a merge list, or a refined list (e.g., determined based on template matching).

In some embodiments, the reference block may be a block determined according to ARBVP. Alternatively, the reference block may be selected according to another block vector-based process such as, for example, IBC.

Each predicted current block in the set of predicted current blocks 3312A-3312N may be compared to the selected reference block (e.g., reference block 3304) to select the IPM (BVIMD IPM) for encoding/decoding the current block. More particularly, the IPMs in the first list of IPMs may be reordered according to their corresponding predicted current block's similarity to the reference block. As noted in relation to FIG. 33 and FIG. 34, this similarity may be determined based on block-shaped template costs using cost metrics such as Sum of Absolute Differences (SAD), Sum of Absolute Transformed Differences (SATD), sum of squared error (SSE), or Hadamard Transform (HAD) cost, or a difference determined based on a hash function. In some examples, instead of using the entire reference block and the predicted current block, a portion of the respective blocks are used for similarity calculation. For example, a subset of samples of the reference block (e.g., down-sampled versions or cropped versions of the reference block) and corresponding samples of the predicted current block are used to calculate the similarity.

In some examples, the cost of the IPM, from the first list of IPMs, that yields the predicted current block that is most similar (e.g., with the highest similarity of the similarities) to the reference block is selected determine the threshold predicted cost. In the reordered first list of IPMs, the IPM that yields the predicted current block that is most similar to the reference block may be located in the first position (e.g., with the smallest index in the list). In some embodiments, the cost of another IPM, other than the most similar IPM, that yields a highly similar predicted current block to the reference block may be selected as the threshold predicted cost. For example, the cost may be the second or third lowest cost or may be an average of a number (e.g., predetermined number) of the lowest costs.

Accordingly, the threshold predicted cost may be determined based on a highest similarity of the similarities. The highest similarity corresponds to a lowest prediction cost of prediction costs of the predicted current blocks.

At block 3706, one or more IPMs are excluded from a second list of IPMs based on the threshold predicted cost to generate an updated second list of IPMs.

In some examples, the second list of IPMs may include candidate lists such as one or more of MPM, SMPM, and non-MPM (e.g., TIMD-based, DIMD-based) candidates lists.

In some examples, a predicted current block is calculated for respective IPMs in a candidate list, and if the cost of that predicted current block exceeds the threshold predicted cost or the threshold predicted cost multiplied by a predetermined scalar value, that respective IPM is identified as an improbable IPM that is unlikely to be selected as the IPM for encoding or decoding the current block. That is, in each candidates list considered for exclusion, respective IPMs whose predicted current blocks are less similar to the reference block than the BVIMD IPM are identified as improbable IPMs and are identified for exclusion from the candidate lists.

In some embodiments, another process instead of the BVIMD process may be used to determine prediction costs of IPMs of the second list of IPMs to determine which IPMs to exclude. For example, the prediction cost for each IPM in the second list of IPMs may be determined based on a difference between a current template of the current block and a predicted template obtained using the each IPM. The predicted template may be obtained by performing intra prediction of the current template (e.g., template 3204 of FIG. 32A) using the each IPM and reference samples (e.g., reference of template 3206) neighboring the current template, similar to how IPMs are evaluated in TIMD as explained in FIGS. 32A-B.

In some examples, as explained above, the threshold predicted cost may be determined based on a lowest prediction cost of prediction costs of the predicted current blocks. The threshold predicted cost may be determined as a product of the lowest prediction cost (i.e., highest similarity) and the predetermined scalar value.

The second list of IPMs are updated by removing the improbable IPMs.

In this manner, the size of the candidates lists (e.g., MPM and/or non-MPM candidates lists) is reduced and thus the bits required for signaling a position of an IPM in a candidates list can be reduced.

In some embodiments, before the updating of the second list of IPMs to exclude improbable IPMs, a validation may be performed to ensure that the BVIMD IPM is in a candidates list that is considered based on rate distortion optimization (RDO). The validation includes determining that an identified IPM (e.g., the IPM yielding the highest similarity to the reference block) from the first list of IPMs is present in and RDO candidate list. The validation may optionally include checking whether a cost (e.g., SATD, SAD, etc.) of the IPM of the second list of IPMs is greater than a cost based on the cost of the identified IPM (e.g., the cost of the identified IPM scaled by a scaling value). The excluding of the improbable IPM may be performed only if the validation is successful.

In some examples, the updated second list of IPMs is a primary MPM list, a Secondary MPM (SMPM) list, or a combined primary and secondary MPM list.

In some examples, the updated second list of IPMs is a non-MPM list.

In some examples, the updated second list of IPMs include one or more IPMs obtained based on DIMD and/or TIMD.

In some examples, the updated second list of IPMs includes one or more IPMs obtained from a TIMD mode, one or more IPMs from an MPM list, an MDIP mode, one or more IPMs from an OBIC mode, a DC mode, a planar mode, a horizontal and/or vertical DC mode, and/or a horizontal and/or vertical planar mode.

At block 3708, the current block is encoded or decoded using an IPM selected from a set of IPMs comprising IPMs of the second list of IPMs.

In some examples, an IPM from the updated second list of IPMs, is selected for encoding or decoding the current block. In some examples, an IPM not present in the updated second list of IPMs, such as, for example, the BVIMD IPM, is selected, for encoding or decoding the current block. Therefore, the set of IPMs may include IPMs not present in the second list of IPM and that is selected for coding the current block.

In some examples, an encoder may signal, in a bitstream, an indicator of the IPM to be selected from the set of IPMs. For example, the set of IPMs may be a list of candidate IPMs and the indicator may indicate the location/position of the selected IPM in the list of candidate IPMs. For example, the indicator may be an index indicating a position of the selected IPM in the updated second list of IPMs. The decoder may obtain, from the bitstream, the indicator to identify/select the IPM for decoding/reconstructing the current block.

The process at block 3708 involves determining, based on the selected IPM, a prediction block for the current block by applying the selected IPM to the reference sample of the current block. The current block is coded based on the prediction block. In some embodiments, at the encoder, the block may be encoded by subtracting the prediction block from the block to determine a residual (e.g., residual block). The residual may be encoded and signaled in the bitstream. At the decoder, the decoder may reconstruct the block based on a residual (e.g., residual block) obtained from a bitstream and the prediction block. For example, the current block may be determined by adding the residual to the prediction block.

In some examples, the coding further includes the encoder signaling, in a bitstream, an indication of a block vector-based intra mode derivation (BVIMD) being used for excluding improbable IPMs for the block. At the decoder, the indicator indicating that BVIMD is used for excluding improbable IPMs is obtained from the bitstream, and the determining the intra coding mode for the block is performed based on the indication.

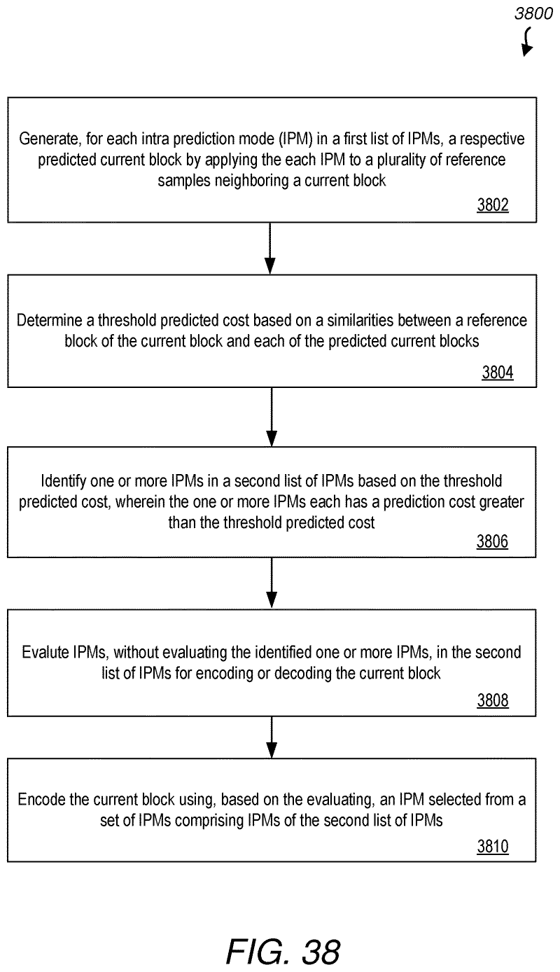

FIG. 38 shows an example flowchart 3800 illustrating a process for coding (encoding or decoding) a block based on excluding improbable IPMs from candidate lists, where the excluding of the improbable IPMs is using BVIMD, according to some embodiments. Operations of flowchart 3800 may be performed by an encoder, such as, for example, encoder 200 in FIG. 2.

The process of flowchart 3800 may begin at block 3802. The processing at blocks 3802 and 3804 are identical to the processing described above in relation to blocks 3702 and 3704. As described in relation to block 3704, at block 3804, a threshold predicted cost is determined based on the first list of IPMs that are reordered based on BVIMD.

At block 3806, one or more IPMs are identified in a second list of IPMs based on the threshold predicted cost, wherein the one or more IPMs each has a prediction cost greater than the threshold predicted cost.

In some examples, the second list of IPMs may include candidate lists such as one or more of MPM, SMPM, and non-MPM (e.g., TIMD-based, DIMD-based) candidates lists.

In some examples, a predicted current block is calculated for respective IPMs in a candidate list, and if the cost of that predicted current block exceeds the threshold predicted cost or the threshold predicted cost multiplied by a predetermined scalar factor, that respective IPM is identified as an improbable IPM that is unlikely to be selected as the IPM for encoding or decoding the current block. That is, in each candidates list considered for exclusion, respective IPMs whose predicted current blocks are less similar to the reference block than the BVIMD IPM are identified as improbable IPMs and are identified for exclusion from the candidate lists.

At block 3808, without evaluating the identified one or more IPMs, IPMs in the second list of IPMs are evaluated for encoding or decoding the current block. For example, when an RDO cost is calculated, any IPMs that were identified as improbable IPMs are skipped. In this manner the computational burden of determining the IPM for encoding the current block is reduced.

In this embodiment, the candidate lists (e.g., MPM (e.g., primary and/or secondary MPM list) or non-MPM candidate lists) are not updated by excluding the improbable IPMs. Therefore, the candidates lists themselves are not made smaller.

At block 3810, an IPM is selected for encoding the current block, and the current block is encoded using the selected IPM. The process at block 3810 involves determining, based on the selected IPM, a prediction block for the current block by applying the selected IPM to the reference sample of the current block. The current block is coded based on the prediction block. In some embodiments, at the encoder, the block may be encoded by subtracting the prediction block from the block to determine a residual (e.g., residual block). The residual may be encoded and signaled in the bitstream. Similar to block 3708, the encoder may signal, in a bitstream, an indication (e.g., index) of the selected IPM in the set of IPMs. For example, the indication may be an index indicating a position of the selected IPM in the second list of IPMs or in a list of candidate IPMs comprising the set of IPMs.

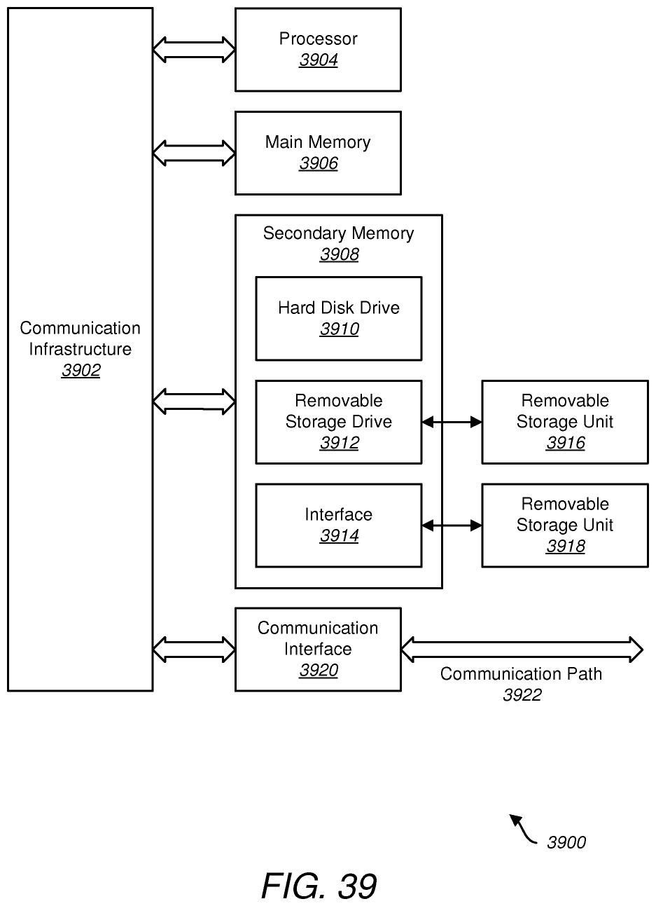

Embodiments of the present disclosure may be implemented in hardware using analog and/or digital circuits, in software, through the execution of instructions by one or more general purpose or special-purpose processors, or as a combination of hardware and software. Consequently, embodiments of the disclosure may be implemented in the environment of a computer system or other processing system. An example of such a computer system 3900 is shown in FIG. 39. Blocks depicted in the figures above, such as the blocks in FIGS. 1, 2, and 3, may execute on one or more computer systems 3900. Furthermore, each of the steps of the flowcharts depicted in this disclosure may be implemented on one or more computer systems 3900.

Computer system 3900 includes one or more processors, such as processor 3904. Processor 3904 may be, for example, a special purpose processor, general purpose processor, microprocessor, or digital signal processor. Processor 3904 may be connected to a communication infrastructure 3902 (for example, a bus or network). Computer system 3900 may also include a main memory 3906, such as random access memory (RAM), and may also include a secondary memory 3908.

Secondary memory 3908 may include, for example, a hard disk drive 3910 and/or a removable storage drive 3912, representing a magnetic tape drive, an optical disk drive, or the like. Removable storage drive 3912 may read from and/or write to a removable storage unit 3916 in a well-known manner. Removable storage unit 3916 represents a magnetic tape, optical disk, or the like, which is read by and written to by removable storage drive 3912. As will be appreciated by persons skilled in the relevant art(s), removable storage unit 3916 includes a computer usable storage medium having stored therein computer software and/or data.

In alternative implementations, secondary memory 3908 may include other similar means for allowing computer programs or other instructions to be loaded into computer system 3900. Such means may include, for example, a removable storage unit 3918 and an interface 3914. Examples of such means may include a program cartridge and cartridge interface (such as that found in video game devices), a removable memory chip (such as an EPROM or PROM) and associated socket, a thumb drive and USB port, and other removable storage units 3918 and interfaces 3914 which allow software and data to be transferred from removable storage unit 3918 to computer system 3900.

Computer system 3900 may also include a communications interface 3920. Communications interface 3920 allows software and data to be transferred between computer system 3900 and external devices. Examples of communications interface 3920 may include a modem, a network interface (such as an Ethernet card), a communications port, etc. Software and data transferred via communications interface 3920 are in the form of signals which may be electronic, electromagnetic, optical, or other signals capable of being received by communications interface 3920. These signals are provided to communications interface 3920 via a communications path 3922. Communications path 3922 carries signals and may be implemented using wire or cable, fiber optics, a phone line, a cellular phone link, an RF link, and other communications channels.

As used herein, the terms “computer program medium” and “computer readable medium” are used to refer to tangible storage media, such as removable storage units 3916 and 3918 or a hard disk installed in hard disk drive 3910. These computer program products are means for providing software to computer system 3900. Computer programs (also called computer control logic) may be stored in main memory 3906 and/or secondary memory 3908. Computer programs may also be received via communications interface 3920. Such computer programs, when executed, enable the computer system 3900 to implement the present disclosure as discussed herein. In particular, the computer programs, when executed, enable processor 3904 to implement the processes of the present disclosure, such as any of the methods described herein. Accordingly, such computer programs represent controllers of the computer system 3900.

In another embodiment, features of the disclosure may be implemented in hardware using, for example, hardware components such as application-specific integrated circuits (ASICs) and gate arrays. Implementation of a hardware state machine to perform the functions described herein will also be apparent to persons skilled in the art.

What is claimed is:

1. A method, comprising:
generating, for each intra prediction mode (IPM) in a first list of IPMs, a respective predicted current block by applying the each IPM to a plurality of reference samples neighboring a current block;
determining a threshold predicted cost based on similarities between a reference block of the current block and each of the predicted current blocks;
excluding one or more IPMs from a second list of IPMs based on the threshold predicted cost to generate an updated second list of IPMs; and
decoding the current block using an IPM selected from a set of IPMs comprising IPMs of the second list of IPMs.

2. The method of claim 1, wherein the threshold predicted cost is determined based on a highest similarity of the similarities, and wherein the highest similarity corresponds to a lowest prediction cost of prediction costs of the predicted current blocks.

3. The method of claim 1, wherein the excluding the one or more IPMs from the second list of IPMs based on the threshold predicted cost comprises:
determining that each of the one or more IPMs in the second list of IPMs has a prediction cost greater than the threshold predicted cost; and
removing the one or more IPMs from the second list of IPMs.

4. The method of claim 3, wherein the prediction cost and the threshold predicted cost are determined based on portions of the predicted current blocks, and wherein the prediction cost comprises a difference between the portions of the predicted current block and corresponding portions of the reference block.

5. The method of claim 1, wherein the reference block is obtained using template matching based on L-shaped templates, above-only templates, or left-only templates of the current block and reference blocks.

6. The method of claim 1, wherein the reference block is selected from candidate blocks indicated by block vector predictors (BVPs) in a sparse list, in a merge list, or a refined list determined based on template matching.

7. The method of claim 1, wherein the updated second list of IPMs comprises at least one of a Most Probable Mode (MPM) list, a Secondary MPM (SMPM) list, or a non-MPM list.

8. A decoder, comprising:
one or more processors; and
memory storing instructions that, when executed by the one or more processors, cause the decoder to
generate, for each intra prediction mode (IPM) in a first list of IPMs, a respective predicted current block by applying the each IPM to a plurality of reference samples neighboring a current block;
determine a threshold predicted cost based on similarities between a reference block of the current block and each of the predicted current blocks;
exclude one or more IPMs from a second list of IPMs based on the threshold predicted cost to generate an updated second list of IPMs; and
decode the current block using an IPM selected from a set of IPMs comprising IPMs of the second list of IPMs.

9. The decoder of claim 8, wherein the threshold predicted cost is determined based on a highest similarity of the similarities, and wherein the highest similarity corresponds to a lowest prediction cost of prediction costs of the predicted current blocks.

10. The decoder of claim 8, wherein the exclusion of the one or more IPMs from the second list of IPMs based on the threshold predicted cost comprises:
determining that each of the one or more IPMs in the second list of IPMs has a prediction cost greater than the threshold predicted cost; and
removing the one or more IPMs from the second list of IPMs.

11. The decoder of claim 10, wherein the prediction cost and the threshold predicted cost are determined based on portions of the predicted current blocks, and wherein the prediction cost comprises a difference between the portions of the predicted current block and corresponding portions of the reference block.

12. The decoder of claim 8, wherein the reference block is obtained using template matching based on L-shaped templates, above-only templates, or left-only templates of the current block and reference blocks.

13. The decoder of claim 8, wherein the reference block is selected from candidate blocks indicated by block vector predictors (BVPs) in a sparse list, in a merge list, or a refined list determined based on template matching.

14. The decoder of claim 8, wherein the updated second list of IPMs comprises at least one of a Most Probable Mode (MPM) list, a Secondary MPM (SMPM) list, or a non-MPM list.

15. A non-transitory computer readable medium storing a bitstream, which, when decoded by a decoder, causes the decoder to:
generate, for each intra prediction mode (IPM) in a first list of IPMs, a respective predicted current block by applying the each IPM to a plurality of reference samples neighboring a current block;
determine a threshold predicted cost based on similarities between a reference block of the current block and each of the predicted current blocks;
exclude one or more IPMs from a second list of IPMs based on the threshold predicted cost to generate an updated second list of IPMs; and
decode the current block using an IPM selected from a set of IPMs comprising IPMs of the second list of IPMs.

16. The non-transitory computer readable medium of claim 15, wherein the threshold predicted cost is determined based on a highest similarity of the similarities, and wherein the highest similarity corresponds to a lowest prediction cost of prediction costs of the predicted current blocks.

17. The non-transitory computer readable medium of claim 15, wherein the exclusion of the one or more IPMs from the second list of IPMs based on the threshold predicted cost comprises:
determining that each of the one or more IPMs in the second list of IPMs has a prediction cost greater than the threshold predicted cost; and
removing the one or more IPMs from the second list of IPMs.

18. The non-transitory computer readable medium of claim 17, wherein the prediction cost and the threshold predicted cost are determined based on portions of the predicted current blocks, and wherein the prediction cost comprises a difference between the portions of the predicted current block and corresponding portions of the reference block.

19. The non-transitory computer readable medium of claim 15, wherein the reference block is obtained using one of:
template matching based on L-shaped templates, above-only templates, or left-only templates of the current block and reference blocks; or
selecting from candidate blocks indicated by block vector predictors (BVPs) in a sparse list, in a merge list, or a refined list determined based on template matching.

20. The non-transitory computer readable medium of claim 15, wherein the updated second list of IPMs comprises at least one of a Most Probable Mode (MPM) list, a Secondary MPM (SMPM) list, or a non-MPM list.
